(19) United States
(12) Patent Application Publication
(10) Pub. No.: US 2017/0235909 A1
(43) Pub. Date: Aug. 17, 2017

(54) TELEMONITORING SYSTEM !

(71) Applicant: Esvyda!, Inc., Campbell, CA (US)

(72) Inventors: Elias Lozano, Campbell, CA (US); Wilson David Jaramillo Romero, Pereira (CO); Paola Bonilla Galindo, Pereira (CO); David Alexander Murillo Gaviria, Pereira (CO)

(21) Appl. No.: 15/431,646

(22) Filed: Feb. 13, 2017

Related U.S. Application Data
(60) Provisional application No. 62/294,254, filed on Feb. 11, 2016.
(60) Provisional application No. 62/455,570, filed on Feb. 6, 2017.

(51) Int. Cl. G06F 19/00; G09B 19/00; G09B 5/06; G06Q 30/00

(52) U.S. Cl. CPC G06F 19/3418; G06Q 30/018; G06F 19/328; G06F 19/322; G06F 19/327; G06F 19/3475; G06F 19/3456; G09B 19/0092; G09B 5/065

(57) ABSTRACT

Disclosed is a telemonitoring system and associated methods. A doctor creates a care plan for a patient with a chronic condition, such as diabetes. The care plan includes a medication plan, an exercise plan, a healthy eating plan, etc., and the care plan is input at a telemonitoring system. When the patient returns home, the telemonitoring system helps the patient to adhere to his care plan. The telemonitoring system determines that it is time for the patient to take a medication, so the system sends a text message to notify the patient to take a medication. The system determines that it is time for the patient to take a blood sugar reading. The patient does so, and the glucose meter sends the readings to the telemonitoring system, where the system determines that the patient's glucose level is dangerously high, so the system notifies the patient's care team.

### CROSS-REFERENCE TO RELATED APPLICATIONS

This application claims the benefit of U.S. Provisional Patent Application No. 62/294,254, filed Feb. 11, 2016, and U.S. Provisional Patent Application No. 62/455,570, filed Feb. 6, 2017, both of which are incorporated by reference herein in their entirety.

### BACKGROUND

A patient visits a doctor for a medical condition, and the doctor evaluates the patient and makes a diagnosis. The doctor writes up a care plan that includes a medication plan, an exercise plan, a healthy eating plan, and a biometric testing plan. When the patient returns home, he neglects to review his care plan, and he forgets all the items he is supposed to be doing. When he returns to the doctor, he is embarrassed, and does not accurately report how well he has been adhering to the care plan.

### BRIEF DESCRIPTION OF THE DRAWINGS

FIG. 1. is a flow diagram that illustrates a workflow for telemonitoring a patient's compliance with a care plan, consistent with various embodiments.

FIG. 2. is a system diagram that illustrates high-level interactions between various platforms associated with a telemonitoring system, consistent with various embodiments.

FIG. 3. is a diagram that illustrates components of a system for telemonitoring a patient's compliance with a care plan, also referred to as a telemonitoring system, consistent with various embodiments.

FIGS. 4A-B are a flow diagram that illustrates a login process at a telemonitoring system, consistent with various embodiments.

FIGS. 5A-B are a flow diagram that illustrates a process for enrolling a health care provider at a telemonitoring system, consistent with various embodiments.

FIGS. 6A-B are a flow diagram that illustrates a process for enrolling a patient at a telemonitoring system, consistent with various embodiments.

FIGS. 7A-B are a flow diagram that illustrates a process for exchanging patient health information between Electronic Health Record (EHR) systems, consistent with various embodiments.

FIGS. 8A-B are a flow diagram that illustrates a process for generating, modifying, or canceling a medical appointment, consistent with various embodiments.

FIGS. 9A-B are a flow diagram that illustrate a process for establishing a care plan for a patient enrolled at a telemonitoring system, consistent with various embodiments.

FIG. 10 is a flow diagram that illustrates a process to associate a medical staff member with a patient's care plan, consistent with various embodiments.

FIG. 11 is a flow diagram that illustrates a process to associate a care giver with a patient's care plan, consistent with various embodiments.

FIGS. 12A-D are a flow diagram that illustrates a process to establish parameters or targets for processing the biometric data according to some embodiments of the present integration, consistent with various embodiments.

FIGS. 13A-B are a flow diagram that illustrate a communication and data synchronization process between a wireless medical device and a mobile device, consistent with various embodiments.

FIG. 14 is a flow diagram that illustrates a process for transmitting biometric data from a mobile device to a telemonitoring system, consistent with various embodiments.

FIG. 15 is a flow diagram illustrating a process for transmitting biometric data from a telemonitoring system to a mobile device, consistent with various embodiments.

FIGS. 16A-B are a flow diagram illustrating a process for sending biometric data to a telemonitoring system via an Applications Programming Interface (“API”), consistent with various embodiments.

FIGS. 17A-B are a flow diagram illustrating a process for detecting an unauthorized attempt to access a telemonitoring system, consistent with various embodiments.

FIGS. 18A-B are a flow diagram illustrating a process for generating a medical alert based on biometric data, consistent with various embodiments.

FIG. 19 is a flow diagram illustrating a process for generating a medical alert when biometric readings are not taken in compliance with a care plan, consistent with various embodiments.

FIGS. 20A-E are a flow diagram illustrating a process for updating a care plan based on telemonitoring data, consistent with various embodiments.

FIGS. 21A-B are a flow diagram illustrating a billing process for a telemonitoring system, consistent with various embodiments.

FIGS. 22A-E are a flow diagram illustrating a process for generating a patient compliance score, consistent with various embodiments.

FIGS. 23A-E illustrate data associated with a patient compliance score, consistent with various embodiments.

FIG. 24 illustrates an example patient care plan user interface, consistent with various embodiments.

FIG. 25 illustrates an example patient activity user interface, consistent with various embodiments.

FIGS. 26A-B illustrate an example nutrition tracking user interface, consistent with various embodiments.

FIG. 27 illustrates an example patient biometric data user interface, consistent with various embodiments.

FIGS. 28A-B illustrate an example patient engagement progression user interface, consistent with various embodiments.

FIG. 29 illustrates an example patient engagement general user interface, consistent with various embodiments.

FIG. 30 illustrates an example patient daily checklist user interface, consistent with various embodiments.

FIG. 31 is a system block diagram illustrating a computer system in which at least some operations described herein can be implemented, consistent with various embodiments.

### DETAILED DESCRIPTION

Introduced here is technology related to a telemonitoring system, which is a system for remotely monitoring patients who are not at a same location as a health care provider. A daughter takes her elderly father to visit a doctor for a medical condition, and the doctor evaluates the patient (i.e., the father), and makes a diagnosis that he has diabetes. The doctor writes up a care plan that includes a medication plan, an exercise plan, a nutrition plan, an education plan, a medical review plan, and a biometric testing plan, and the care plan is input into a database of a telemonitoring system. When the patient returns home, he neglects to review his care plan, and he forgets all the items he is supposed to be doing. However, the telemonitoring system helps the patient to adhere to his care plan.

The telemonitoring system analyzes the patient's care plan, and determines that the medication plan indicates that it is time for the patent to take a certain medication. The telemonitoring system sends a message to the patient's smartphone, which triggers a care plan application running on the smartphone to display an alert that it is time to take a particular medication. The patient takes his medication and taps an icon on his phone to indicate that he took the medication. At a later time, the patient receives an alert that it is time for him to go for a walk as part of his exercise plan. The patient taps an icon that indicates that he wants to be reminded later. Thirty minutes later, the patient once again receives an alert that it is time for him to go for a walk. The patient goes for the walk, and taps an icon that indicates that he completed his exercise.

At meal time, the care plan application displays a message notifying the patient that he should adhere to the nutrition plan prescribed by his physician or other medical staff. His smartphone displays a recommended meal, and the patient uses the application to swap some food items with other recommended food items. The application displays an alert to notify the patient to adhere to his biometric testing plan by taking a blood sugar reading prior to eating his meal, and the patient does so. The patient uses a glucose meter to take the reading, and the glucose meter wirelessly communicates the blood sugar reading to the care plan application running at the patient's smartphone. The patient eats his meal, and taps an icon on the smartphone to indicate that he consumed the food items recommended by the meal plan. He also notes via the care plan application that he ate some additional food items.

In the morning, the patient is not feeling well, and he ignores the alert to take his morning medication per his medication plan. After a certain period of time, the telemonitoring system, in response to not receiving an indication that the patient took his prescribed medication, sends an alert to a care plan application running at a smartphone of the patient's care giver, who in this example is his daughter. The daughter stops by her father's house on the way home from dropping off the kids at school. She gets her father's medication and brings it to him, and he takes it. The daughter taps on an icon on her smartphone to indicate that her father took his medication in compliance with his medication plan.

At a later time in the day, the care plan application notifies the patient that it is time to take his blood sugar reading and his blood pressure per his biometric testing plan. The patient uses a glucose meter to check his blood sugar, and the glucose meter wirelessly sends his glucose level reading to the care plan application running at his smartphone. He then uses a blood pressure monitor to check his blood pressure, and his blood pressure meter wirelessly sends his blood pressure reading to the application. The application sends the information to a server of the telemonitoring system, and the telemonitoring system determines that the glucose level reading is outside of a safe range, and, in response, the telemonitoring system sends an alert to his physical or other medical staff. A nurse at his doctor's office is notified via the alert, and she initiates a video call with the patient via a care plan application that runs on her smartphone. She notifies the patient that his glucose level is dangerously low, and she urges him to drink some sugary drink, such as orange juice. The patient does so. The nurse sets up an alert to notify the patient to take his blood sugar in ten minutes so she can verify that his blood sugar levels are recovering. Ten minutes later, the patient receives an alert to re-test his blood sugar, which he does. The telemonitoring system sends the blood sugar reading to his nurse, who verifies that his blood sugar readings are recovering.

The physician or other medical staff set up a doctor's appointment to review the patient's progress per the medical review plan, and sets up a diabetes education class per the education plan, which the medical staff conveniently schedules immediately after the doctor's appointment. The care plan application has a reminder that reminds the patient and his daughter of his doctor's appointment and the diabetes education class. The daughter, having been reminded of the appointments by the care plan application running at her smartphone, picks up her father and brings him to his doctor's appointment. When the patient meets with the doctor, the doctor uses his work computer to obtain from the telemonitoring system a compliance score, also sometimes referred to as an adherence score, that indicates the patient's compliance/adherence with the care plan, and how his health is responding to the care plan. The metric indicates that the patient is doing well overall. The doctor uses a care plan application running at his work computer to dig deeper into the telemonitoring data. The doctor reviews the patient's glucose and blood pressure readings, and sees room for improvement. He next reviews the patient's medication plan, which sees no reason to change. He reviews the patient's exercise and nutrition plans, and decides to change the care plan to add additional exercise to the exercise plan. After the doctor's appointment, the patient and his daughter both attend the diabetes education class.

The patient's son learns of his father's medical issue, and asks if he can help out. The father responds that he is having trouble meeting his exercise plan, and he asks his son if he can come by and go on walks with him. Via his care plan application, he grants his son permission to view his care plan. The son uses a care plan application running at this smartphone to determine when his father's next planned walk is, and he arranges his schedule so that he can meet his father at his house to go on a walk together.

The embodiments set forth herein represent the necessary information to enable those skilled in the art to practice the embodiments, and illustrate the best mode of practicing the embodiments. Upon reading the current description in light of the accompanying figures, those skilled in the art will understand the concepts of the disclosure and will recognize applications of these concepts that are not particularly addressed here. It should be understood that these concepts and applications fall within the scope of the disclosure and the accompanying claims.

The purpose of terminology used herein is only for describing embodiments and is not intended to limit the scope of the disclosure. Where context permits, words using the singular or plural form may also include the plural or singular form, respectively.

As used herein, unless specifically stated otherwise, terms such as “processing,” “computing,” “calculating,” “determining,” “displaying,” “generating,” or the like, refer to actions and processes of a computer or similar electronic computing device that manipulates and transforms data represented as physical (electronic) quantities within the computer's memory or registers into other data similarly represented as physical quantities within the computer's memory, registers, or other such storage medium, transmission, or display devices. As used herein, unless specifically stated otherwise, the term “or” encompasses all possible combinations, except where infeasible. For example, if it is stated that a database can include A or B, then, unless specifically stated otherwise or infeasible, the database can include A, or B, or A and B. As a second example, if it is stated that a database can include A, B, or C, then, unless specifically stated otherwise or infeasible, the database can include A, or B, or C, or A and B, or A and C, or B and C, or A and B and C.

As used herein, terms such as “connected,” “coupled,” or the like, refer to any connection or coupling, either direct or indirect, between two or more elements. The coupling or connection between the elements can be physical, logical, or a combination thereof. References in this description to “an embodiment,” “one embodiment,” or the like, mean that the particular feature, function, structure or characteristic being described is included in at least one embodiment of the present disclosure. Occurrences of such phrases in this specification do not necessarily all refer to the same embodiment. On the other hand, the embodiments referred to also are not necessarily mutually exclusive.

As used herein, terms such as “cause” and variations thereof refer to either direct causation or indirect causation. For example, a computer system can “cause” an action by sending a message to a second computer system that commands, requests, or prompts the second computer system to perform the action. Any number of intermediary devices may examine and/or relay the message during this process. In this regard, a device can “cause” an action even though it may not be known to the device whether the action will ultimately be executed.

Note that in this description, any references to sending or transmitting a message, signal, etc. to another device (recipient device) means that the message is sent with the intention that its information content ultimately be delivered to the recipient device; hence, such references do not mean that the message must be sent directly to the recipient device. That is, unless stated otherwise, there can be one or more intermediary entities that receive and forward the message/signal, either “as is” or in modified form, prior to its delivery to the recipient device. This clarification also applies to any references herein to receiving a message/signal from another device; i.e., direct point-to-point communication is not required unless stated otherwise herein.

### General

Advantages, components and features of the disclosed technology will be set forth in the description and detailed in the following figures. Some challenges overcome by the current disclosure include efficiently integrating patient clinical data generated by medical devices, data generated during patient engagement with their care providers using a telemonitoring system to collect biometric data under the supervision of a health care provider (HCP), and obtaining payments from health insurance plans (HIPs) for rendered telemonitoring services.

Some embodiments of the technology presented here allow for efficient care coordination methods, patient engagement policies, vital sign analytics, care plan analytics, and medical billing. The health data flow components of the current disclosure are intended to be and generally are in compliance with health regulations and policies.

Some embodiments of the present technology involve a telemonitoring system, which can integrate all the services and functions required to provide the telemonitoring service covered by the health data flow. A telemonitoring system can include some or all of the components described in the current disclosure.

Some embodiments of a telemonitoring system include web application software that supports a user interface for administrating the functions and services of the telemonitoring system. The user interface can be designed to address issues of health or technological literacy.

Some embodiments of a telemonitoring system include an application running at a mobile device that wirelessly communicates with medical devices, such as to collect biometric data obtained by the medical devices. The application running at the mobile device can be a medical care plan application, among others, and the telemonitoring system can include the mobile device and the application running at the mobile device. Some embodiments of a telemonitoring system include hardware components that communicate via a corporate network, and does not include hardware components outside of the corporate network. For example, a telemonitoring system may be comprised of one or more servers and associated storage, where the servers and storage are owned or managed by a single entity and that communicate with each other via a corporate network of the entity. The mobile device can communicate via any of various wireless technologies, such as via cellular technologies (e.g., GPRS, 3G, 4G), WiFi (IEEE 802.11), Bluetooth, Bluetooth Low Energy (BLE), zigbee, Zwave, GPRS, Near Field Communications (NFC), ANT, ANT+, etc. The mobile device can use an abstract communication driver that supports multiple protocols or any other wireless protocols needed to process health or other data.

A telemonitoring system can be coupled with online Electronic Health Record (HER) systems and Electronic Data Interchange (EDI) platforms that provide communication with health insurance providers and pharmacy systems. The telemonitoring system can also be connected with notification suppliers system for sending messages, alerts, audio or video conferencing communication, sending reminders to improve care treatments or reduce communication problems between patients and medical staff, etc.

A telemonitoring system can include handling patient fragmented information through the use of standard protocols and Application Programming Interfaces (APIs) to integrate the following: synchronization of biometric readings between a mobile application and wireless medical devices, clinical data exchange process with any EHR system, billing claims with health insurance systems and e-prescriptions with the pharmacies, etc.

A telemonitoring system can enable a health care provider to enroll patients to provide them with telemonitoring services, to enroll medical staff members to support telemonitoring services, to enroll care givers or other care team members to assist with the a patient's treatment at home or outside of a hospital/clinic, etc. A telemonitoring system can assign a unique identifier to enable consolidation of patient clinical and biometric data with the patient's records. To help ensure secure communications between various components of a telemonitoring system, examples of components including a mobile application, web site, web application, server, etc., the components can obtain a security token to enable secure communication between components of the telemonitoring system. For example, a mobile application can securely obtain biometric data from a wireless medical device, debug the data, and synchronize the data with other components of a telemonitoring system.

In some embodiments, medical staff establish a care plan and biometric parameters for a patient and performs care plan analytics based on data obtained by a telemonitoring system, and the telemonitoring system evaluates compliance with the care plan. The telemonitoring system can analyze the data, and, based on biometric parameters, can generate alerts, reminders, instigate a video or audio conference between a patient and a member of the medical staff, can provide analytics for the medical staff and the patient, etc. The telemonitoring system can further provide an efficient billing process, which includes providing support documents for financial billing, and can generate insurance provider claims for telemonitoring services rendered. A telemonitoring system can further validate patient clinical data or biometric readings, and can analyze patient clinical data or biometric readings in light of the patient's biometric parameters or care plan.

### Mobile Devices

There are many manufacturers of medical devices with wireless communication approved by FDA (Federal Drug Administration of USA), and many of the medical devices use Bluetooth communication to communicate with a medical device or other electronic device. As Bluetooth has become a global standard, however many affiliates have different communication protocols and different implementations of a same standard. Such differences make the integration of various medical devices with a software application a complex job. Some recent technologies, such as smart Bluetooth (e.g., Bluetooth Low Energy), promise better standards, but the implementation still often differs between devices/manufacturers.

### Mobile Applications

Mobile applications that can obtain data from medical devices and that can utilize that data under medical supervision to provide quality medical supervision of a patient are lacking. A need exists for mobile medical applications that include medical supervision, and that provide proper feedback to assist a patient with his or her care plan. Such a mobile medical application should have Federal Drug Administration (FDA) compliance. Because of a lack of proper standardization in the medical device market, it is difficult to construct a mobile medical application that can communicate with the various medical devices from the various medical device manufacturers. Further, there are differences in accuracy and user interface that may affect the usability of a particular device.

### Telemonitoring Web Platforms

A need exists for a telemonitoring system that enables a health care provider to establish and monitor a care plan for a patient. A telemonitoring system that is patient centric, such as a telemonitoring system that only lets a patient establish and change a care plan, is insufficient to provide quality telemonitoring services. When a patient rather than medical staff establishes and monitors a care plan, it lowers the likelihood of achieving desired biometric goals, which increases risk of an emergency room visit for a chronic condition.

### Government Regulations

Medical providers in United States must adhere to the requirements of the Health Insurance Portability and Accountability Act of 1996 (HIPAA), which places certain requirements on “Protected Health Information.” Under the HIPAA rules, data must be protected, such as by use of encryption, a secure firewall, real time analytics, etc. to prevent unauthorized access to protected information, such as patient records. A health care provider must further establish policies and procedures to ensure that private patient data is kept confidential. In recent years, attacks from hackers to illegally obtain PHI have increased and the cost associated with those security breaches has increased exponentially.

### Telemonitoring Reimbursement

In the healthcare ecosystem, insurance providers, including the Center for Medicaid Services (CMS), are important participants. Health insurance providers have reimbursement policies for provision of telemonitoring services, however, those policies are often not clear and telemonitoring service coverage differs between health insurance providers.

Reimbursement models for physicians that provide telemonitoring services are changing and depend highly on regulations and policies dictated by health insurance providers to the network of health care providers. Administrative issues, such as determining which services are reimbursed by insurance providers, who is authorized to provide the care services, what kind of licenses are needed to provide a particular telehealth service, etc., are a significant problem for physicians providing telehealth services via a telemonitoring system. (State Coverage for Telehealth Services, (Updated January 2014) National Conference of State Legislatures. http://www.ncsl.org/research/health/state-coverage-for-telehealth-Services.aspx Accessed Jun. 1, 2015, an archive copy of which is available at http://web.archive.org/web/20151127192025/http://www.ncsl.org/research/health/state-coverage-for-telehealth-services.aspx.)

### Care Coordination Problems

Other problems associated with patient treatment administered via a telemonitoring system include care coordination problems, such as patient care plan administration and analytics when the patient information is fragmented among different electronic health record systems. Many times patients do not have access to their care plan or health data, so they find it difficult to understand their treatment, current condition, current assessment, the goals established by the Medical Doctor, etc. When all this information is fragmented and not available in an integrated fashion, it creates inefficiencies and difficulties for a physician or other medical staff treating a patient, thereby reducing the probability that the patient has a successful treatment.

Care coordination problems are also related to patient compliance to a medical care plan. When there are poor communication channels between medical staff, the patient, caregivers, or other care team members, additional care coordination problems arise. Such poor communications result in, among others, lack of medical knowledge and information of patients suffering chronic conditions.

Reference to various health data flows practiced by a telemonitoring system will now be made in following embodiments, workflows, data flows and examples, some of which are illustrated in the associated figures. A number of specific details are set forth in order to provide a thorough understanding of the disclosed technology. However, the described health data flow may be practiced without these specific details. Some data flows, methods, procedures, networks or algorithms have been described in general terms so as not unnecessarily confuse aspects of the embodiments.

The disclosed technology describes some embodiments of an “optimized data flow” that integrates wireless medical devices, health care providers, medical staff, patients suffering chronic conditions including metabolic syndrome, care givers, Electronic Data Interchange (EDI) platforms for data interchange with Insurance providers and pharmacies, Electronic Health Record (EHR) systems, third party notification systems with a web/mobile application for providing telemonitoring of biometrics and collecting the required health data of the patient needed to provide a custom care plan, audio and video communication for constant interaction between patient and health care providers, and efficient billing process for the health care provider doing the telemonitoring.

Some embodiments of the disclosed technology involve a telemonitoring system that integrates all the services and functions required to provide the telemonitoring service covered by the health data flow. The patient can apply to be enrolled into a telemonitoring service under the supervision of the health care provider, receive a unique patient identifier, and the telemonitoring system can synchronize the patient clinical information.

Using standard protocols and APIs, the telemonitoring system can integrate efficiently with EHR systems, insurance health plan systems, and pharmacies, to collect patient health data. A telemonitoring system can provide an API for synchronizing biometric data with mobile applications. Some wireless medical devices can synchronize biometric data acquired by the medical devices with a telemonitoring system, such as by communicating with a mobile application running at a patient's mobile device. In some embodiments, the patient's mobile device is part of the telemonitoring system, and in other embodiments, the patient's mobile device sends the biometric data to the telemonitoring system for synchronization.

In some embodiments, medical staff perform all the functions associated with establishing a patient care plan, such as setting patient biometric parameters, and performing analytics of data acquired by the telemonitoring system.

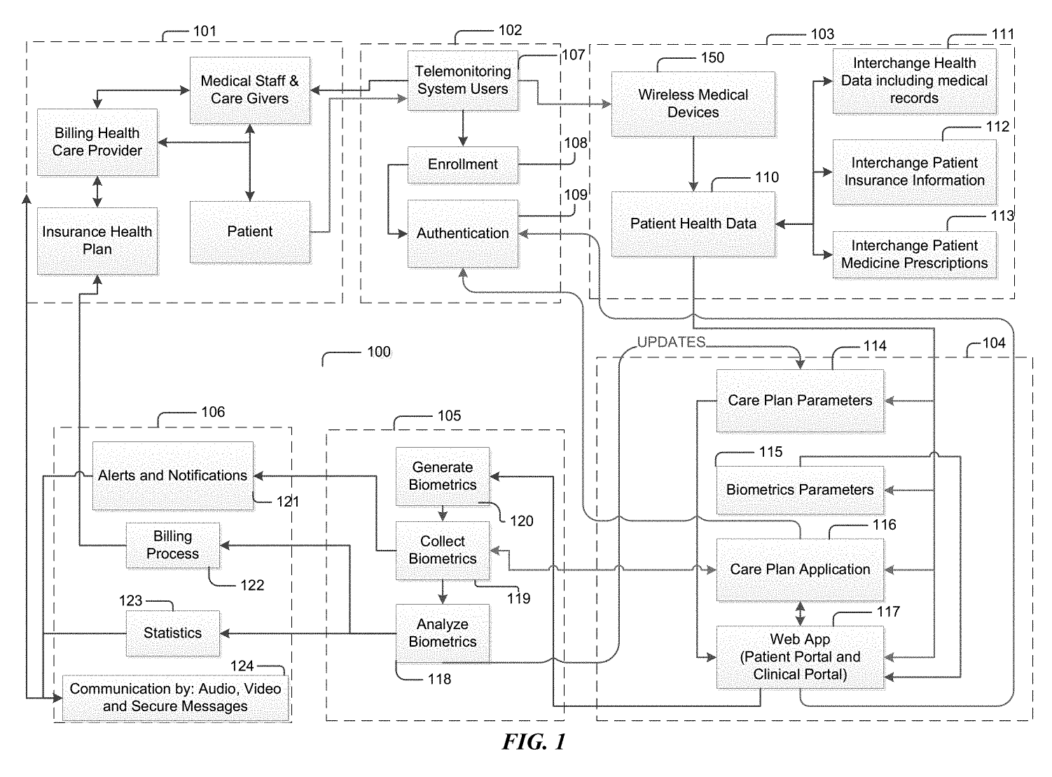

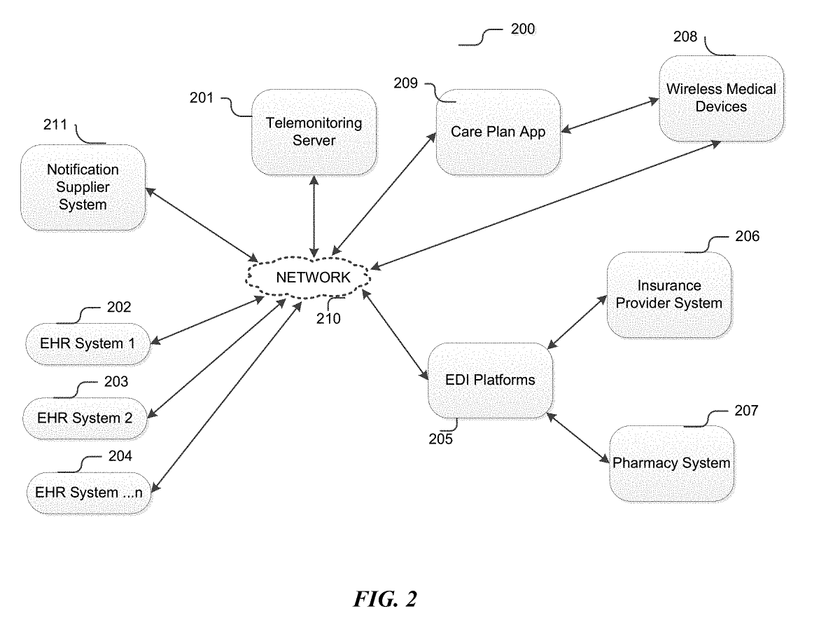

FIG. 1. is a flow diagram that illustrates a workflow for telemonitoring a patient's compliance with a care plan, consistent with various embodiments. As shown in the example of FIG. 1, block 101 shows common interactions between a patient's insurance health plan, a patient's health care provider, a patient, medical staff & care givers that can be facilitated by use of a telemonitoring system, such as telemonitoring system 200 of FIG. 2. A health care provider is a person or entity that is able to provide and bill for health care services, such as a doctor practicing as a sole proprietorship, a medical corporation, a medical partnership, etc. Medical staff are licensed medical professionals and those that are authorized by a licensed medical professional to provide medical-related services, such as doctors, nurses, dieticians, counselors, appointment schedulers, billing coordinators, etc. A care giver is a person that provides health-related care to a patient outside of a medical facility, such as a relative that assists a patient at home in taking a biometric reading or administering medication to the patient, a person who is trained to provide health-related care to a patient at their home, etc. A care team are those people that provide health-related care to a patient, such as a health care provider, medical staff, care givers, etc.

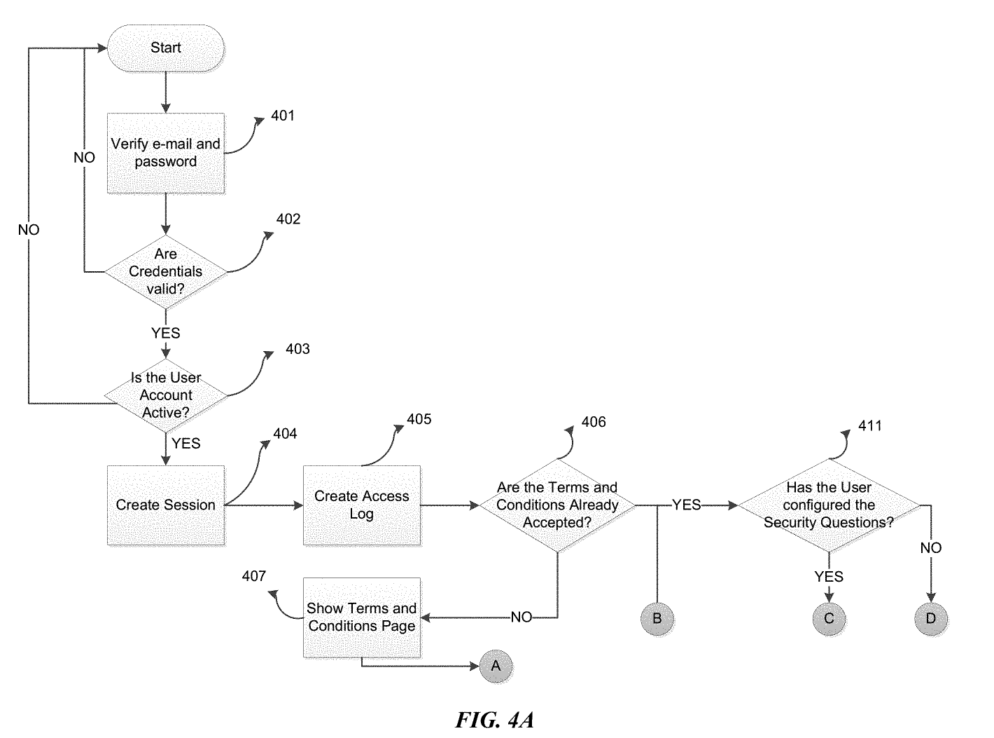

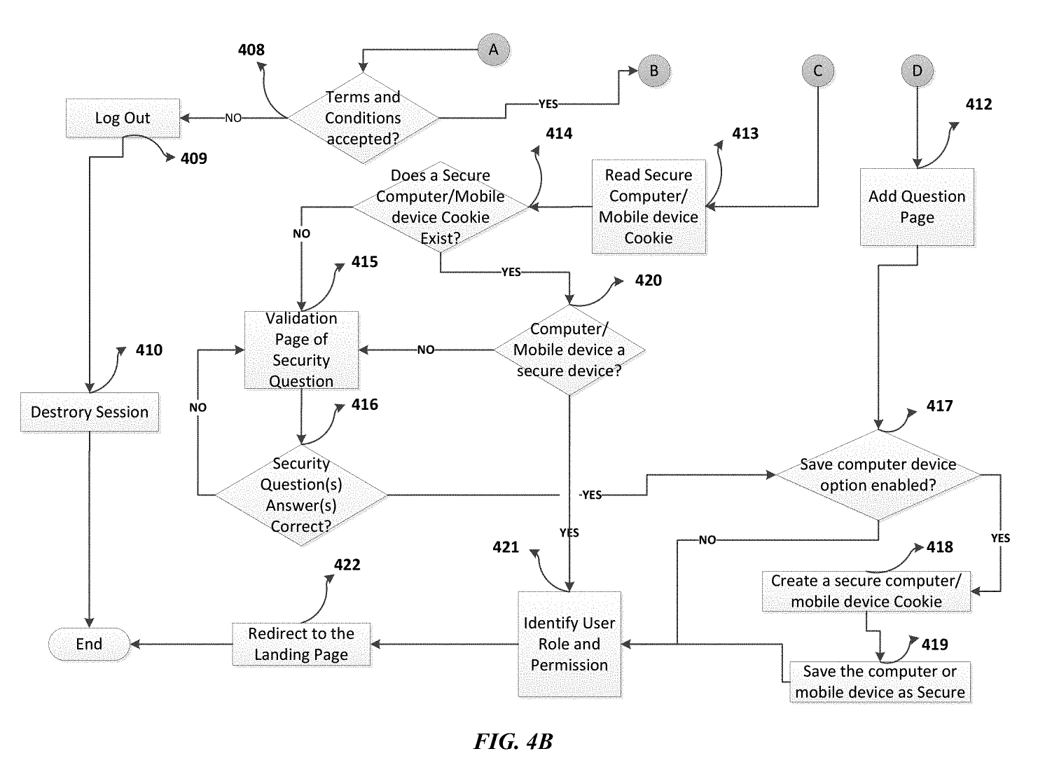

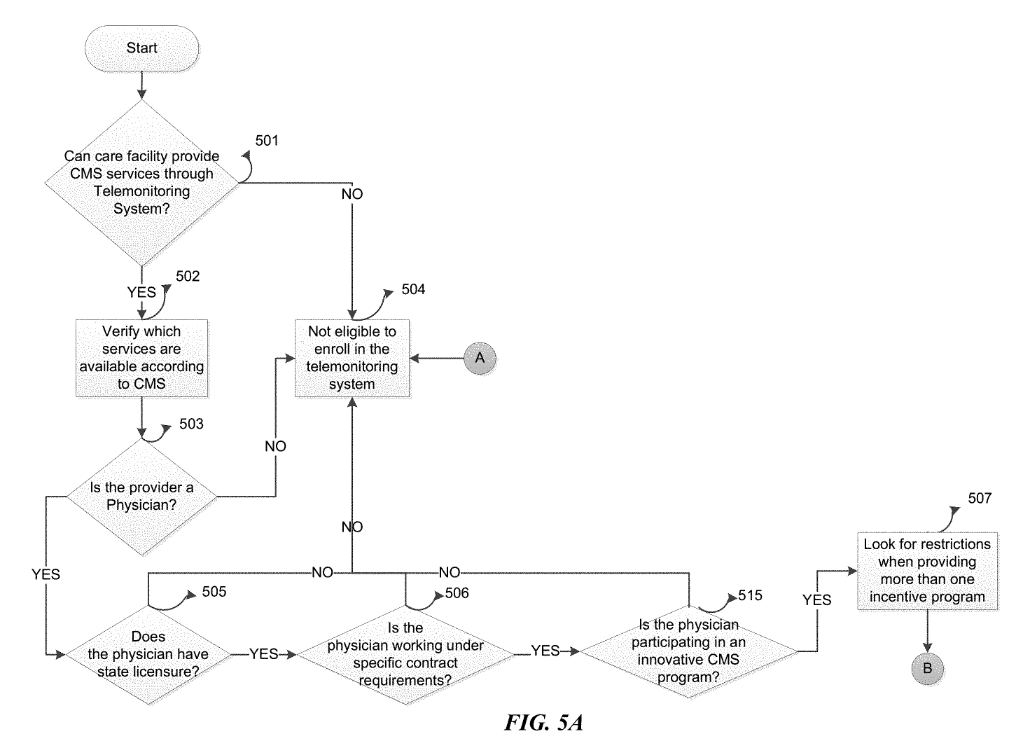

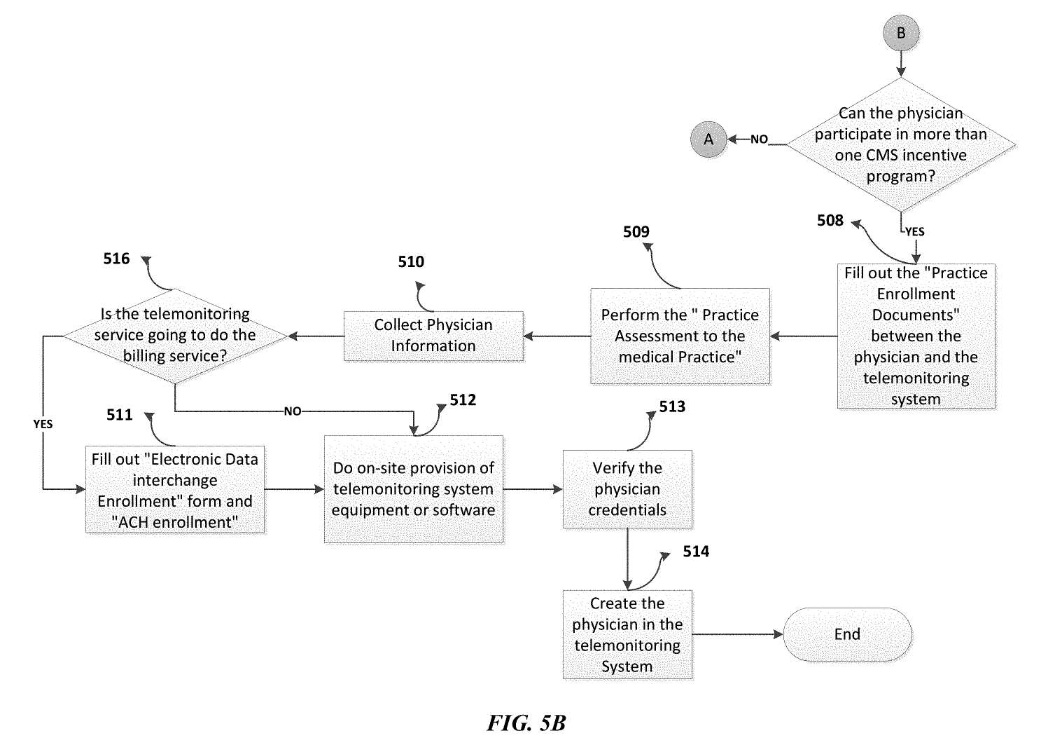

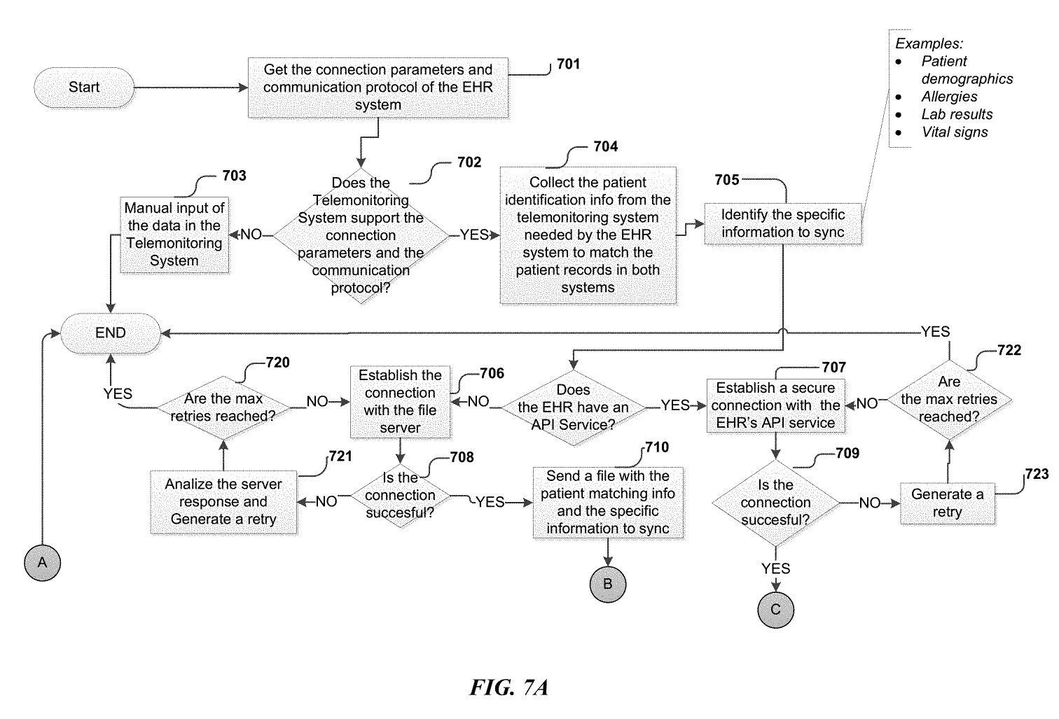

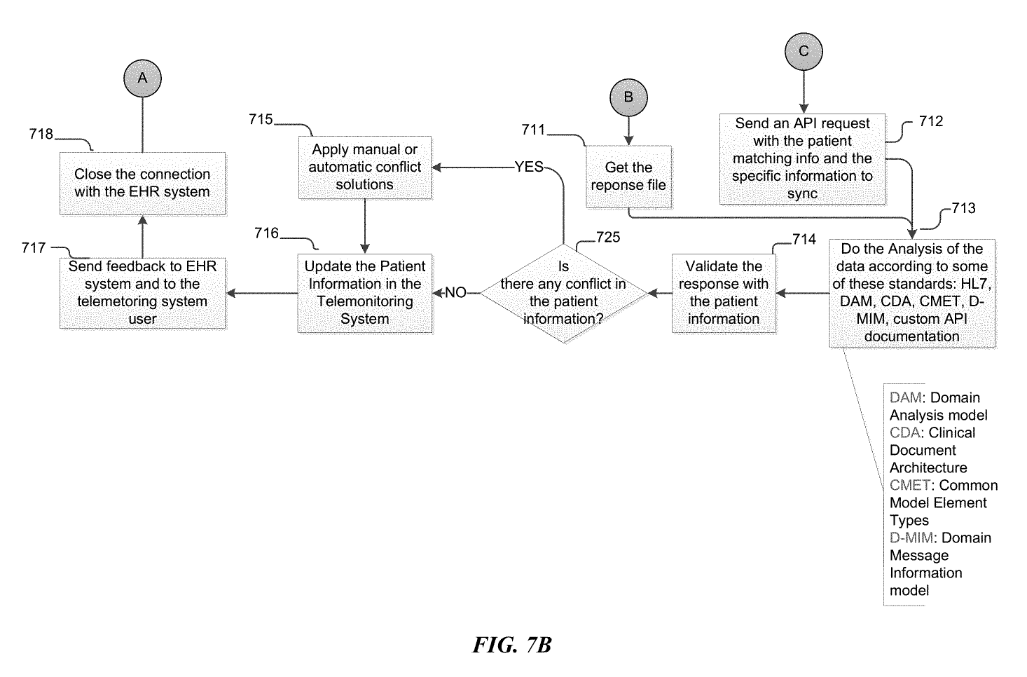

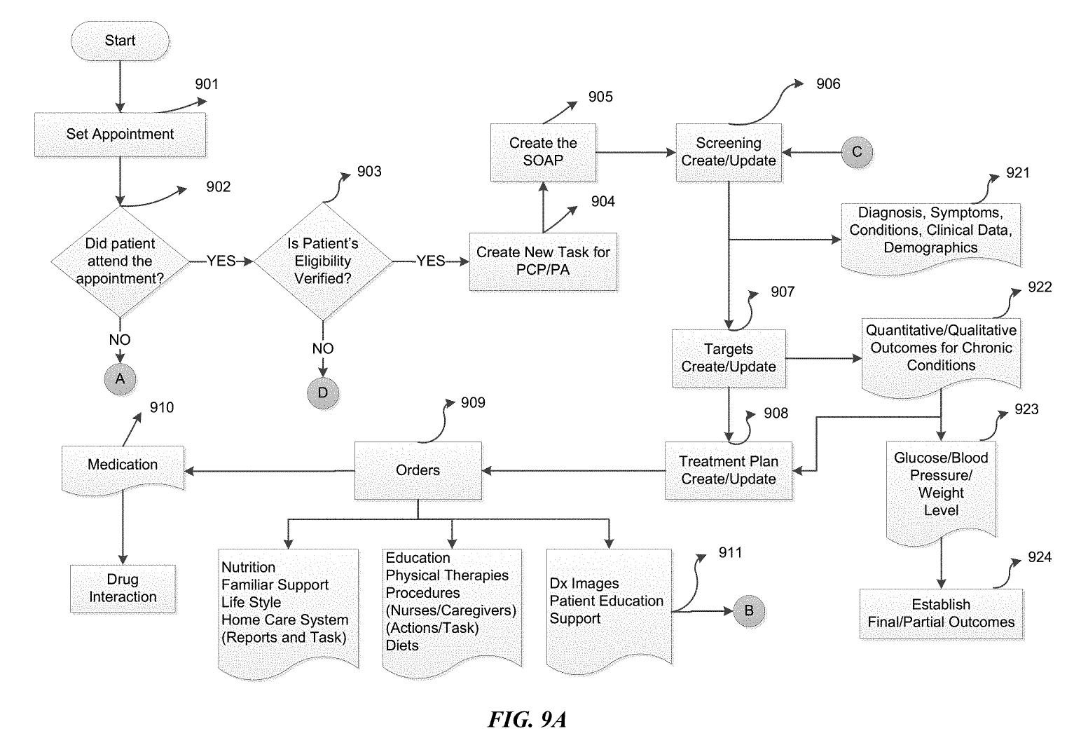

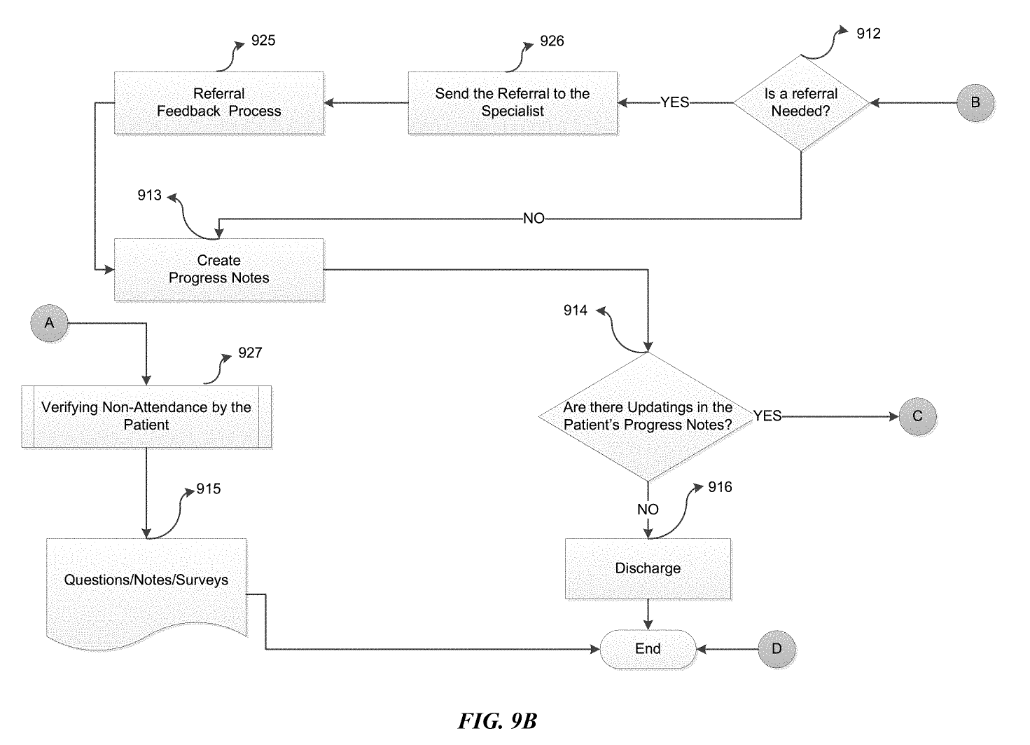

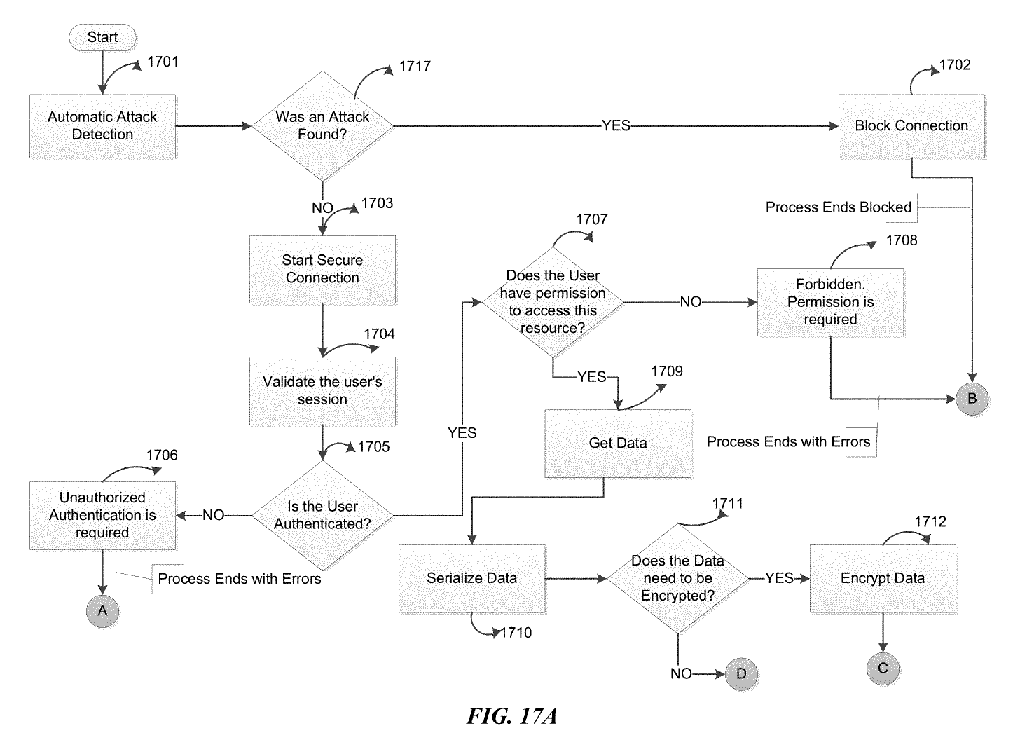

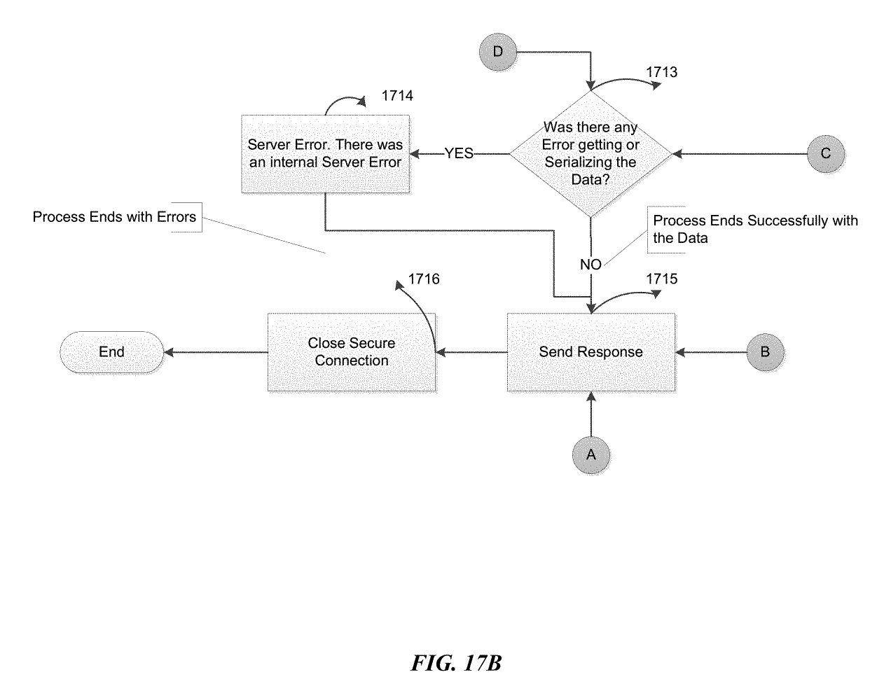

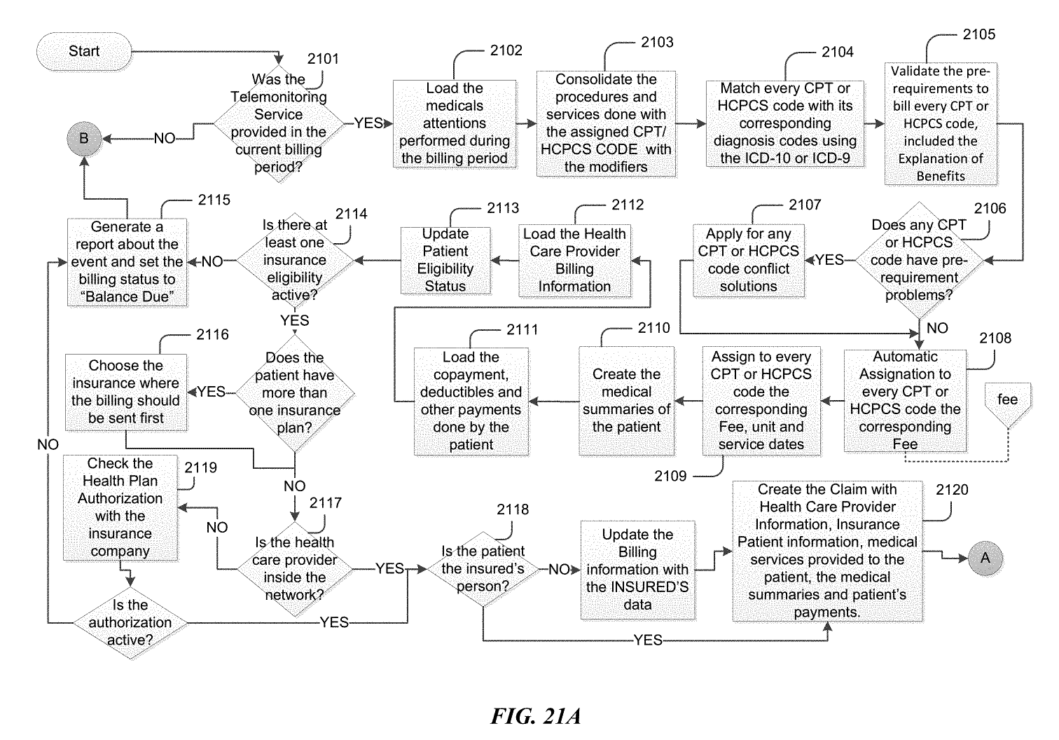

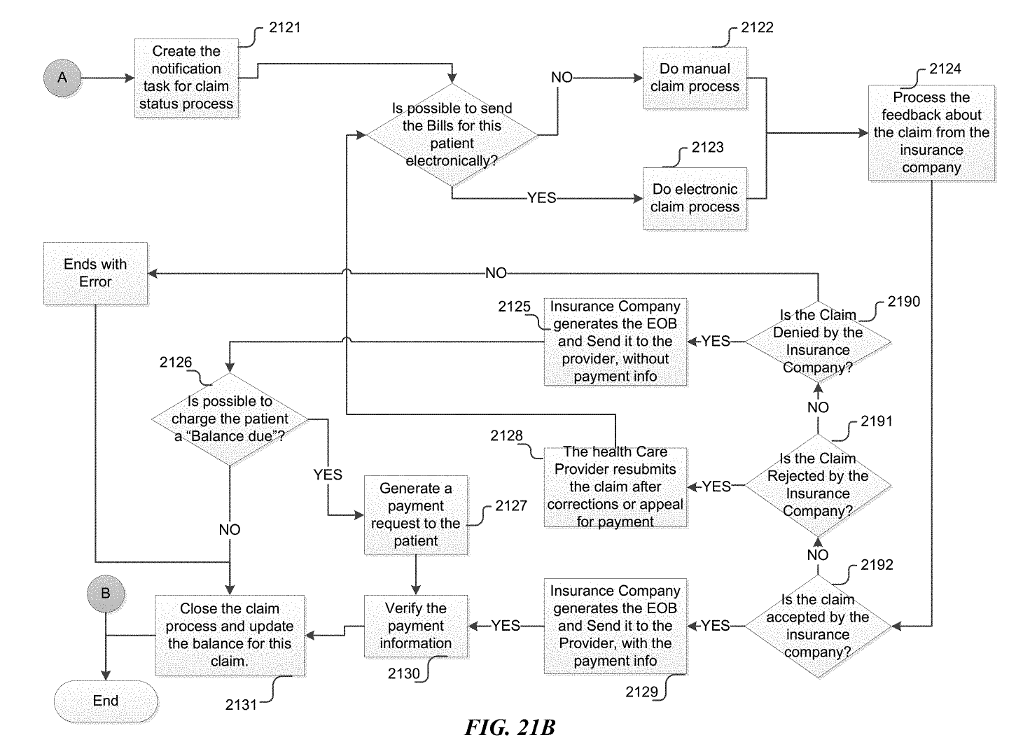

Interaction between the billing health care provider and the health insurance health plan is bidirectional, and can start when a business agreement to provide medical services is established between the parties. Interaction between the health care provider and the medical staff and care givers is bidirectional, as the staff and care givers use the telemonitoring system to establish or monitor a care plan for a patient (see FIG. 9), and the billing health care provider utilizes the care plan and monitoring to bill the insurance health plan for services provided (see FIG. 21). At block 102, the health care provider, the medical staff, care givers and patients become telemonitoring system users 107, with specific roles, permissions and responsibilities assigned. The users follow a customized enrollment process during enrollment 108. In some embodiments, once a user is enrolled, he logs in at the telemonitoring system according to a login and authentication process (see FIGS. 4, 17) that implements authentication process 109 of the telemonitoring system, the user is assigned a role (see FIGS. 5, 10, 11). At block 103, wireless medical devices 150 are assigned to a patient for generating biometric data required to monitor the patient's compliance with a medical care plan and associated health progress. The biometric and other data is stored at patient health data 110. Patient health data 110 is one of the cores of the telemonitoring system. Patient health data 110 is where the telemonitoring system also stores patient information for other telemonitoring system modules, or for other systems that require information interchange, such as: medical records 111 (see FIG. 7), patient's insurance 112 or medicine prescriptions 113. Storing patient data at patient health data 110 enables centralized location of data stored at a secure location, and enables timely access to complete clinical information in compliance with regulations issued by HIPAA.

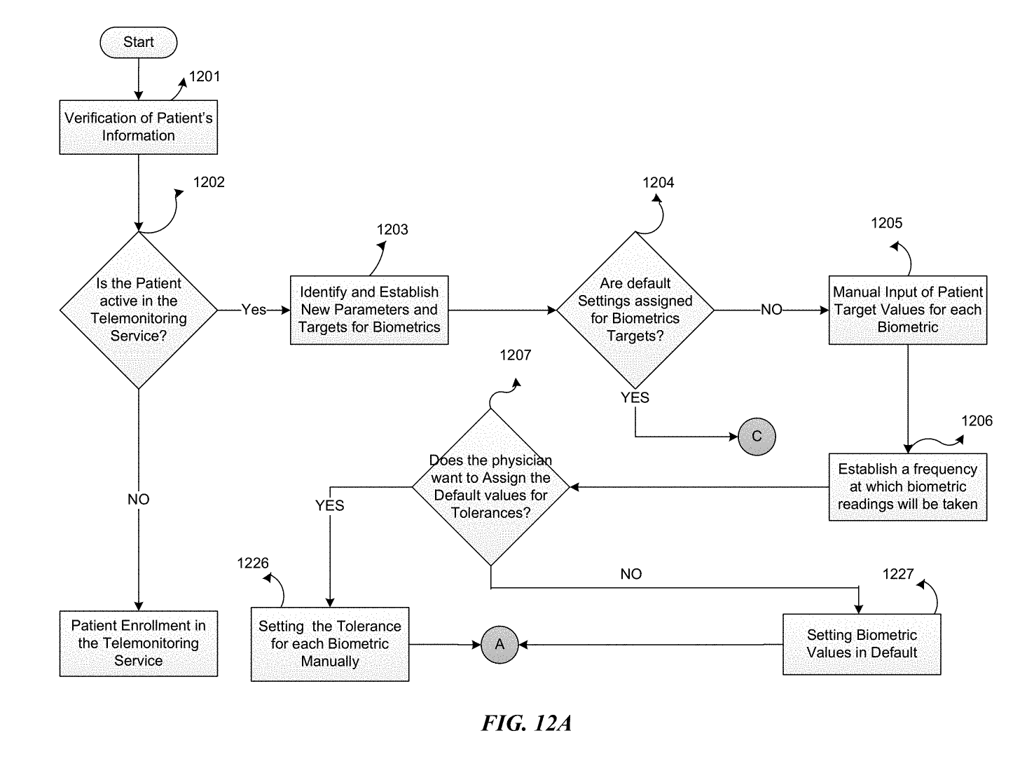

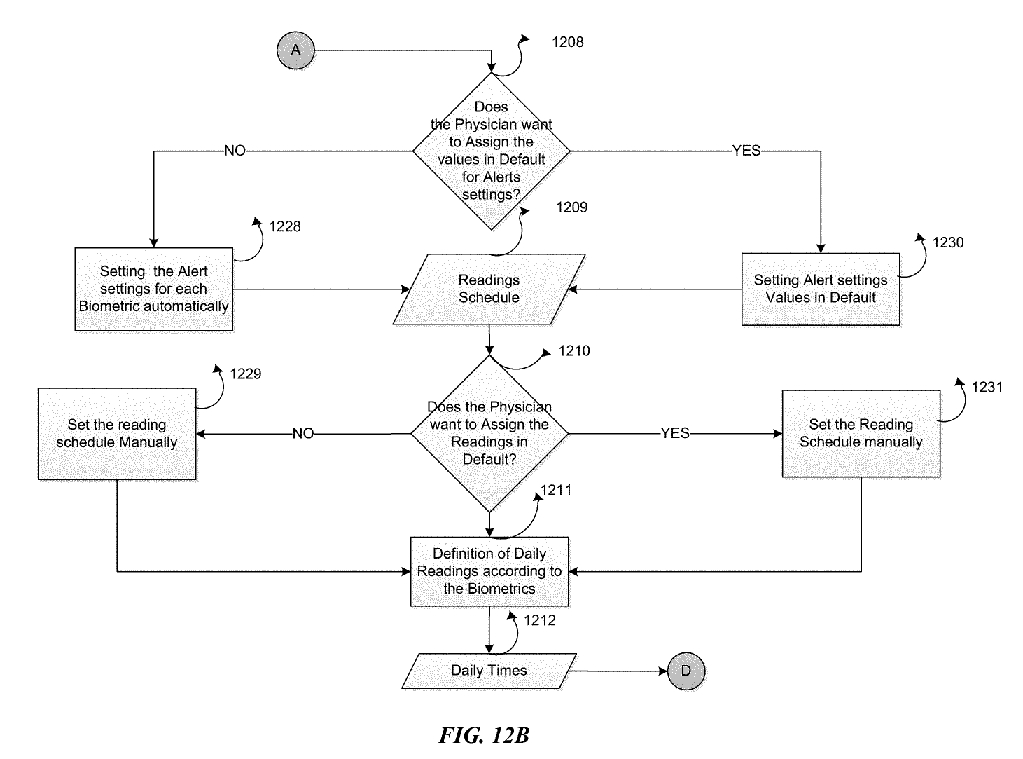

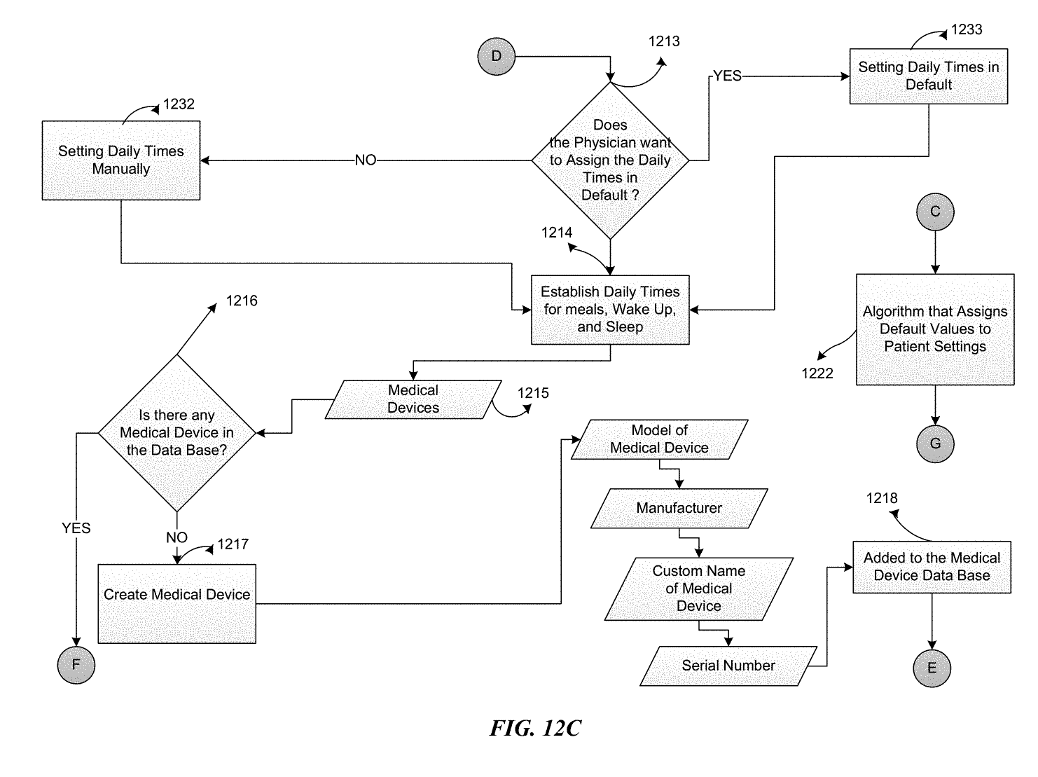

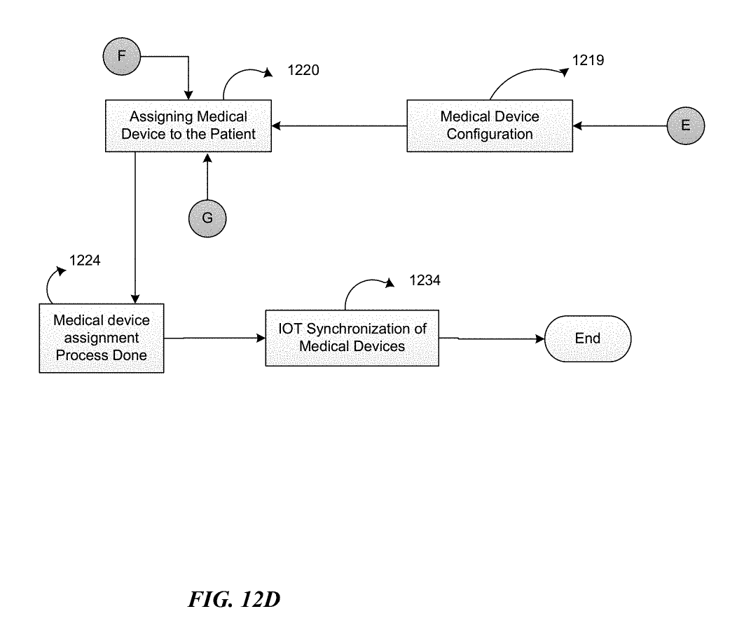

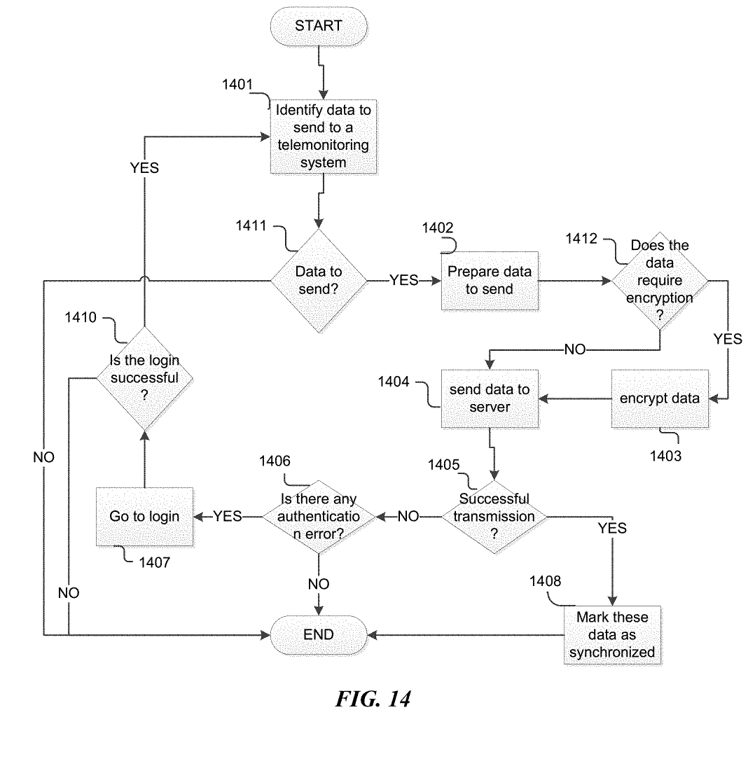

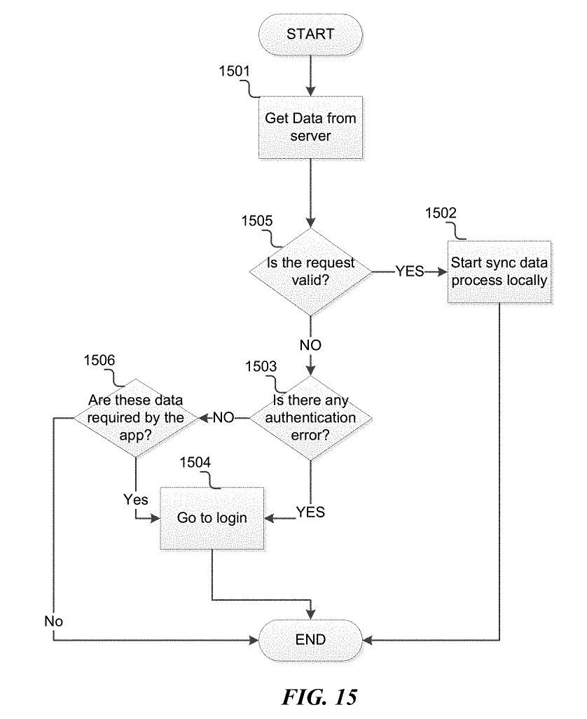

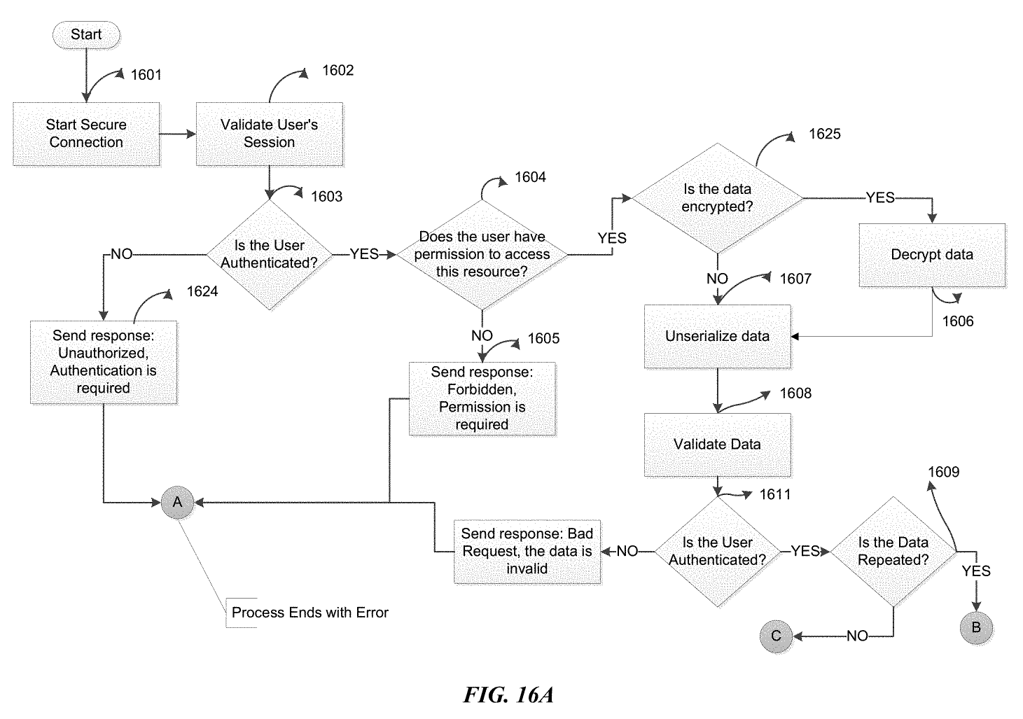

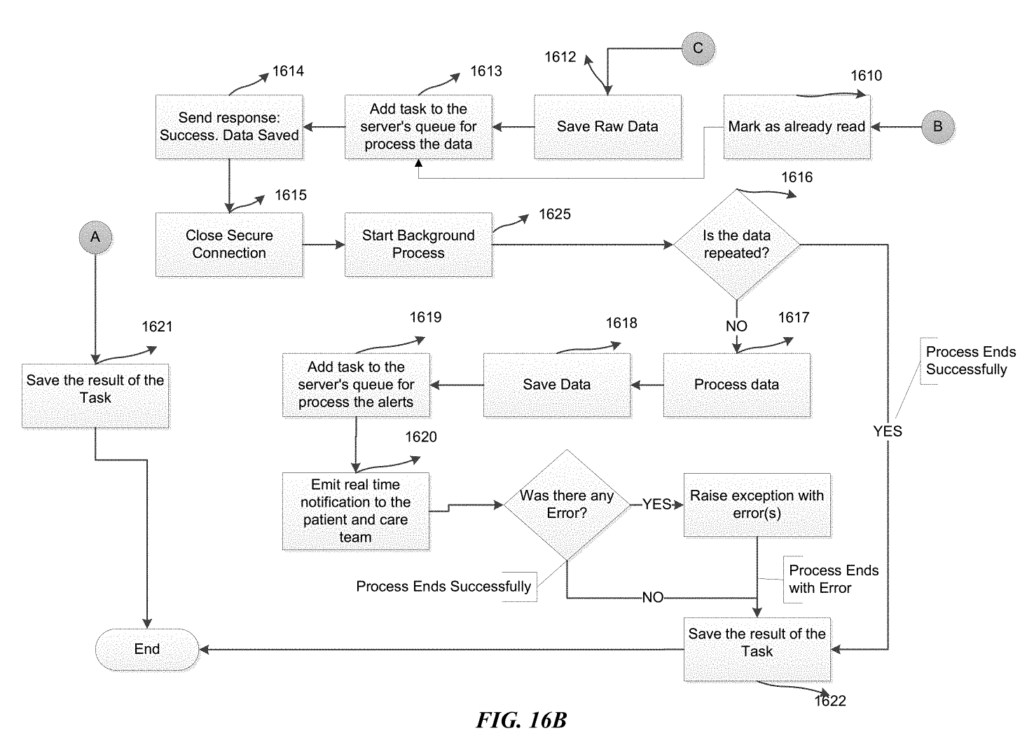

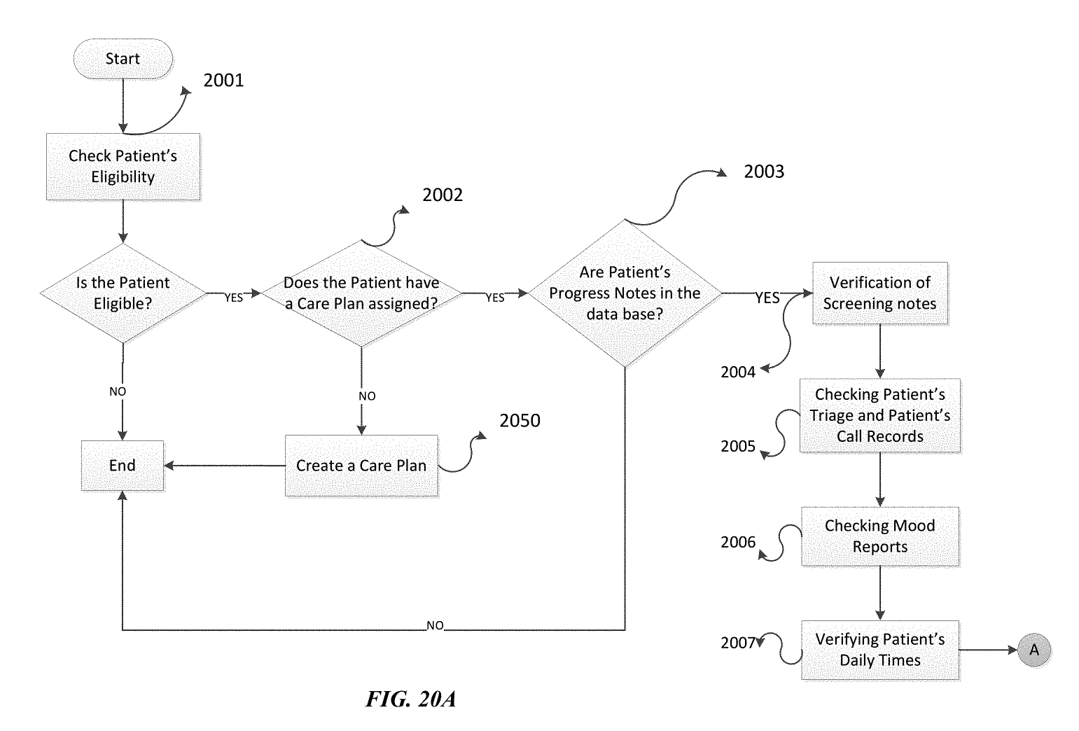

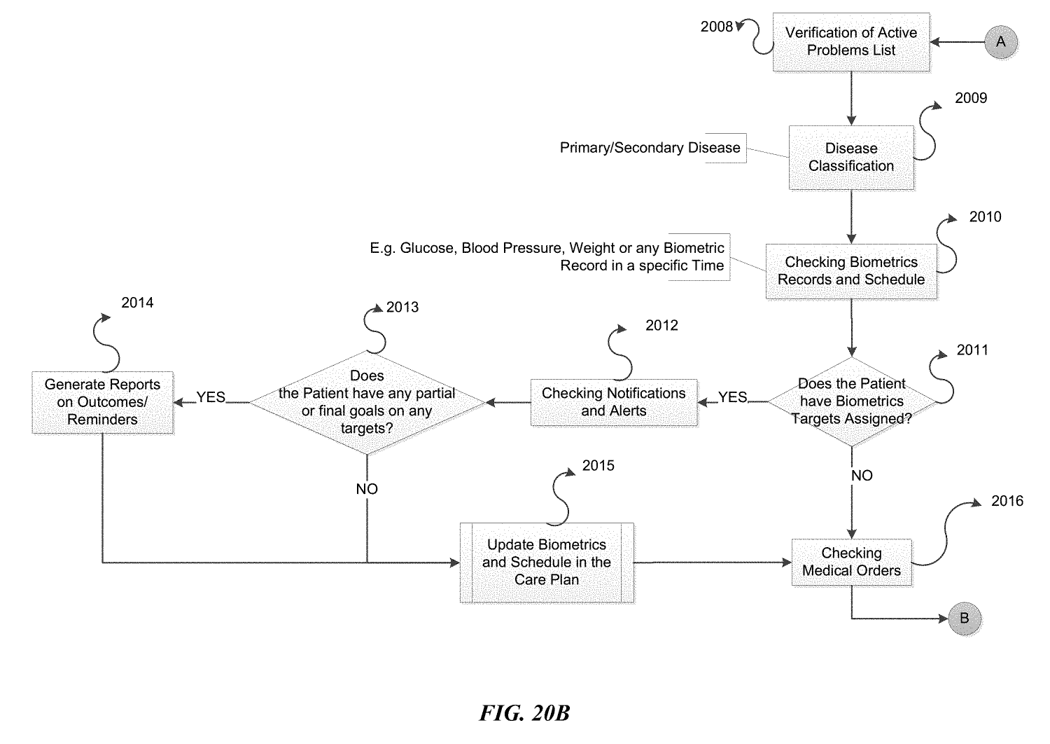

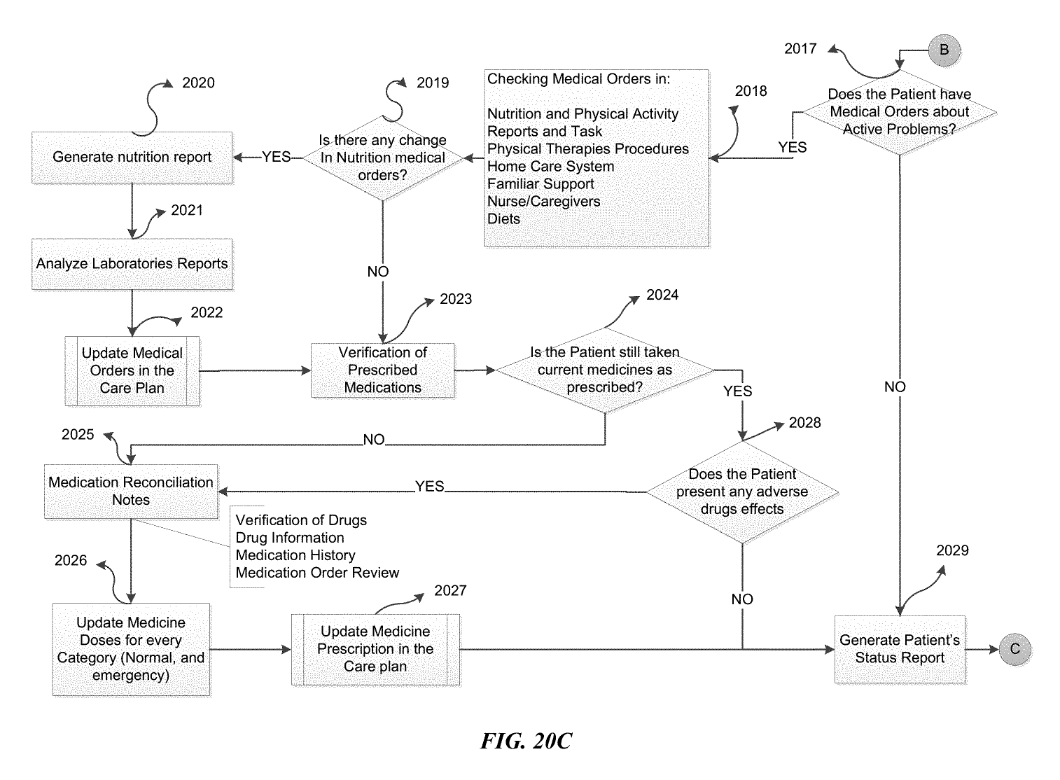

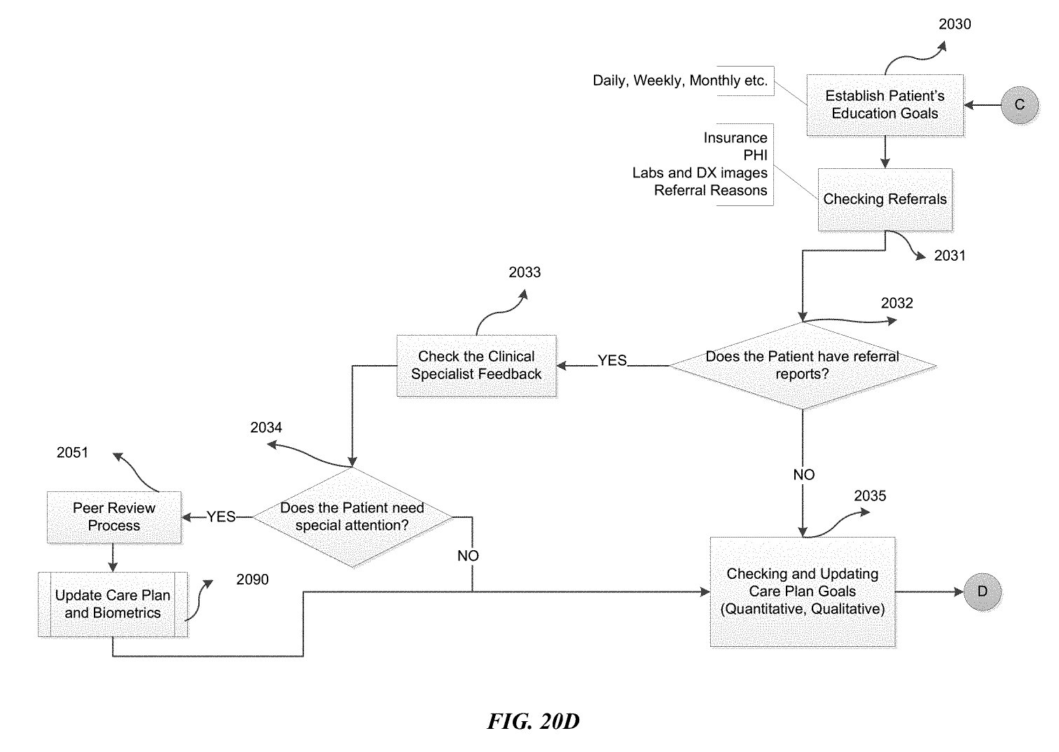

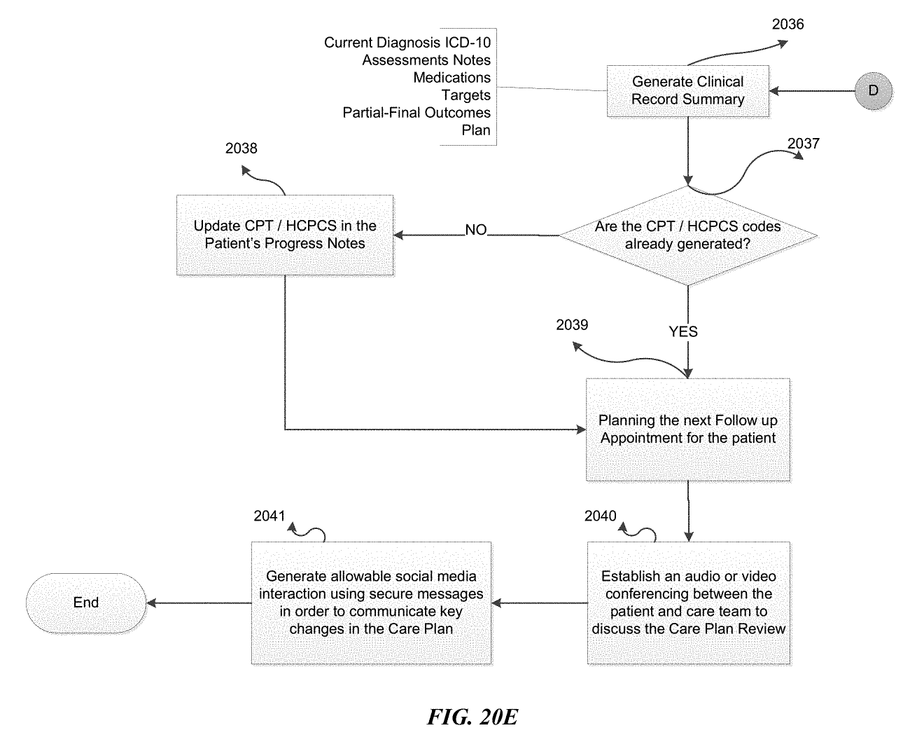

At block 104, after a patient is enrolled in the telemonitoring system (enrollment 108) and the minimum patient health data is collected (patient health data 110), the telemonitoring system allows setting up a patient care plan 104 (see FIG. 9). Establishing a patient care plan includes establishing care plan parameters 114 and biometrics parameters 115 (see FIG. 12) to enable analysis of biometric data and adjustment/refinement of the care plan (see FIG. 20). Components that can provide a user interface for collecting biometric data or displaying stored data include care plan application 116, which can run on the patient's mobile device or another computing device, and which can provide a gateway to send and store biometric data at patient health data 110. Care plan application 116 can connect to an API Web Service (see FIGS. 14 and 15) of the telemonitoring system and can also get all the parameters established for the monitored patient. The user connection is protected by authentication process 109. Web App 117 is a web application that enables medical staff, care givers or patients to interact with the telemonitoring system from any device that can run a web browser. Web app 117 is protected by authentication process 109. Web app 117 also enables audio and video communications between users (e.g., patients, medical staff, care givers, health care providers, insurers, etc.) of the telemonitoring system. At block 105, patient biometrics are generated (block 120), collected (block 119) and analyzed (block 118) by the telemonitoring system (see FIGS. 16, 18, 19, 22). Upon completion of biometric data analysis 118, Patient Care Plan parameters 114 and the Biometrics Parameters 115 can be updated.

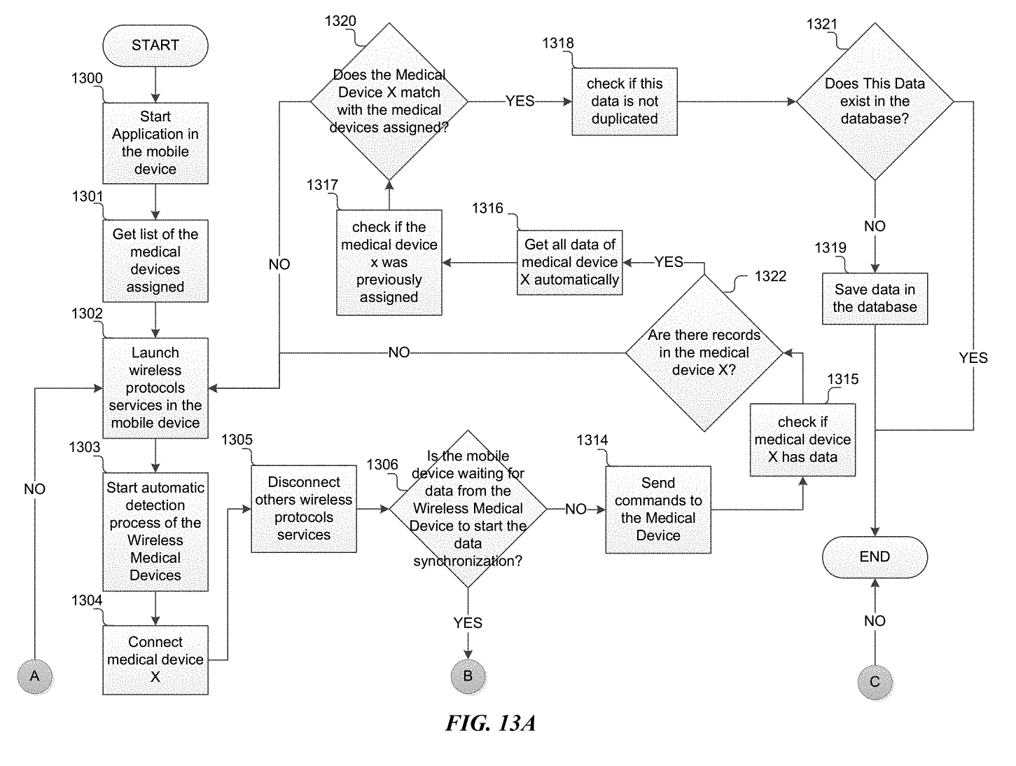

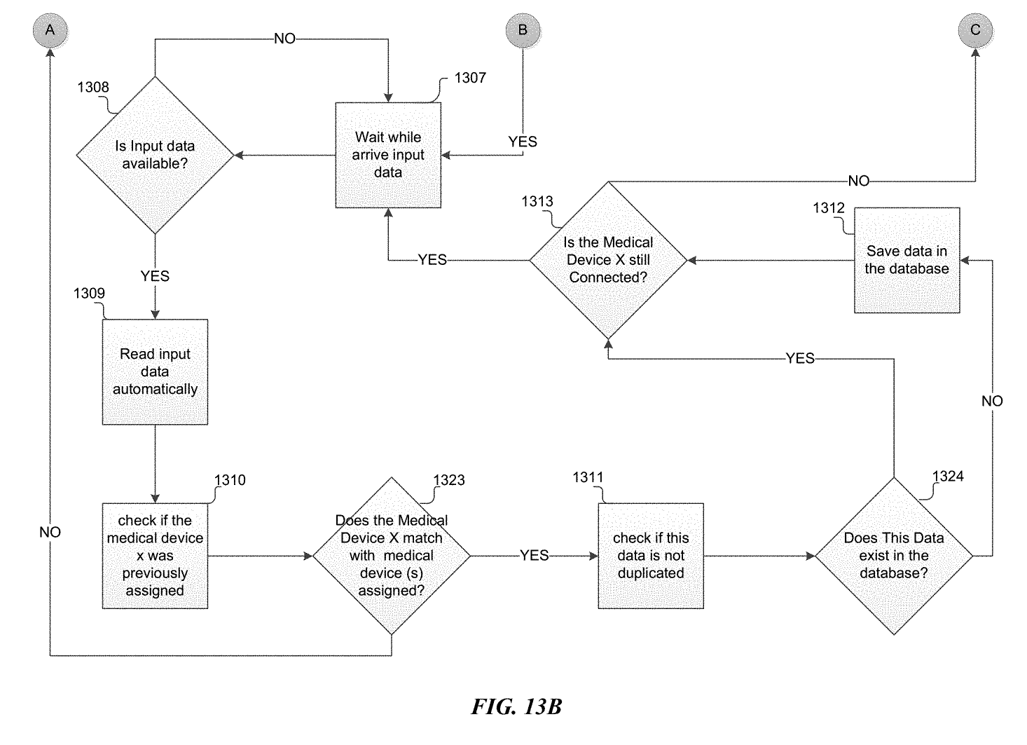

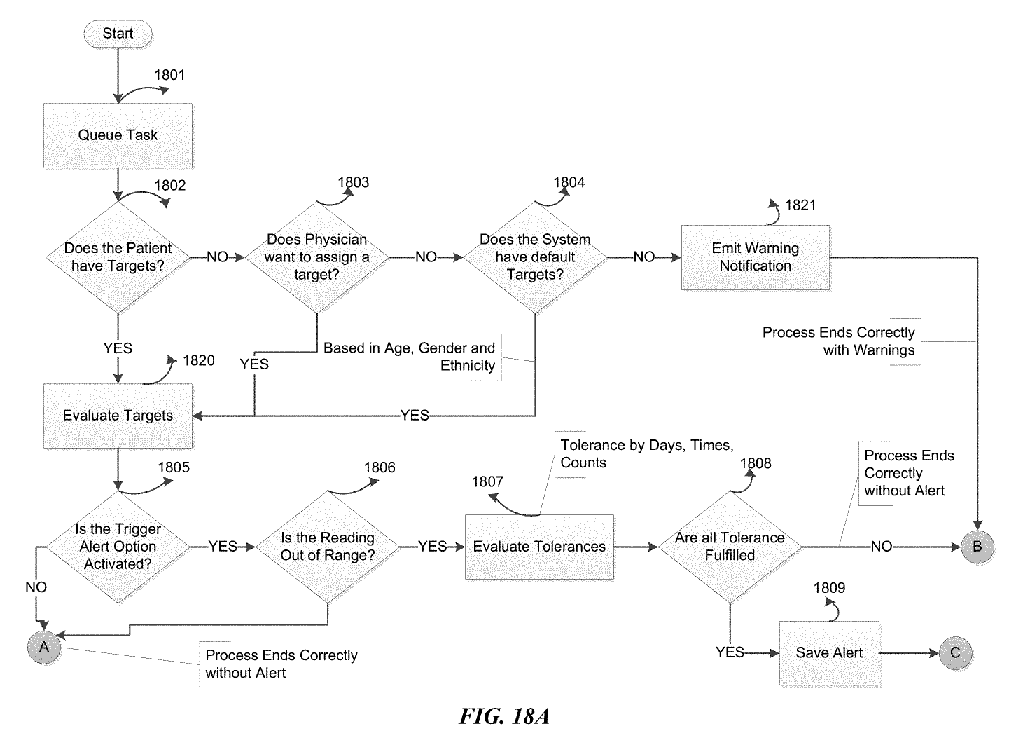

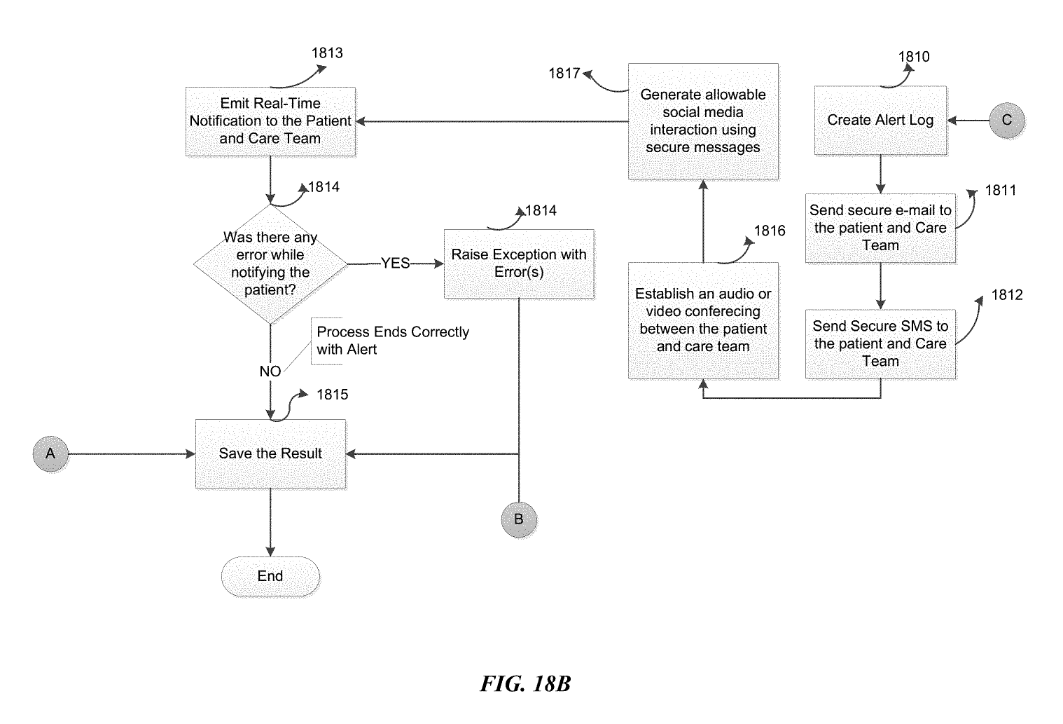

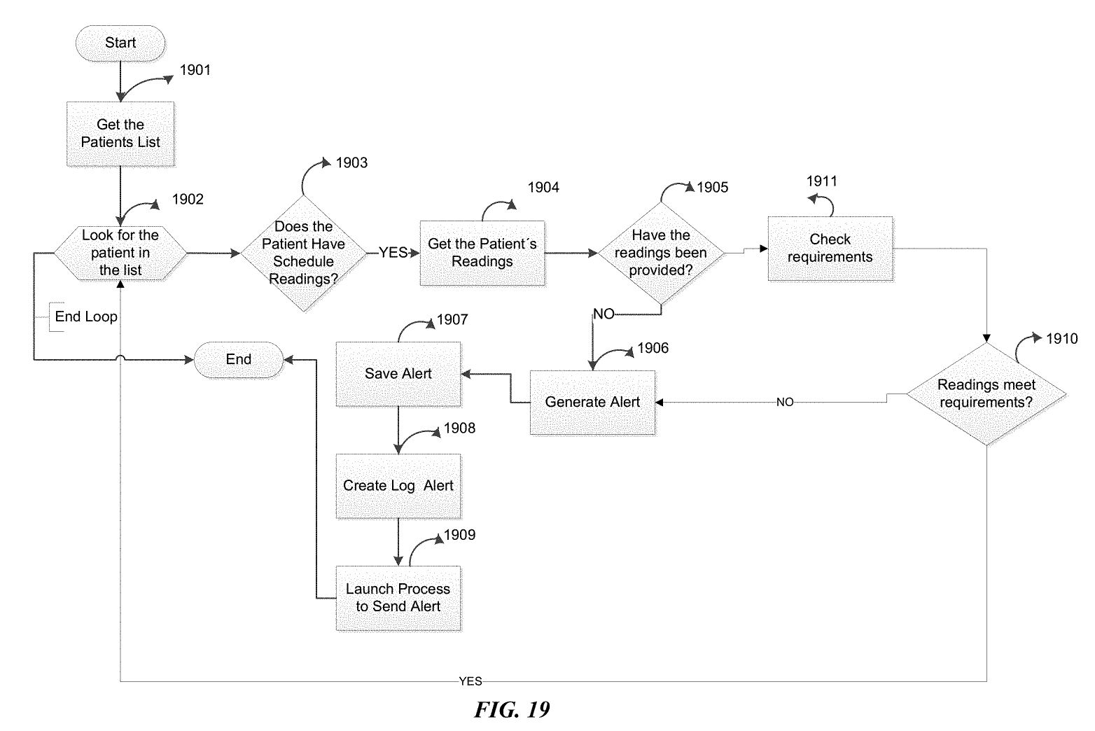

At block 106, based on the collection and analysis of biometrics (see FIGS. 13-15), the telemonitoring system can generate alerts and notifications 121 (see FIGS. 18 and 19). The telemonitoring system can further perform billing process 122, where the health care provider charges the insurance health plan for the rendered medical services. The telemonitoring system can further generate statistics 123 that can provide insight into the medical condition of the patient, and which can be used to refine/adjust the medical care plan of the patient. To support personal interaction and health data interchange amongst the various telemonitoring system users (e.g., the health care providers, patient, medical staff and care givers, etc.), the telemonitoring system provides communication by audio, video and secure messages 124.

FIG. 2. is a system diagram that illustrates high-level interactions between various platforms associated with a telemonitoring system, consistent with various embodiments. As shown in the example of FIG. 2, telemonitoring Server 201 can be coupled via network 210 with one or more Electronic Health Record (EHR) systems 202, 203, 204, EDI Platforms 205, insurance provider systems 206, pharmacy systems 207, care plan applications 209, wireless medical devices 208, or Notification Supplier Systems 211. Wireless medical devices 208 can be wireless medical devices 109 of FIG. 1, and EHR systems 202-204 can be patient health data 110. EHR systems 202-204 store patient information and patient medical records from any medical practice that belongs to a health care provider that is enrolled in the telemonitoring system (see FIG. 5). Telemonitoring system 200, such as via telemonitoring server 201, provides an API service, a file transfer service, etc., to interoperate the data with EHR systems 202-204. In some embodiments, telemonitoring system 200 is telemonitoring server 201.

Telemonitoring Server 201 is coupled with EDI Platforms 205 via network environment 210, which provides standards for exchanging data via any of various electronic means. EDI platforms 205 can be used to enable interchange health data including medical records 111 of FIG. 1, to enable interchange patient insurance information 112, or to enable interchange patient medicine prescriptions 113. Telemonitoring system 200, such as via telemonitoring server 201, can provide a process for exchanging data with the insurance provider system 206 or pharmacy system 207 by use of EDI Platforms 205. For example, an insurance provider system can provide information about patient eligibility status, or can receive electronic billing claims for the telemonitoring services provided to a patient using telemonitoring system 200. Wireless medical devices 208 generate the patient's biometric data and sends the data to the telemonitoring system, such as via care plan application 209 and network environment 210, or via network environment 210. Care plan application 209 can be an application that runs on a mobile device, such as the patient's smartphone or tablet computer, or can be an application that runs on another computing device. For example, a glucose meter captures the patient's glucose level and connects with the care plan application by wireless communication, where the care plan application obtains the glucose readings from the glucose meter and sends the biometric data (e.g., the glucose readings) to the telemonitoring system, reducing the computational energy and keeping the data secure.

Care plan application 209 can access data of telemonitoring system 200, and can set up parameters in wireless medical devices 208. The telemonitoring server 201 can include an online web application to administer the health data flow, process the biometric data, and perform other functions, such as generating care plan related alerts, reminders, notifications, etc. In addition, telemonitoring system 200 is coupled with Notification Supplier System 211, which is a system that supports communication by any of various means, such as by sending email or text (SMS) messages between users, by establishing audio or video communications between user devices, by sending short message (SMS) or push notification to care plan application 209. For example, when a biometric reading is out of range based on the parameters for the patient stored at the telemonitoring system, telemonitoring system 200 notifies the patient and medical staff via notification supplier system 211.

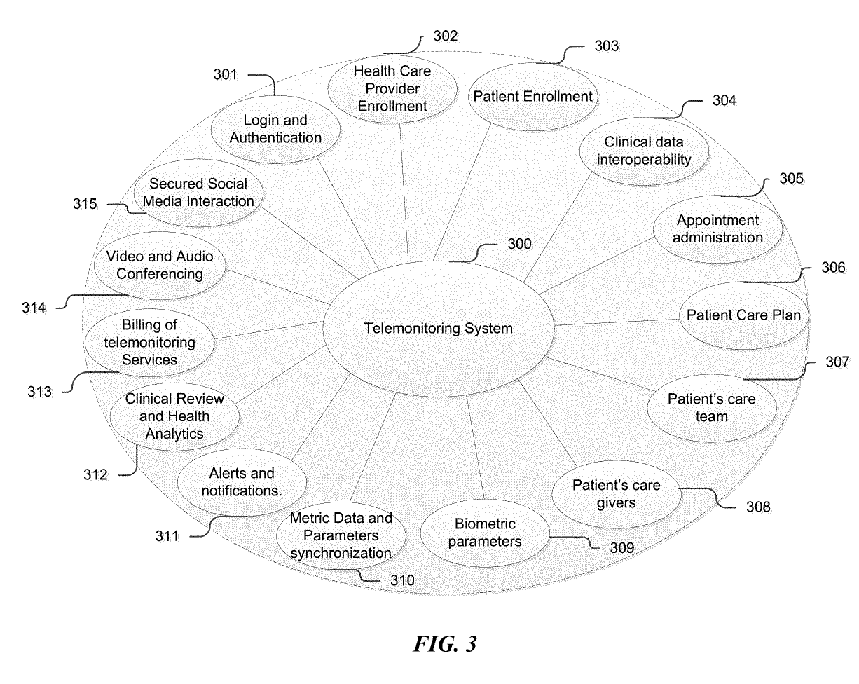

FIG. 3. is a diagram that illustrates components of a system for telemonitoring a patient's compliance with a care plan, also referred to as a telemonitoring system, consistent with various embodiments. FIG. 3 illustrates an exemplary telemonitoring system 300, which integrates various components/modules/processes that will be described in detail in following figures. The components of telemonitoring system 300 include Login and Authentication 301, health care provider enrollment 302, Patient Enrollment 303, Clinical data interoperability 304, Appointment administration 305, Patient Care Plan 306, Patient's medical staff 307, Patient's care givers 308, Biometric parameters 309, Metric Data and Parameters synchronization 310, Alerts and notifications 311, Clinical Review and Health Analytics 312, Billing of telemonitoring Services 313, Video and Audio Conferencing services 314, and Secured Social Media Interaction 315.

In the example of FIG. 3, Login and Authentication component 301 includes processes and techniques for keeping secure health data information for components of telemonitoring system 300. Health care provider enrollment 302 includes information and processes required by any health care provider that is providing telemonitoring services under insurance coverage. Patient enrollment 303 includes processes for enrolling patients with telemonitoring system 300, which enables telemonitoring system 300 to properly bill an insurance provider for services provided by telemonitoring system 300. Clinical data interoperability 304 includes an API with JavaScript Object Notification (JSON) format or any other acceptable format, and file transfer service compliant with Health Level Seven (HL7) standards or any appropriate standard or custom format. Appointment Administration 305 provides support for sending notifications, reminders, etc., regarding schedules of users, such as the patient's schedule or the medical staffs' schedule.

Patient care plan 306 integrates the various components of the patient's care plan, which can include, e.g., assessments, goals, prescriptions, treatment details, exercise plans, nutrition plans, biometric testing plans, etc. Patient care plan 306 can be customized in one or more templates, such as in templates for managing any of various chronic diseases, chronic pain conditions, etc. Patient's medical staff component 307 enables assignment of medical staff members to the patient's care and care plan activities. For example, a doctor can be assigned as a primary care giver, a nurse can be assigned as a medical staff care giver, a patient's relative can be assigned as a family care giver, etc., and the various care givers can be given various levels of access to the patient's health data, and can be assigned various tasks related to the patient's care. Biometric parameters component 309 manages communications with wireless medical devices for obtaining biometric data in support of the care plan. Metric data and parameter synchronization 310 includes an API service with JSON format or any other standard or custom format that serves the patient health data, biometrics parameters, and biometrics readings for keeping the information synchronized between various components of a telemonitoring system, such as between a care plan application and a wireless medical device, or a care plan application and a telemonitoring server, etc. Once biometric data and parameters are established, alerts and notification component 311 is able to process and analyze biometric data to determine, based on the patent care plan, if any alert or notification should be generated.

Clinical Review and Health Analytics component 312 includes techniques and processes to process health data in order to generate data that can be used to modify the care plan and biometric parameters for a patient, to improve the patient's care plan and associated health care. Billing of telemonitoring services component 313 includes techniques and processes for generating an insurance claim to send to the patient's insurance health plan in order to obtain payment for medical services provided to the patient in relation with the telemonitoring services. Audio and video conferencing component 314 includes techniques and processes for providing communication capabilities among the various users of the telemonitoring system, such as the health care provider, the patient, the medical staff and care givers, the insurance provider, etc. Secure Social Media Interaction component 315 includes techniques and processes for generating, processing, and sending real-time secure messages between users, and for supporting obtaining usage statistics. Users can include medical staff, care providers, patients, insurance company employees, pharmacy company employees, among others.

FIGS. 4A-B are a flow diagram that illustrates a login process at a telemonitoring system, consistent with various embodiments. In the example of FIGS. 4A-B, each user of a telemonitoring system has his or her own security credentials, and users are able to login by use of his or her security credentials. A user can login at a telemonitoring system by use of a mobile device or other computing device that is running a care plan application, by use of a computing device that can run a web browser, etc. In some embodiments, some or all users login by use of a login process that includes two-factor authentication (“2FA”). At blocks 401-403, a new user provides an email address and password, which are verified, his or her credentials are verified to be valid, and his or her user account is verified to be active. When blocks 401-403 are all verified, at block 404, the telemonitoring system creates a session (404) and logs information related to the user's login (405). At blocks 406, the telemonitoring system verifies whether the user has accepted the terms and conditions. If not, the telemonitoring system causes the terms and conditions to be displayed at the user's computing device (407).

When a user decides to decline the terms and conditions, the telemonitoring system ends the process and redirects to the login page (409, 410). When a user accepts the terms and conditions (406), the telemonitoring system verifies that the user has configured security questions (411). If not, the telemonitoring system causes an “adding security questions” page to be displayed at the user's computing device (412). When the telemonitoring system is able to validate that the user's computer or mobile device is secure (413, 414, 420), the telemonitoring system proceeds to identify the user's role and permission (421), otherwise, the telemonitoring system executes security question validation (415, 416). Once the user is validated, the user can select the option “save this device as secure” (417), in which case the telemonitoring system identifies the computing device as secure and saves this information (417, 418, 419). When the telemonitoring system identifies the user's permissions and roles (421), the telemonitoring system redirects to an appropriate landing page (422), such as the user's dashboard in a Web Application or Mobile Application.

FIGS. 5A-B are a flow diagram that illustrates a process for enrolling a health care provider at a telemonitoring system, consistent with various embodiments. In the example of FIG. 5, at block 501, the telemonitoring system determines whether a care provider is able to perform CMS services via a telemonitoring system. If the care provider is authorized to provide the service, the telemonitoring system classifies it according to CMS rules (CMS establishes different programs for various types of providers based on several requirements) and assigns program(s) that the care provider can or may provide (502). At block 503, the telemonitoring system verifies that a care provider includes an appropriately licensed medical professional (e.g., Physician, Psychiatrist, Surgeon, etc.). Non-doctors (Registered Nurse, Physician Assistant, Clinical Nurse Midwife, Psychologist, Social Worker, Nurse Practitioner, etc.) can participate, but, in the example of FIG. 5, initial enrollment by a new provider requires a medical doctor. To provide medical services, in any state of USA, a license is mandatory for any provider. At block 505, the telemonitoring system verifies that the medical doctor has a valid state license. At block 506, the telemonitoring system determines whether the medical doctor is working under specific contract requirements. At block 515, the telemonitoring system determines whether the medical doctor is participating in an innovative CMS programs (e.g., a program offered via the CMS Innovation Center).

At block 507, the telemonitoring system determines whether the medical doctor or the care provider is providing services under more than one innovative CMS program, and determines what restrictions, if any, may result from participation in the more than one innovative CMS program. Some restrictions are set by CMS. If the provider is already participating in a CMS innovative Program, the telemonitoring system determines if the provider can apply to participate in an additional CMS innovative program, taking into account the programs' restrictions. If the provider is able to participate in the additional CMS innovative program(s), at block 508, the telemonitoring system provides the “Practice Enrollment” documents needed (e.g., Business Association Agreement and services Agreement), to ensure that patient's Protected Health Information is safe according to CMS laws and HIPAA compliance.

To meet the needs of the provider, the telemonitoring system assesses the practice (509), and generates/provides/obtains corresponding documentation. Once the practice is assessed, at block 510, the telemonitoring system proceeds to collect information required to the provide service(s). When a provider decides that the telemonitoring system will provide billing support (block 516), the telemonitoring system generates an Electronic Data Interchange Enrollment form (block 511), which may include claims and claims attachments, remittances, eligibility/benefits, claim status or any other electronic information that the provider may need to provide to CMS to become an authorized participant. At block 511, the telemonitoring system also generates/provides/obtains an ACH enrollment form, which is used for payment processing via the Automated Clearing House (ACH) payment system. At block 512, setup or installation of equipment or software at the provider's location is done under the provider's supervision and approval. Once the on-site setup is completed, the telemonitoring system verifies the provider's credentials (513), and creates the provider at the telemonitoring system (514).

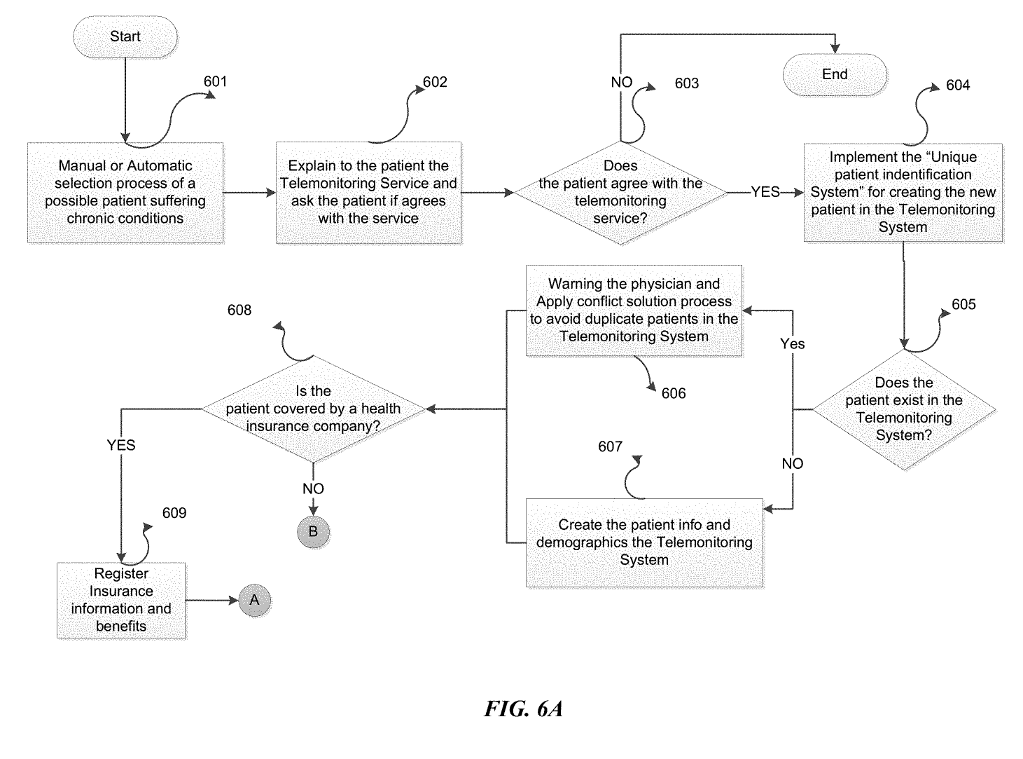

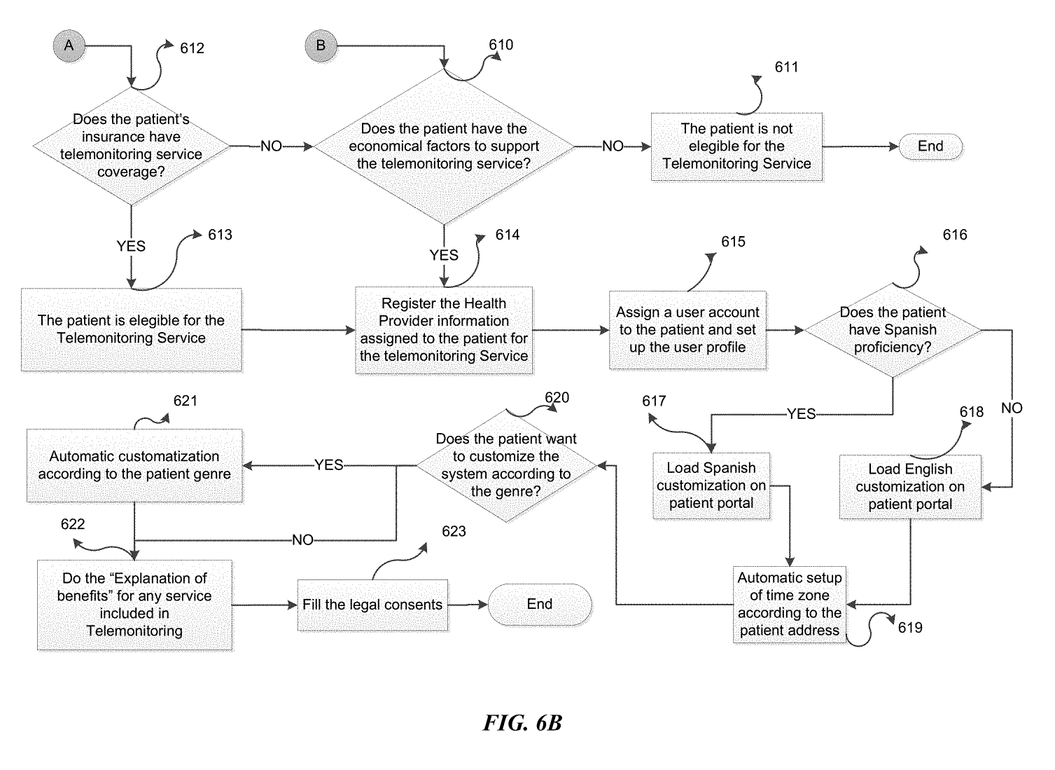

FIGS. 6A-B are a flow diagram that illustrates a process for enrolling a patient at a telemonitoring system, consistent with various embodiments. A telemonitoring system can provide an opportunity to leverage the increasing accessibility of mobile technologies and digital devices to empower users to monitor their own health outside of a hospital setting. To effectively provide such a service, a telemonitoring system should be accessible to and usable by patients who could benefit from such a system, such as sufferers of chronic disease. At block 601, a person manually, such as by use of a computing device that is part of or can communicate with the telemonitoring system, or the telemonitoring system automatically identifies a patient with any chronic condition in the data base by an assessment technique or process.

At block 602, a person or the telemonitoring system explains services provided by the telemonitoring system to a patient. For example, the telemonitoring system can cause a video to be displayed, at a computing device of a patient, that helps to explain the services provided by the telemonitoring system, and can display a service agreement, which the patient can read and electronically sign. Alternately, a health care professional, such as a physician, nurse, medical assistance, etc. can explain the services provided by the telemarketing system to the patient (602). At block 603, when the patient agrees to accept services of the telemonitoring system, the telemonitoring system will implement a unique patient's identification system (604) to assign a registry within the telemonitoring service. In case the patient is already enrolled (605), a warning message will be sent to a medical staff person and the telemonitoring system will apply a conflict solution process (606) to avoid creating a duplicate patient in the telemonitoring system's data base. If the patient does not exist, the telemonitoring system will cause a user interface to be displayed, such as at the medical staff member's computing device, where the medical staff member or the patient can input various enrollment or medical related information regarding the patient (607).

At block 608, the telemonitoring system determines whether the patient is covered by any public or private insurance provider. If so, the telemonitoring system saves information related to the insurance provider (609) and determines whether the insurance provider covers telemonitoring services (612). When a patient does not have the economic ability to pay for the telemonitoring service (610), the patient is not eligible (611). When blocks 610 and 612 evaluate positively, at block 614, the telemonitoring system proceeds to register the health provider information (614) and assign an account to the patient and establish the patient's profile at the telemonitoring system (615). An advantage of the telemonitoring system of this example is that it is oriented for multilingual users, including Spanish-speaking demographics like Hispanic/Latino communities. Accordingly, the telemonitoring system can be set in Spanish/English according to the user's language proficiency (616-618).

At block 619, the telemonitoring system establishes the time zone where the end user will be using the service, such as by receiving input from a patient via a computing device that indicates a time zone. At block 620, the telemonitoring system is customized according to the patient's sexual gender preferences, and at block 621, the telemonitoring system does further customization based on the patient's gender. At block 622, the telemonitoring system provides information regarding the benefits of telemonitoring, and at block 623, the user provides any needed legal consents.

FIGS. 7A-B are a flow diagram that illustrates a process for exchanging patient health information between Electronic Health Record (EHR) systems, consistent with various embodiments. To solve problems associated with Continuum of Care Coordination, the telemonitoring system includes processes whereby patient demographic information and medical records associated with a patient enrolled at the telemonitoring system can be obtained and synchronized to reduce computational energy, avoid rework for the telemonitoring system's users, and improve data reliability.

In the example of FIGS. 7A-B, a telemonitoring system imports patient information from an Electronic Health Record (EHR) system. At block 701, the telemonitoring system is setup with the connection and communication parameters to enable the telemonitoring system to successfully communicate with an EHR system. At block 702, the telemonitoring system determines whether it supports the connection parameters and the communication protocol of the EHR system. If not, at block 703, the patient's information is manually input at the telemonitoring system, such as by a medical staff member via a computing device that is part of or can communicate with the telemonitoring system.

Due to the nature of the interoperability engines in the health care industry, the telemonitoring system includes techniques and processes to ensure a successfully communication process between various systems. At block 704, the telemonitoring system collects patient identification information needed by the EHR system to match the patient records in the various systems. The telemonitoring system further identifies, based on protocols supported, what specific information can be synchronized, such as: patient demographics, allergies, vital signs, or other health information as identified by the telemonitoring system (705). When the telemonitoring system confirms which information can be synchronized, the communication is done using any of various techniques, such as via a file transfer server (706), an API service (707), etc. When a connection is not successful, the telemonitoring system applies a retry process (721, 723) to help ensure a successfully connection with the EHR system (708, 709). When communication is via file transfer, the telemonitoring system sends a file that is compliant with the receiving system, where the file includes patient matching information and specific information to synchronize with the EHR system (710).

At block 711, the telemonitoring system receives a response file generated by the EHR system. When communication is via an API service, such as a restful API service, the telemonitoring system sends an API request that includes patient matching information and specific information to synchronize with the EHR system (712). At block 713, analysis of the EHR system data is according to one or more of the following standards: HL7, DAM, CDA, CMET, D-MIM, or is via a custom API of the EHR system. At block 714, the telemonitoring system validates the data returned by the EHR system, and determines if there is any issue or conflict with the patient information (725). For data that doesn't meet requirements, the telemonitoring system may apply an automatic conflict/issue resolution process (715), or may allow a user to check and solve a conflict/issue manually (715). Once the response meets the requirements, the patient's records in the telemonitoring system are updated (716) and a notification about the operation result is sent either to the “EHR system” and the user of the telemonitoring system (717). Finally the connection between the interoperable systems is closed and all the changes saved (718).

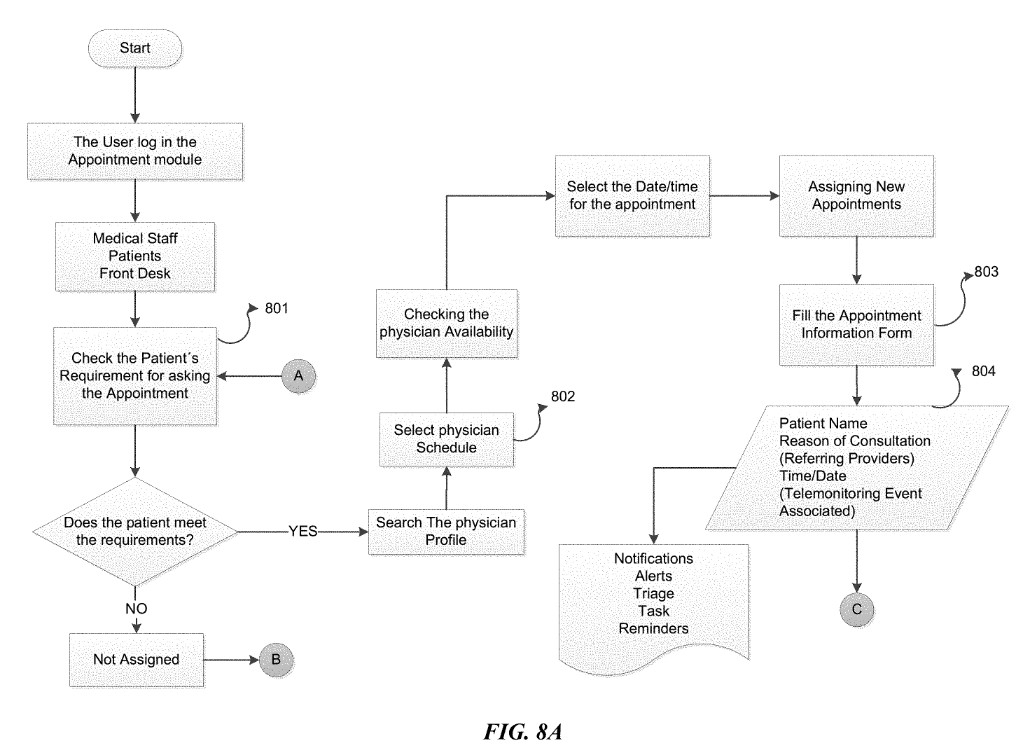

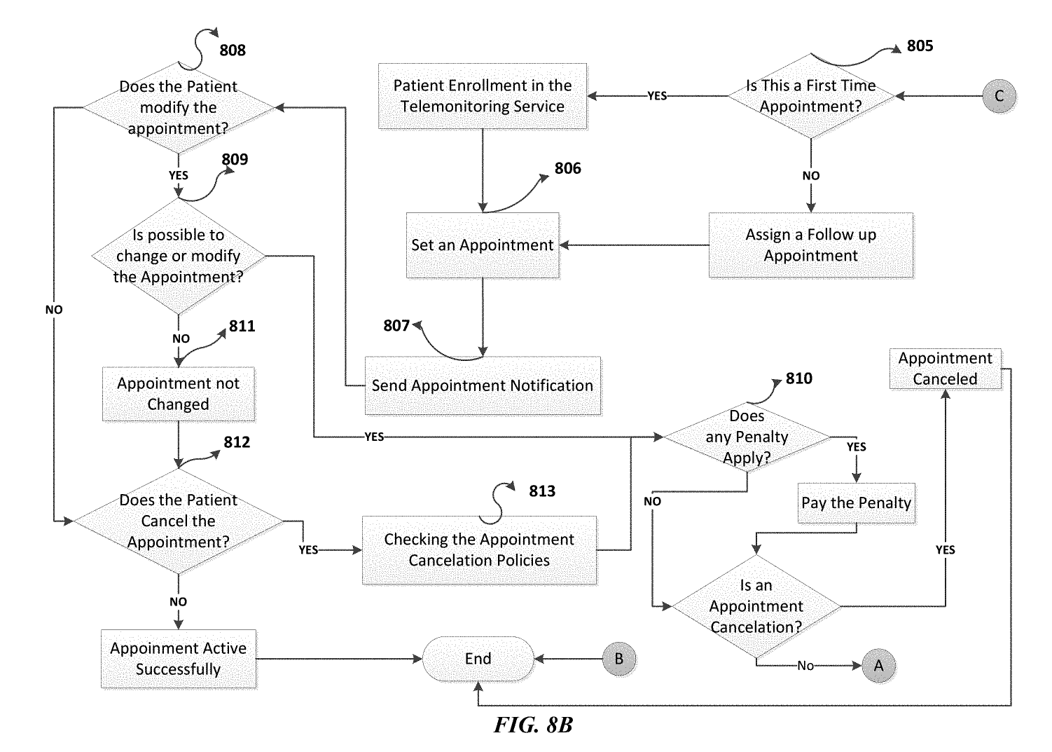

FIGS. 8A-B are a flow diagram that illustrates a process for generating, modifying, or canceling a medical appointment, consistent with various embodiments. An appointment administration function within a telemonitoring system allows medical staff, patients, etc. to manage and check appointments by the use of a schedule module of the telemonitoring system, which can medical consultations according to medical staff or patient needs. A medical staff member logs in and access an appointment module, and a patient communicates with the medical staff member to arrange an appointment, such as via an in person conversation, via a phone call, via an electronic message exchange, etc.

At block 801, the medical staff member determines if the patient will be granted an appointment. The medical staff member, sometimes with the assistance of the telemonitoring system, determines whether the patient meets the requirements to be granted a medical appointment. The medical staff member searches for physician profiles to determine an appropriate physician to see the patient, such as via a computing device that is part of or is in communication with the telemonitoring system, and the medical staff member selects the physician for the appointment (802). The medical staff member checks the physician's availability, and selects a date and time for the appointment. The medical staff member, with assistance from the telemonitoring system, assigns the appointment and provides appointment information (803).

The appointment information can include, for example, the reason for the consultation, referring providers, time/date, or the associated Telemonitoring event, such as: a notification, an alert, triage, task, or reminders (804). The telemonitoring system notifies the physician with the status of the appointment, such as whether it is a first time or follow up appointment (805). When the appointment is a first time appointment, the medical staff enrolls the patient in the telemonitoring service, and sets the appointment (806). When the appointment is a follow up appointment, the medical staff sets the appointment (806). At various times, the telemonitoring system sends a notification to remind the patient of the upcoming appointment (807). A patient may modify an appointment (808), in which case the telemonitoring system determines whether the appointment can be changed (809), and whether any penalty may apply (810). The patient may decide to cancel the appointment (812), in which case the telemonitoring system determines whether the appointment can be canceled (813), and whether any penalties apply (810).

FIGS. 9A-B are a flow diagram that illustrate a process for establishing a care plan for a patient enrolled at a telemonitoring system, consistent with various embodiments. A key component of a Telemonitoring system is a Patient Care Plan. A patient care plan component encompasses a tailored treatment process for a chronic condition to observe progress and evolution of a patient's health. Content of a care plan can be dynamic and depends on the systematic implementation of the care plan after the patient's first visit. At block 901, a patient works with a medical staff member or the telemonitoring system to set a medical appointment. When the patent shows up to the appointment (902), the telemonitoring system determines the patient's eligibility for a telemonitoring service (903), and creates a new task a new for medical staff (904), such as a primary care physician, a physician's assistant, etc. When the patient does not show up for the appointment, at block 915, notes are generated regarding the non-attendance.

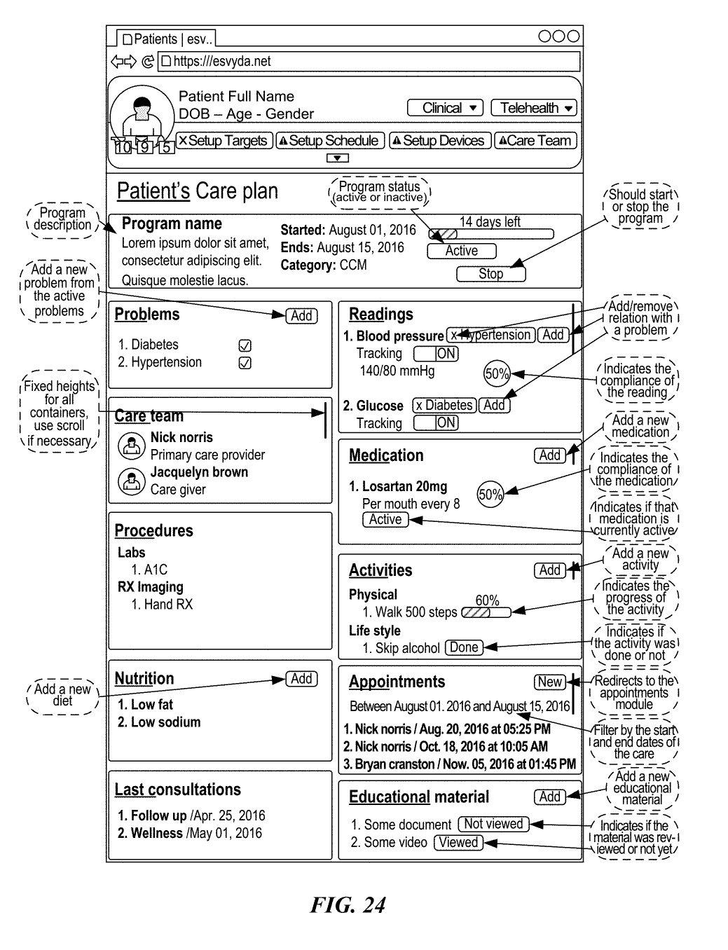

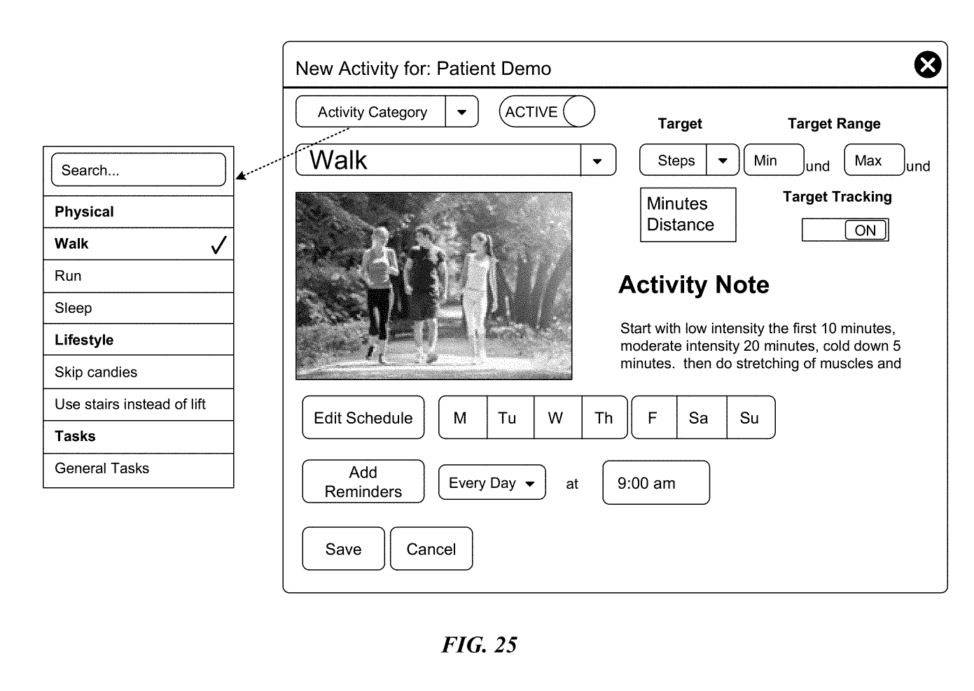

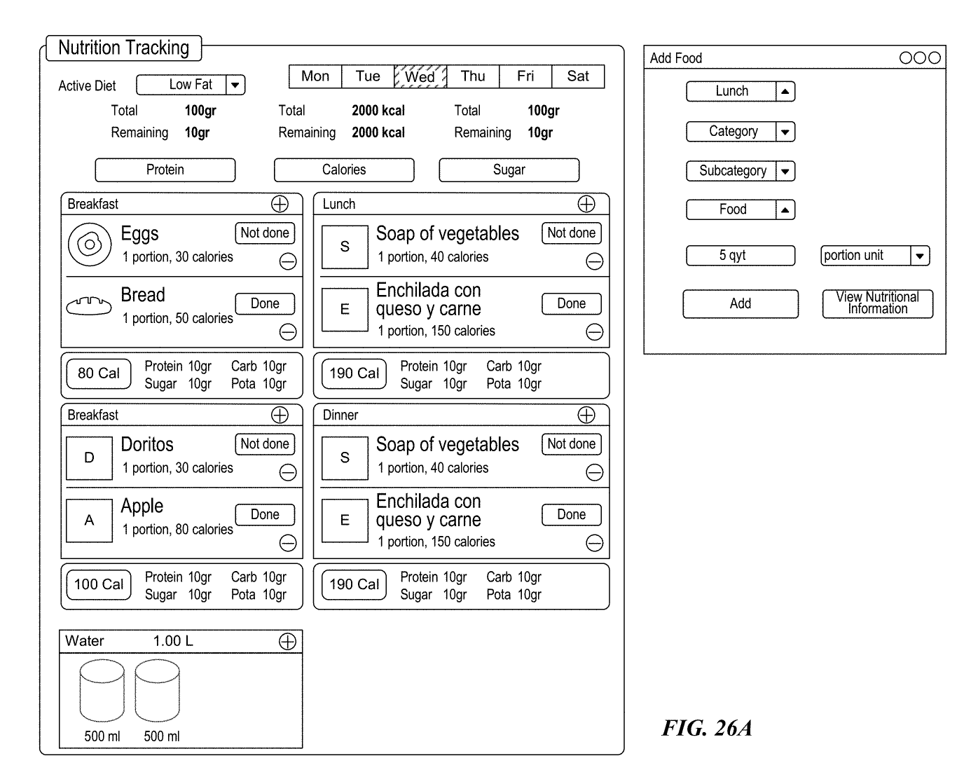

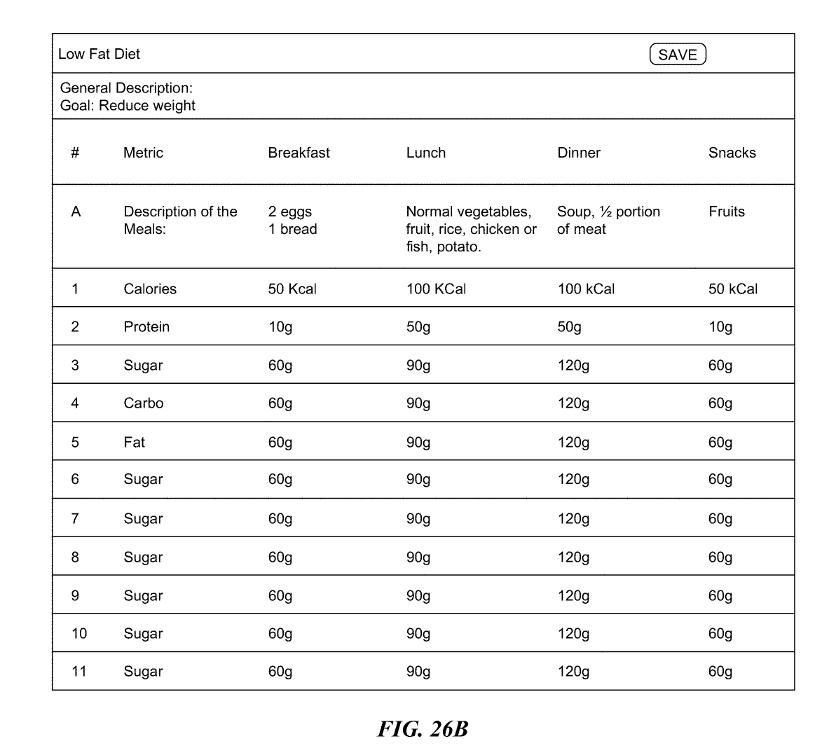

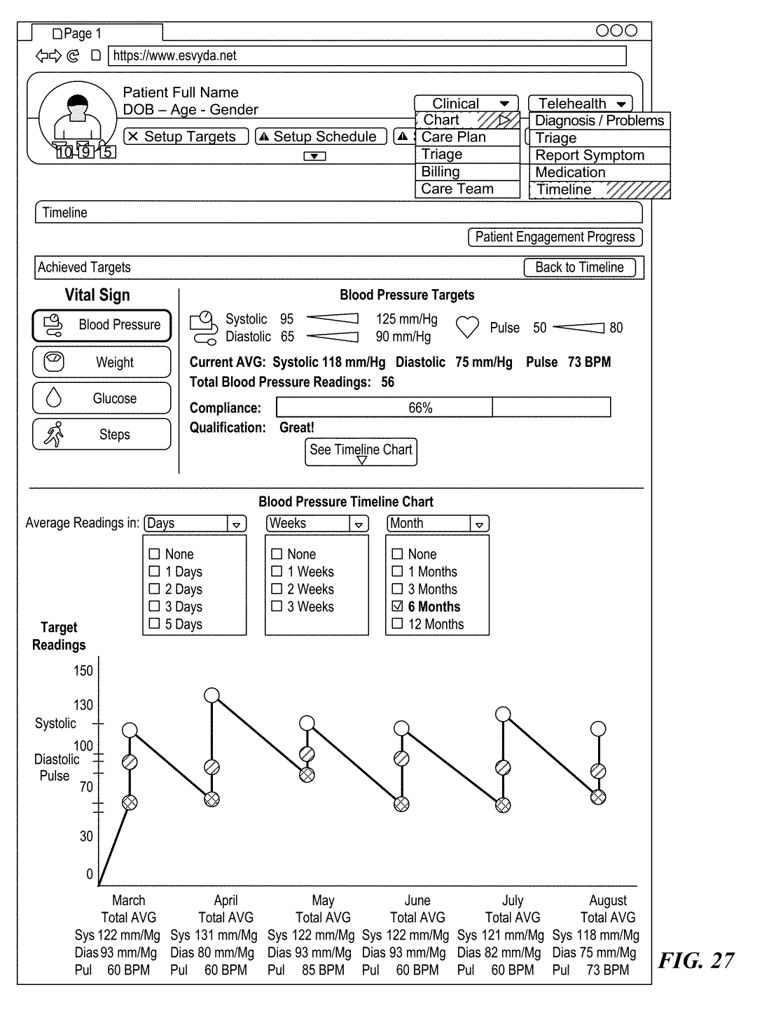

At block 905, the medical provider creates a SOAP (subjective, objective, assessment, and plan) form (905), such as by inputting the SOAP form by use of a computing device that is in communication with the telemonitoring system. FIG. 24 illustrates an example patient care plan user interface, which can be used to input a care plan or components of a care plan, such as a SOAP component. The SOAP form or data is saved in a data base at the telemonitoring system. The telemonitoring system gathers the patient's information (906), such as by the medical provider inputting the data at the telemonitoring system via the computing device, by the telemonitoring system automatically obtaining the data, etc., in order to determine any conditions and symptoms related to the chronic disease (921). The medical provider generates some targets (907) for the patient to attempt to achieve through the treatment of the care plan. The user interface of FIG. 24 can be used to input targets, such as a physical activity target. FIG. 25, which illustrates an example patient activity user interface, can also be used to input targets, such as a physical activity target. FIGS. 26A-B, which illustrate an example nutrition tracking user interface, which can be used to input nutrition targets. FIG. 27 illustrates an example patient biometric data user interface, which can be used to input targets, such as a biometric target. The targets can include qualitative or quantitative outcomes for a chronic condition (922), such as a patient's blood sugar level, blood pressure level, weight, energy level, endurance level, etc. (923), which can be used to establish final or partial outcomes (924).

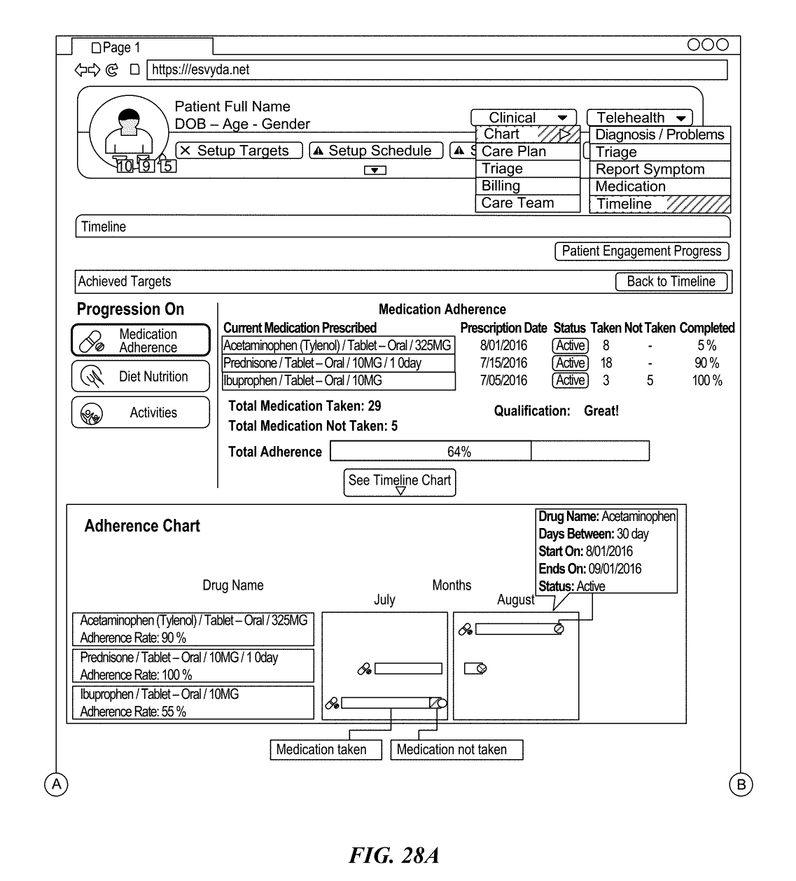

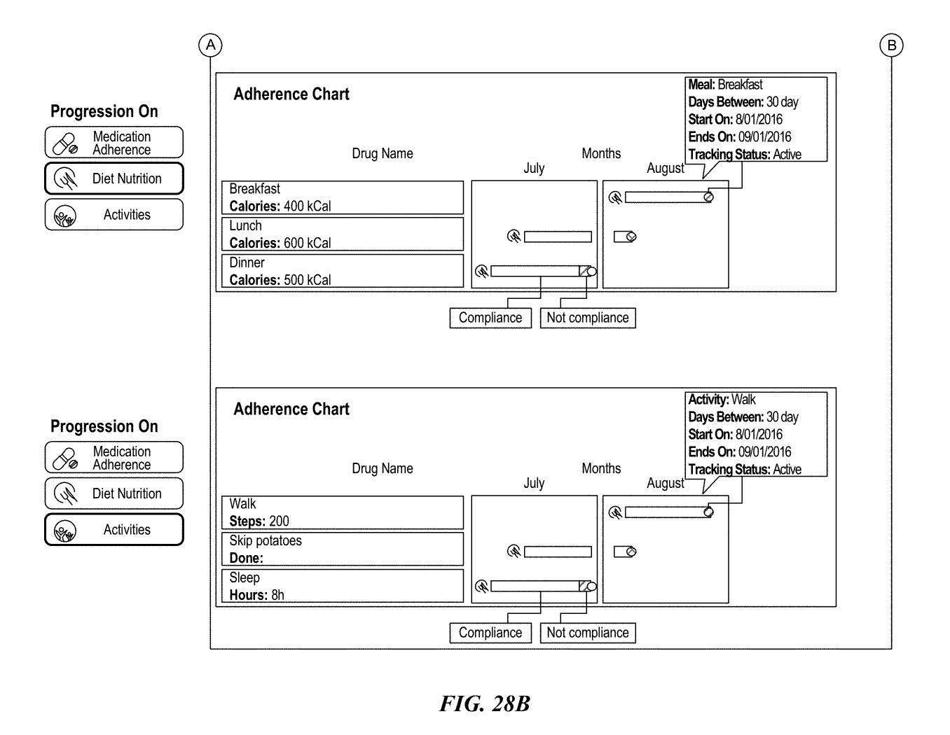

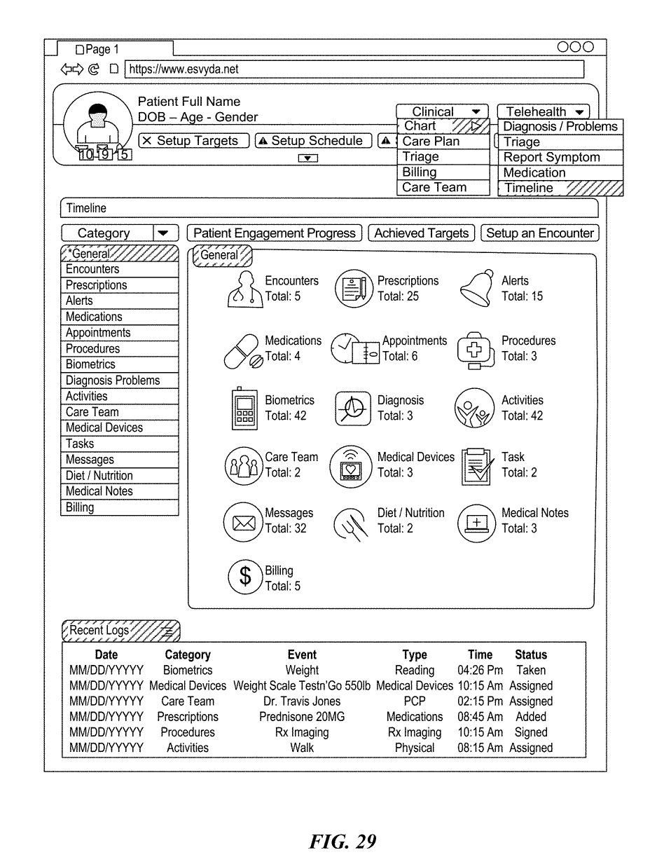

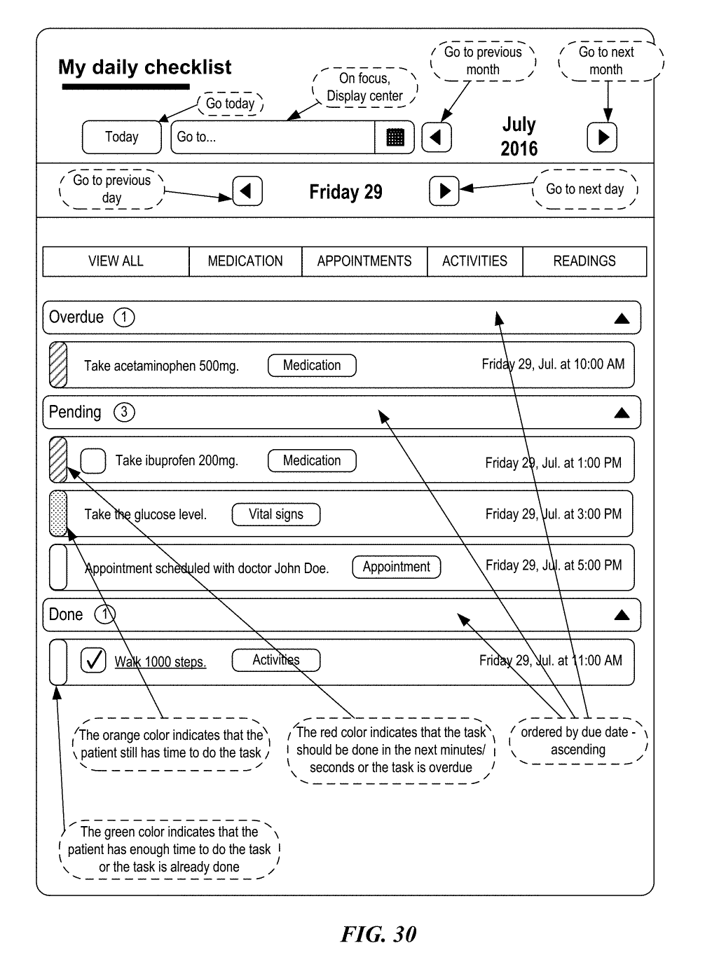

At block 908, the medical provider creates or updates the patient care plan, which is central to the telemonitoring system. The care plan can include, for example, a nutrition plan, an exercise plan, a medication plan, a biometric reading plan, etc. FIGS. 24-28 provide examples of user interfaces that can be used to input various components of the care plan, such as the nutrition plan, the exercise plan, the medication plan, the biometric reading plan, etc. FIG. 30 provides an example of a user interface that can be used to provide a daily checklist of tasks for the patient. A nutrition plan (see, e.g., FIGS. 26A-B) can include, for example, a nutrition education program, guidelines for healthy eating, recommended caloric intake levels, recommended consumption levels of various nutrients or food items, etc. A physical activity plan (see, e.g., FIG. 25) can include, for example, an exercise education program, physical therapy, physical activity guidelines, such as types of physical activity, frequency of physical activity, intensity of physical activity, etc. A medication plan (see, e.g., FIGS. 24, 28A) can include, for example, a set of medication prescriptions. A biometric reading plan (see, e.g., FIG. 27) can include, for example, guidelines on taking biometric readings, such as how often and when to take blood sugar measurements, how often and when to take blood pressure measurements, how often to obtain lab tests, etc. Progress towards the care plan and its associated goals or targets can be tracked via interfaces such as the examples of FIGS. 28A-B and 29.

The treatment plan is used to generate treatment orders (909), which can consist of physical activities, nutrition, life style, actions, task information, etc. that will assist in the management of the patient's health condition. In addition to orders or recommendations to follow, the telemonitoring system includes a module for tracking or managing medications, where prescribed medications are stored in a data base at the telemonitoring system that a patient or medical staff can check for currently prescribed medicines. Consequently, information that the telemonitoring system can generate, based on the care plan or orders, includes Dx images, patient education, and support (911). Such information can help physicians understand the patient's behaviors and how those behaviors affect his chronic disease.

After the care plan and orders are input, confirmed, and saved at the data base, the telemonitoring system or a medical provider can determine if a referral is needed (912), and can refer the patient to a specialist (926). The telemonitoring system can generate a referral form that can be sent directly to the specialist if needed. Upon completion of all the actions of the patient's appointment are completed, the telemonitoring system creates progress notes (913) which include data associated with the chronic condition of the patient, and which include feedback from the specialist referral (925). The telemonitoring system, such as via interaction with the medical provider, determines whether to update the patient's progress notes (914). If the notes are to be updated, the telemonitoring system can proceed with the update. After the care plan is created, the telemonitoring system notifies the patient of upcoming or completed events/tasks/etc., such as when the patient is due to take a medication, to take a biometric reading, to do a physical activity, etc. The notification can be via any of various mechanisms, such as via a text message to a mobile device of the patient, via an email to the patient, etc. The notification can also be via a checklist or any other appropriate mechanism. For example, FIG. 30 provides an example of a user interface that can be used to provide a daily checklist of events/tasks/etc. for the patient.

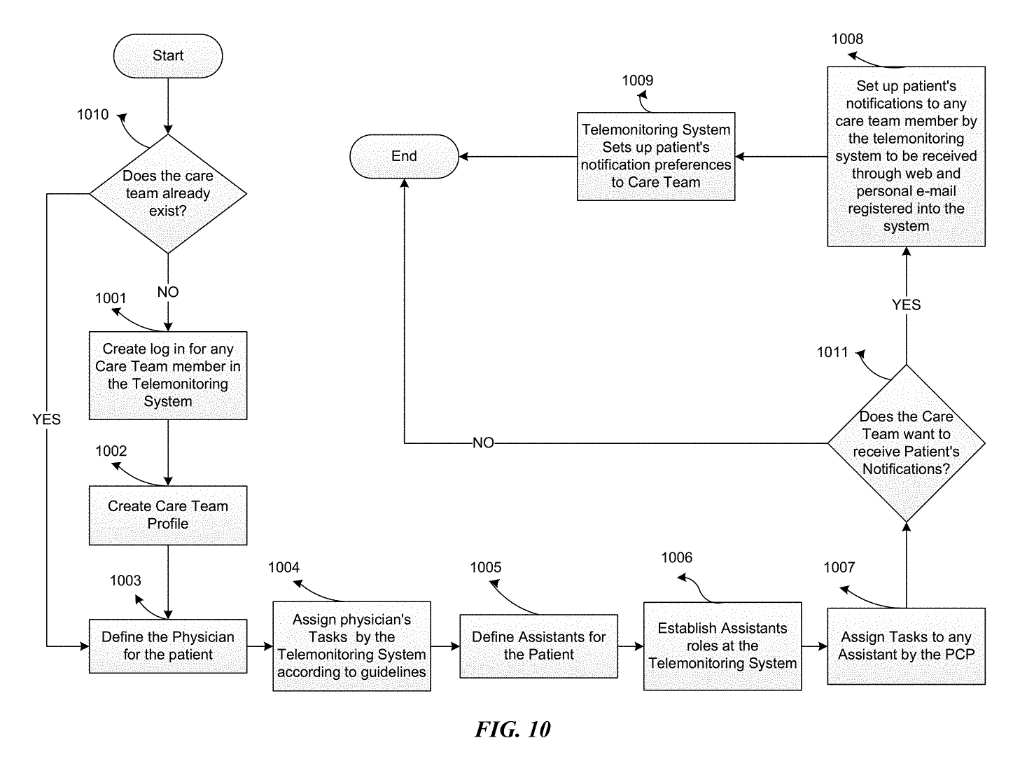

FIG. 10 is a flow diagram that illustrates a process to associate a medical staff member with a patient's care plan, consistent with various embodiments. In the example of FIG. 10, at block 1010, the telemonitoring system verifies whether a care team/provider already exists (e.g., has already enrolled at the telemonitoring system). At block 1001, when the care team does not exist, the telemonitoring system obtains information regarding care team members through a secure process, and creates profiles and logins for the various team members. The secure process can include, for example, a medical staff member inputting care team member information via a computing device that communicates with the telemonitoring system, by access a database, such as at a third party, that includes care team member information, etc. At block 1002, the telemonitoring system creates a profile for the care team. At block 1003, the telemonitoring system identifies a PCP (Primary Care Provider) for the patient, such as by a medical staff member identifying the PCP via a computing device that communicates with the telemonitoring system. At block 1004, the telemonitoring system accesses a database to obtain guidelines for patient care, and, based on the guidelines, creates and assigns tasks related to patient care.

Patient care often involves more than just a medical staff member or any single person, so the telemonitoring system supports the concept of a care team, which enables patient care to be spread amongst a set of people. At block 1005, the telemonitoring system allows identification of other people who may assist with patient care, such as a physician's assistant, a physical therapist, a nurse, a care giver, a relative or friend of the patent, etc. A medical staff member, such as a physician or a nurse, or some other person, such as the patient, inputs identification of assistants by use of a computing device that communicates with the telemonitoring system, and also inputs the person's role (1006). At block 1007, a medical staff member or the telemonitoring system assigns tasks to any member of the care team, such as by inputting the tasks via the computing device.

At block 1011, the telemonitoring system determines whether the care team wants to receive patient notifications. When notifications are the be sent, at block 1008, in some cases, a medical staff member sets up a same notification scheme for all members of the care team. In others, the medical staff member sets up custom notifications for each member of the care team. In yet others, each member of the care team sets up his or her own custom notifications. In some cases, the notification scheme(s) is automatically created by the telemonitoring system. At block 1009, the telemonitoring system sets up the patient's notification preferences, either automatically or based on input from the patient provided by a computing device of the patient.

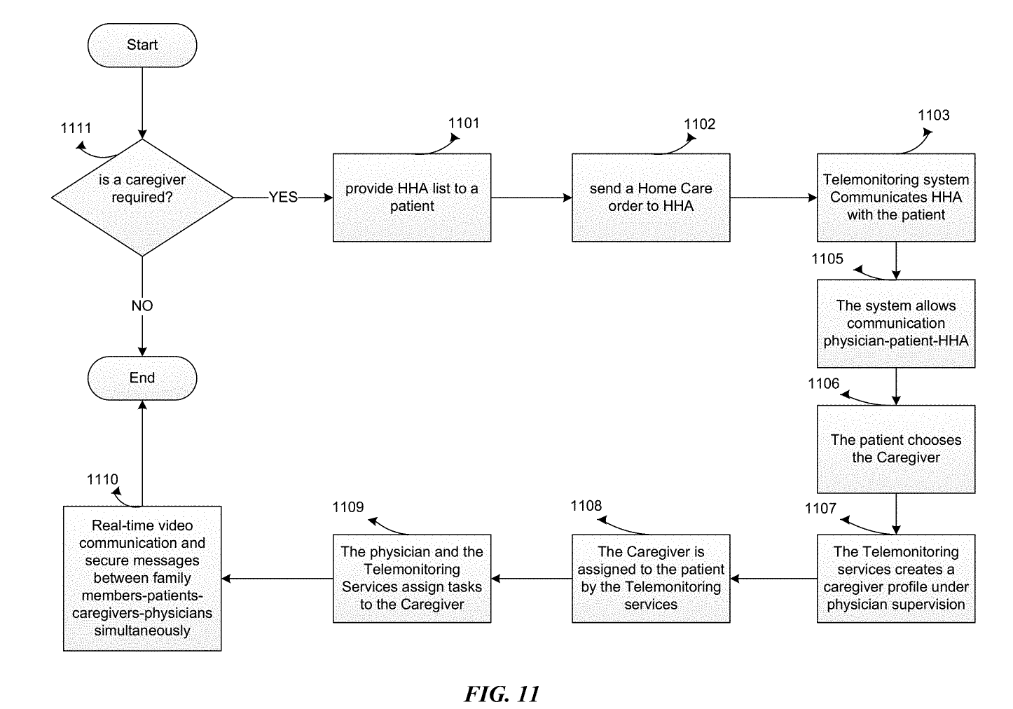

FIG. 11 is a flow diagram that illustrates a process to associate a care giver with a patient's care plan, consistent with various embodiments. At block 1111, a decision is made whether the patient needs a caregiver to provide home care. When a caregiver is needed, at block 1101, a medical staff member provides, or the telemonitoring system causes to be displayed, a list of Home Health Agencies (HHA) available in the patient's area and according to the patient's needs. Once the patient has chosen an HHA, a medical staff member inputs and sends an order for a caregiver. At block 1102, the telemonitoring system, based on an order by an appropriately licensed or otherwise qualified medical professional, sends a home care order to the HHA, and also sends a notification to the patient (1103). At block 1105, the Telemonitoring system enables communication, via telemonitoring system resources, between the care team, the patient, and the HHA, such as to schedule a home care appointment. HHA can access the patient's health information via the telemonitoring system, and can use the information to assess the patient. The telemonitoring system enables the medical staff, patient, and HHA to exchange relevant information about medical care plans, past treatments, drug history and other health relevant issues.

At block 1106, the patient chooses a caregiver, such as by inputting his choice at his computing device, which communicates the choice to the telemonitoring system, or by communicating with a medical staff member or other person, who inputs the choice via a computing device that communicates the choice with the telemonitoring system. To facilitate the choice, the telemonitoring system provides to the patient a caregiver list, which the telemonitoring system received from the HHA, and the patient has the availability to filter the list according to the patient's preferences. At block 1107, the telemonitoring system creates a profile for the caregiver (e.g., e-mail, password and security questions to access to the telemonitoring system, etc.), such as based on information input by a medical staff member working for the PCP. At block 1108, the telemonitoring system assigns the care giver to the patient, based on the patient choice of block 1106.

At block 1109, the telemonitoring system assigns tasks to the caregiver, such as based on guidelines accessible to the telemonitoring system, or based on input from a medical staff member, etc. The tasks can include, e.g., assisting the patient with meal preparation and tracking food consumed by the patent, taking daily biometric readings, tracking prescription drugs, checking safety of the patient at home, teaching the patient on how follow recommendations and guidelines assigned by the physician, etc. An advantage of the telemonitoring system is that it allows physicians or other medical staff members or other care givers to track a patient's care at home (e.g., biometric readings, diet, daily habits, prescription drugs) through real-time communication between patient's caregiver and patient. At block 1110, the telemonitoring system provides electronic communication means between the parties, such as real-time video or audio, electronic messaging, etc.

FIGS. 12A-D are a flow diagram that illustrates a process to establish parameters or targets for processing the biometric data according to some embodiments of the present integration, consistent with various embodiments. Managing care for chronic conditions, such as those associated with metabolic syndrome, and care pain management often includes regular taking of biometric data. At block 1201, a telemonitoring system accesses a patient's data in a database and verifies the patient's data, such as by a medical staff person checking the patient's ID, by checking his address or phone number, by checking his insurance coverage, etc. At block 1202, the telemonitoring system determines whether the patient is registered or active at the telemonitoring system. When a patient is not enrolled, the telemonitoring system goes through a process to enroll the patent, such as the process of FIGS. 6A-B. At block 1203, the telemonitoring system establishes or updates biometric parameters or targets, such as based on a medical care plan, or based on recent changes in the medical condition of the patient.

At block 1204, the telemonitoring system determines whether default settings are assigned to enable automatically setting biometric targets. When the default settings are assigned, at block 1222, the telemonitoring system executes an algorithm that assigns default values for the patient's biometric settings, such as an algorithm that takes into account the patient's diagnosis, medical care plan, guidelines for the diagnosis, etc. When the default settings of block 1204 are not assigned, the telemonitoring system at block 1205 accepts manual input of patient target values for biometric readings, such as input of a medical staff member via a computing device that communicates with the telemonitoring system.

When the biometric values are input manually, the telemonitoring system divides settings for the biometric readings into four categories, target/alert tolerances, biometric reading schedule, daily biometric reading times, and biometric devices. The first category is biometric tolerances, in which a physician or other qualified medical staff assigns or reviews biometric tolerance values according to the patient's condition, where the tolerances can be set in automatically or manually, as can notifications based on those tolerances. The second category is the biometric reading schedule (1209) where a physician or other qualified medical staff can assign the times in which biometric readings of a patient are to be taken, such as blood pressure, weight, glucose, temperature, oxygen level readings or any condition that can be monitored with a wireless medical device. The third category called daily times (1212) in which a physician or other qualified medical staff can save and configure the patient's daily time data (1214). The last category is called medical devices (1215) in which a physician or other qualified medical staff can assign one or more medical devices for the patient's treatment.

At block 1206, the telemonitoring system establishes a frequency at which biometric readings will be taken. At block 1207, the telemonitoring system determines whether a medical staff member wants to assign default values for biometric reading tolerances. When the medical staff member wants to assign the default values for the tolerances, at block 1226, the medical staff member inputs the tolerances for each biometric reading. When the medical staff member does not want to assign the default values for the tolerances, at block 1227, the telemonitoring system sets the default biometric values. At block 1208, the medical staff member determines if he wants to assign default values for alert settings. When he does, at block 1230 he inputs the default values for alert settings. When he does not, at block 1228, the telemonitoring system sets the alert settings. At block 1209, which can be the same as block 1206, the telemonitoring system establishes a reading schedule. At block 1210, the medical staff member determines if he wants to assign default time(s) for the various biometric readings. When he does, at block 1229, he sets the reading schedule manually. When he does not, at block 1231, the telemonitoring system sets the reading schedule automatically. At block 1211, the telemonitoring system sets the schedule for biometric readings.

At block 1212, the medical staff member or the telemonitoring system sets the daily times. At block 1213, the medical staff member determines if he wants to assign default daily times. When he does, at block 1232, he sets the default daily times. When he does not, at block 1233, the telemonitoring system sets the default daily times. At block 1214, daily times, such as times for meals, when the patient wakes up, when the patient goes to sleep, etc., are established. At block 1215, a medical staff member assigns one or more medical devices to the patient, such as a wireless blood pressure meter, a wireless glucose meter, a wireless thermometer, a wireless scale, etc. When a medical device to be assigned does not exist in the database of the telemonitoring system, an entry is created (1217) which can include the model of the device, the manufacturer, the custom name of the medical device, its serial number, etc. At block 1218, the medical device has been added to the database. The medical device is configured (1219), assigned to the patient (1220), and the assignment is completed (1224). In some embodiments, the medical device is synchronized via the Internet of things (IoT).

FIGS. 13A-B are a flow diagram that illustrate a communication and data synchronization process between a wireless medical device and a mobile device, consistent with various embodiments. At block 1300, a Mobile application, such as a medical care plan application, starts at a mobile device. At block 1301, the mobile application accesses a database of medical devices assigned to a patient. At block 1302, the mobile device or the mobile application launches wireless protocol services, such as Bluetooth. By leaving the mobile application in a listening mode, the mobile application can automatically detect a wireless medical device (1303) and can connect to the medical device (1304). When a new medical device connection is established, other wireless protocols or services are disconnected (1305) to avoid any interruption in the communication process. The mobile application identifies whether it is a master or slave in the current communication mode.

The mobile application determines whether it is waiting for data from a medical device (1306). When it is (1307), the mobile application periodically checks whether any data has been received (1308), and determines if the data is valid. When valid data is received (1309), the mobile application checks if the medical device was previously assigned (1310). If the mobile application cannot find the medical device in a data base of medical devices that are assigned, the mobile application resumes at block 1302. When the mobile application matches the medical device with a previously assigned medical device from the database, before storing any data, the mobile application verifies that the data is not a duplicate of data already in the database (1311, 1324). When data already exists, the duplicate data is ignored. The mobile device verifies whether the medical device is still connected (1313), and, if it is, the process resumes at block 1307. Otherwise, the process is ended. When the data is not duplicate data (1324), the data is stored in the database (1312), and the process continues at block 1313. If communication is in Master Mode, the master synchronization process mode ends.

When it is not waiting for data, the mobile sends commands to the medical device (1314), such as to determine if the medical device has particular needed data (1315). When the mobile device has the needed data (1322), the mobile application requests this data (1316) and verifies that the medical device is assigned (1317). When the medical device matches with an assigned medical device in the database (1320), the mobile application validates that the data is not duplicate (1318, 1321), and, when non-duplicate data is verified, the mobile application saves the data in the database (1319). The database can be local to the mobile device, or can be remote, such as at a telemonitoring system or at cloud storage.

FIG. 14 is a flow diagram that illustrates a process for transmitting biometric data from a mobile device to a telemonitoring system, consistent with various embodiments. In an example where a mobile application stores biometric data received from a medical device in a database local to a mobile device at which the mobile application is executing, the mobile application can send the biometric data to a telemonitoring system. At block 1401, the mobile application identifies data that needs to be sent to the telemonitoring system. When data is identified for sending (1411), the mobile application prepares the data for transmission (1402). When encryption is required (1412), the data is encrypted (1403) the transmission process continues (1404). When encryption of the data is not necessary, the mobile application continues with the transmission process (1404) without encrypting the data. The mobile device determines whether the transmission was successful (1405), and, when it was successful, identifies the data as successfully synchronized with the telemonitoring system (1408). When the transmission is not successful (1405), the mobile application determines the cause of the unsuccessful transmission (1406), and, when the cause if an authentication error, the mobile device goes through an authentication process, such as by logging into the telemonitoring system (1407). When the login is successful, the transmission process is restarted (1401). This process allows for early detection and authentication of correct data, thus reducing the computational energy in the telemonitoring system by using synchronization and data validation algorithms and technologies.

FIG. 15 is a flow diagram illustrating a process for transmitting biometric data from a telemonitoring system to a mobile device, consistent with various embodiments. In an example, to receive data from a telemonitoring system, a mobile application running at a mobile device must be validly recognized, such as via a valid login. At block 1501, the mobile application requests data from the telemonitoring system. When the request is verified to be valid (1505), the telemonitoring system sends the requested data to the mobile application (1502) to enable the data to be synchronized between the two devices. When there is a problem verifying the request (1505), the mobile device determines whether the problem is due to an authentication error (1503). If so, the mobile application attempts to initialize a login session (1504), such as via block 1407 of FIG. 14. If the problem is not due to an authorization problem, the mobile application determines if the requested data is needed by the mobile application (1506). If not, the session ends. If the data is needed, the process continues at block 1504.

FIGS. 16A-B are a flow diagram illustrating a process for sending biometric data to a telemonitoring system via an Applications Programming Interface (“API”), consistent with various embodiments. In an example, a mobile application sends biometric data received from a medical device to a telemonitoring system by use of an API. At block 1601, a mobile application establishes a secure connection with a telemonitoring system (1601) and initiates a valid session, such as by establishing a login session (1602, 1603). When a valid session is established, the telemonitoring system verifies the permissions of the user sending the data (1604). When the user does not have the required permission, the telemonitoring system ends the communication (1605). When the user has adequate permission, the communication is established and data is exchanged. When the data is encrypted (1625), the telemonitoring system decrypts the data (1606). At block 1607, the unencrypted data is deserialized and validated, such as for being valid biometric data (1608). When the user is a valid user (1611), the data is checked to verify it is not duplicate of data already in a database (1609). When the data is a duplicate, the data is identified as stored (1610), and the process continues at block 1613. When the data is not a duplicate (1609), the raw data is queued for storage (1612).

At block 1613, when data is queued to be stored, a background task is initiated to store the data (1613). This approach optimizes computational resources, since the mobile application does not need to wait for the actual store to occur. Once the task is scheduled (1613), the telemonitoring system sends a message to the mobile application indicating that the data was successfully saved (1614), and the connection is closed (1615). The mobile application continues in the background. As previously mentioned, the storing or other processing of data is added as a task in a queue (1613), and the actual work of storing or doing other processing of the data is done as a background task (1625), which frees up resources of both the mobile device and the telemonitoring system. When the background task starts, the data is verified to not be a duplicate (1616). When it is a duplicate, the task stops and the results are saved (1622). Then the data is not a duplicate, the telemonitoring system processes the data (1617), such as to determine if any alerts or notifications need to be sent, or to determine if any future events needs to be scheduled. At block 1618, the telemonitoring system saves the data (1618), and any alerts/notifications/future events are added to a queue for future processing (1619). Upon successful processing of the data and any associated events (1617, 1619), the telemonitoring system sends a notification to the patient or the care team (1620). If an error is detected, the telemonitoring system or the mobile application raise an exception error and ends the process with an error, and stores the result of the task in a log file (1622).

FIGS. 17A-B are a flow diagram illustrating a process for detecting an unauthorized attempt to access a telemonitoring system, consistent with various embodiments. In an example, a telemonitoring system, accessible via a secure API, provides confidential information about patients, their vital signs, readings, tasks related to the patients' health, etc. The telemonitoring system implements a security system for auto detecting an unauthorized attempt to access data, such as an attack (1701, 1717), and blocks the connection when an unauthorized access attempt is detected (1702). When an authorized access request is detected (1717), the telemonitoring system will establish a secure communication (1703), such as with a mobile medical care plan application, or an authorized web browsing session, and will verify the credentials (1704, 1705) of the user. All connections incoming from an ‘Anonymous’ user will be stopped (1706). In addition to having valid credentials (1705), the user must also have permission to access the requested resource (1707), otherwise, the communication will be interrupted (1708).

When the user is fully authorized (1707), the telemonitoring system proceeds to provide the information requested (1709) and to prepare data for transmission (1710). When the data requested is considered sensitive (1711), the telemonitoring system encrypts the data prior to sending (1712). The telemonitoring system determines if the data was successfully prepared for transmission (1713), and, if it was, it sends the requested data (1715) and closes the secure connection (1716). If the data was not successfully prepared for sending (1713), the telemonitoring system reports an error (1714).

FIGS. 18A-B are a flow diagram illustrating a process for generating a medical alert based on biometric data, consistent with various embodiments. After data is processed, such as per the process of FIG. 16, the telemonitoring system has a queuing system (1801) that supports scheduling and processing of tasks related to the data, such as sending an alert in response to analysis of biometric data, sending a notification to notify a patient regarding an upcoming doctor's appointment, etc. A queue capability (1801) is used to perform concurrent execution of tasks, and includes tasks related to processing incoming data to determine when any alerts or notifications are required. Ay block 1802, the telemonitoring system determines whether targets have been input regarding the patient, such as targets for biometric readings. When evaluating whether an alert is to be sent, the telemonitoring system determines, for example: minimum and maximum values for biometric readings, whether alerts are enabled or disabled, tolerances for readings, times of readings, dates of readings, customizations for different scenarios depending on the patient and chronic condition, etc.

When the patient does not have targets (1802), the telemonitoring system determines whether a qualified medical staff person, such as an appropriately licensed medical professional, appropriately trained medical staff person, etc., wants to input targets (1803), and take actions previously discussed to input those targets. When the qualified medical staff person does not input targets, the telemonitoring system determines if default targets exist for the patient, the patient's condition (e.g., disease, age, ethnicity, etc.), etc. (1804). When no targets exist, the telemonitoring system sends a warning notification to the patient or the medical staff (1821). When target values are established for a patient (1802, 1803, 1804), the telemonitoring system evaluates the data in light of the target values (1820), and in light of the alert settings (1805).

When the alert settings are active (1805), such that alerts are sent, and the biometric readings are outside of the target range (1806), the biometric readings are evaluated in light of the tolerances (1807). For example, an alert may be sent when a glucose reading exceeds a target range by more than 10% for 3 days, by more than 20% for 2 days, by 50% for one day, etc. When the tolerances have been fulfilled (1808), the telemonitoring system creates a new alert (1809), and logs the alert (1810). The telemonitoring system further performs some or all of blocks 1811 (send a secure email to the patient and the care team regarding the alert), 1812 (send a secure SMS to the patient and care team), 1816 (establishes an audio or video conference between the patient and care team), 1817 (generates allowable social media interaction using secure messages), and 1813 (sends a real-time notification to the patient and the care team). The user has the flexibility to enable or disable any of the notifications methods and only use preferred ones. The telemonitoring system determines whether there was any error while notifying the patient or care team (1814), and, when there is an error, raises an exception error (1814), and, in either case, saves the result (1815). The user has the flexibility to enable or disable any of the notifications methods and only use preferred ones.

FIG. 19 is a flow diagram illustrating a process for generating a medical alert when biometric readings are not taken in compliance with a care plan, consistent with various embodiments. In an example, at block 1901, a telemonitoring system obtains a patient list, and locates a particular patient in the list (1902). The telemonitoring system verifies whether the patient has scheduled readings (1903), and, when he does, the telemonitoring system obtains the patient's readings (1904). When readings have not been provided (1905), the telemonitoring system generates an alert (1906), saves the alert (1907), logs the alert (1908), and sends the alert (1909) to notify the patient or the care team that readings for the patient have not been obtained in compliance with the patient's care plan.

When the patient does take his readings (1905), the telemonitoring system verifies if the readings are in compliance with the requirements of the readings (1911). Examples of some requirements include that the readings were taken within a required time frame (e.g., between 8 am and 8 pm on Tuesday), that three readings were taken in a 24 hour period, that the readings were taking by a certain type of medical device, etc. When the readings do not meet the requirements, such as the reading was not taken within the required time frame, the telemonitoring system generates an alert (1906) notifying the patient or his care givers that the readings have in compliance with the patient's care plan have not been taken. The telemonitoring system saves the alert (1907), logs the alert (1908), and sends the alert 1909). An advantage of this process is to increase patient engagement with his treatment and to facilitate his compliance with the care plan to help the patient achieve the care plan goals in a timely manner.

FIGS. 20A-E are a flow diagram illustrating a process for updating a care plan based on telemonitoring data, consistent with various embodiments. In an example, once biometric data and other data is collected, the telemonitoring system generates a report of for the patient. Through processes previously discussed in this specification, the telemonitoring system has access to medical records of a patient, such as the patient's biometric readings, his care plan, etc. The telemonitoring system further has access to analysis results from various medical professionals, such as a health assessment by a physician or another member of the medical staff. The data collected enables any authorized member of the medical staff to monitor, control and check the patient's health progress as relates to, e.g., his chronic condition or chronic pain management. The data further enables a member of the medical staff to generate a bill claim automatically.

In an example, at block 2001, the telemonitoring system checks the patient's eligibility 2001. When the patient is eligible, the telemonitoring system checks to see if a medical care plan has been assigned to the patient (2002). When a care plan has not been assigned, the telemonitoring system notifies the care team to create a care plan for the patient (2050). When a care plan is assigned (2002), the telemonitoring system proceeds to verify whether there are progress notes/data in the database (2003). When the database includes progress notes/data, the telemonitoring system verifies the notes of the patient (2004) (diagnosis, symptoms, conditions, clinical data and demographics) to provide health care providers, care team members, etc. with information regarding the present condition of the patient. The telemonitoring system allows the review of the patient's triage and call records (2005), mood reports (2006), and the patient's daily tasks (2007), such as daily biometric readings, daily nutrition log, daily exercise log, etc. This information will help physicians, health care providers, or care team members to generate an outcome report for clinical review.

At block 2008, the telemonitoring system verifies the active problems list of the patient (e.g., the patient's chronic conditions) and their associated classifications within the database (2009). The telemonitoring system checks biometrics records and their associated reading schedules during a specific period of time (2010). The telemonitoring system verifies whether the patient has biometric targets assigned (2011) that correspond to the patient's chronic condition(s). When the patient does, the telemonitoring system checks issues notifications and alerts (2012). When the patient's care plan includes goals for any health indicators (2013), the telemonitoring system reviews progress on the various health indicators, such as actual versus target reading goals, actual nutrition versus nutrition goals, actual exercise versus exercise goals, actual medications versus medication goals, etc. The telemonitoring system generates a health status report (2014), such as a report on the outcome of the care plan, and saves the report. The telemonitoring system, such as under the supervision of, or based on input of, a doctor or other appropriately licensed or qualified medical professional, updates the patient's care plan (2015), such as by updating the patient's target indicators (e.g., target biometric readings), the patent's biometric reading schedule, or the patient's exercise, nutrition, or medication plans, to improve the health care of the patient.

At block 2016, the telemonitoring system checks the patient's medical orders to determine whether the medical orders properly address the patient's current active health issues (2017). When the patient does not have medical orders, or they do not address the patient's issues, the telemonitoring system generates a status report for the patient that so indicates (2029). When the patient has medical orders that address the patient's current active health issues, the telemonitoring system determines if they properly address the issues (2018). The telemonitoring system determines whether any changes in the nutrition, medication, exercise, biometric reading, etc. medical orders are needed. At block 2019, the telemonitoring system checks if there are any needed changes in the nutrition medical orders (2019). When there are, the telemonitoring system generates a nutrition report, such as a report that includes the calories and nutrients consumed each day, the calories burned each day, etc. The telemonitoring system updates the nutrition-related medical orders in the care plan (2022).

At block 2023, the telemonitoring system verifies the prescribed medicines of the patient (2023) while under the supervision of or based on input from a physician or other appropriately licensed or qualified medical care practitioner. The telemonitoring system checks the list of the current medicines for the patient and determines whether the patient is in compliance with the medication plan (2024). If not, during medication reconciliation/notes (2025), the telemonitoring system reconciles medication data/notes in the database with the medical orders. The telemonitoring system updates the medical plans/orders as needed (2026, 2027), and verifies the plan, such as by checking for drug interactions, patient allergies, proper doses, etc. When the patient is taking current medications as prescribed (2024), the telemonitoring system determines whether the patient has any adverse drug effects (2028), and, when he does, the process proceeds to block 2025. When the patient has no adverse drug effects, the telemonitoring system generates a status report for the patient that reports the patient's progress towards the medical care plan (2029).

At block 2030, the telemonitoring system established a patient's education goals, such as how to properly obtain daily, weekly and monthly readings, how to properly perform various health-related tasks or activities from the patient's care plan, etc. At block 2031, the telemonitoring system generates and checks referrals, such as a referral to a particular type doctor (e.g., endocrinologist), to a medical lab for testing, to a nutritionist, etc. The checking can entail checking the patient's insurance, PHI, Labs, DX images, referral justification, diagnosis codes, etc. When the patient has referral reports (2032), the telemonitoring system can check the clinical specialist feedback from the referral report (2033), and can determine if the patient needs special attention (2034). When there are no referral reports (2032), or when the patient does not need special attention (2034), the telemonitoring system checks and updates the care plan goals (2035). When the patient needs special attention (2034), the telemonitoring systems allows physicians to share the information with the medical staff for peer review analysis (2051) in order to update the information in the patient's care plan (2090).

At block 2036, the telemonitoring system generates a clinical record summary, which includes summaries of the patient's various health-related data, to allow physicians determine the partial/final outcomes for the patient. The summary report can include, for example, current diagnosis ICD-10, assessment notes, medications, targets, current care plan, etc. Based on this summary, the telemonitoring system, under the supervision of or based on input of an appropriately licensed or other qualified medical professional, generates the CPT/HCPCS codes (2037) and updates the patient's progress notes (2038). If the CPT/HCPCS codes are already generated, the health care provider can plan the next follow-up appointment for the patient's treatment via the telemonitoring system (2039). At block 2040, the medical staff member (e.g., nurse, doctor) can establish an audio or video conference with the patient to discuss the Care Plan Review, where the medical staff member and the patient can exchange information regarding the care plan in real-time. The medical staff member can further generate allowable social media interaction using secure messages in order to communicate key changes in the Care Plan (2041).

FIGS. 21A-B are a flow diagram illustrating a billing process for a telemonitoring system, consistent with various embodiments. In an example, a telemonitoring system includes a billing component, where the various medical services can be analyzed, debugged, and insurance claims automatically generated for provided services. At block 2101, the telemonitoring system determines if telemonitoring services were provided during the current billing period. When services were provided, the telemonitoring system identifies all medical services provided during the billing period (2102), and extract all the procedures and services done in those attentions using the standard codes CPT and HCPCS with its corresponding modifiers (2103). The telemonitoring system analyzes that every CPT and HCPCS code has a properly matched corresponding diagnoses codes under the standard codes for diagnosis, e.g., ICD-9 or ICD-10 (2104), and validates that the association between the procedures and services codes with the diagnosis codes are valid according to the criteria of the CMS, the health insurance provider and the medical practice (2105).

If the telemonitoring system detects any conflict or warning with the requirements (2106), the telemonitoring system either automatically, or with input from a medical staff member, resolves any conflict with CPT or HCPCS codes (2107). Once the conflicts are resolved, the telemonitoring system determines fees that correspond to each CPT/HCPCS code (2108). In determining the proper fee, the telemonitoring system uses 1) the contract between the insurance provider and the medical practice, 2) the patient health plan, 3) and the medical treatment provided. With this fee information, the telemonitoring system prepares the insurance claim, which further includes the units and the service date (2109). In order to provide support for the insurance claim, and to increase the successful rate of reimbursement once the claim is sent to the insurance systems, the telemonitoring system generates a medical summary of the patient's chart (2110), and it stores information associated with the generated claim in a “document support system.”

The telemonitoring system also keeps track of payments made by the patient during the billing period, and keeps statistics of the accumulated deductible (2111). In addition, the telemonitoring system provides in the billing form information regarding the various medical services provided during the billing period (2112). Before the telemonitoring system submits the claim, it re-verifies the patient's eligibility status with the health insurance providers registered in the telemonitoring system (2113) to ensure that the patient has at least one insurance plan active (2114). When the patient has no active insurance (2114), the telemonitoring system is not able to bill an insurance provider, and rather generates a report regarding the patient's lack of insurance (2115), which is sent to the appropriate medical staff and to the patient. When the patient has one or more active insurance plans, the telemonitoring system chooses the insurance plan to bill for the medical services (2116). The telemonitoring system further checks whether the health care provider is inside the insurance network (2117) to determine whether additional authorizations are needed from the insurance provider (2119), and checks to see who the insured person is (2118).

Based on the collected information, the telemonitoring system generates the insurance claim based on the CMS and/or health insurance provider rules (2120) and activates a notification system (2121) to track and update the current status of the claim process for designated users. The process to send the claim could be done either manually (2122) or electronically (2123). When feedback is received from the health insurance provider is received, the telemonitoring system processes the health insurance provider feedback regarding the claim 2124). Some examples of insurance plan responses include claim accepted, claim rejected, or claim denied. When the claim is accepted by the insurance company (2192), the telemonitoring system obtains the payment details and the EOB (Explanation of Benefits) information (2129) and verifies the payment by doing a reconciliation electronically or manually with the bank balance (2130). When the claim is rejected by the insurance company (2191), the telemonitoring system will suggest corrections to the claim, or an appeal process (2128), and put the claim in a pending review status. When the claim is denied by the insurance company (2190), the telemonitoring system obtains the EOB (Explanation of Benefits) information (2125), but no payment information. The telemonitoring system changes the balance due to the patient (2126) to account for the lack of an insurance payment, and generates a payment request to send to the patient (2127). The platform closes the claim and updates the balance, to provide financial information to other systems (2131).

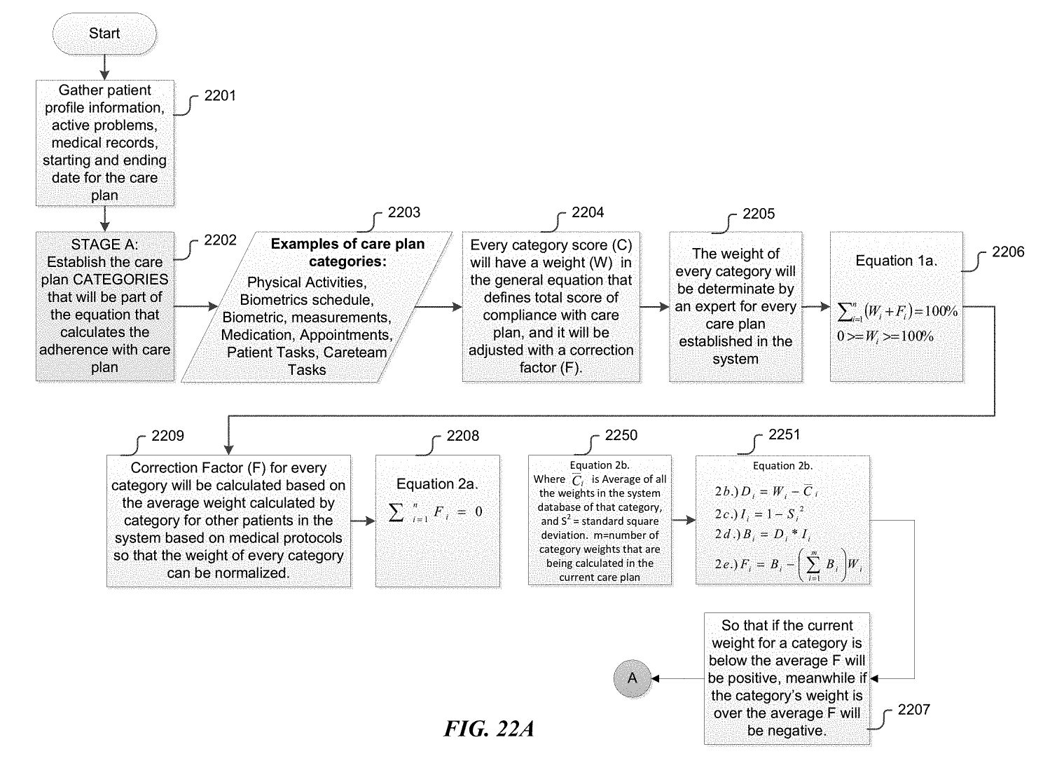

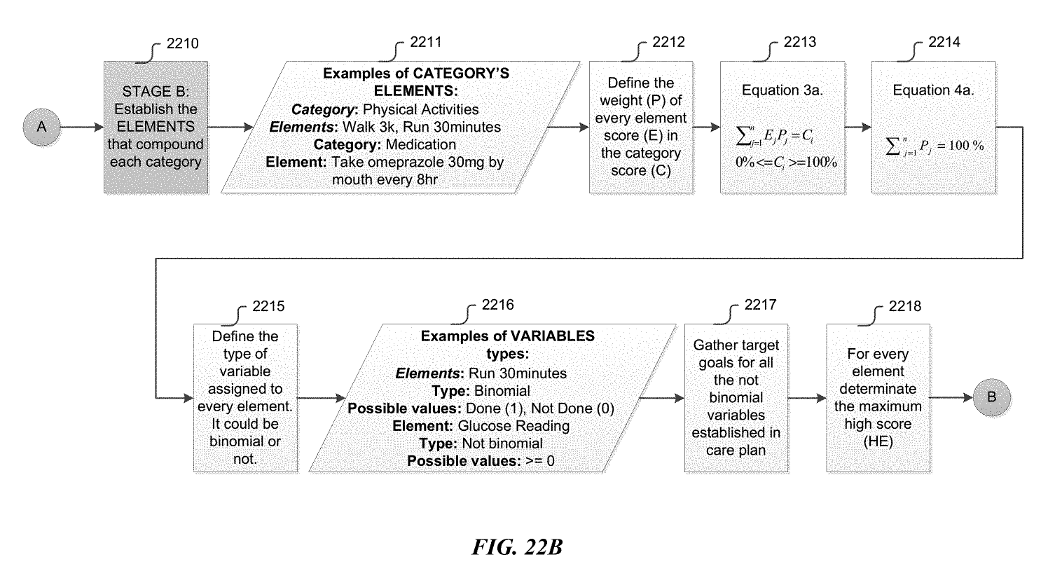

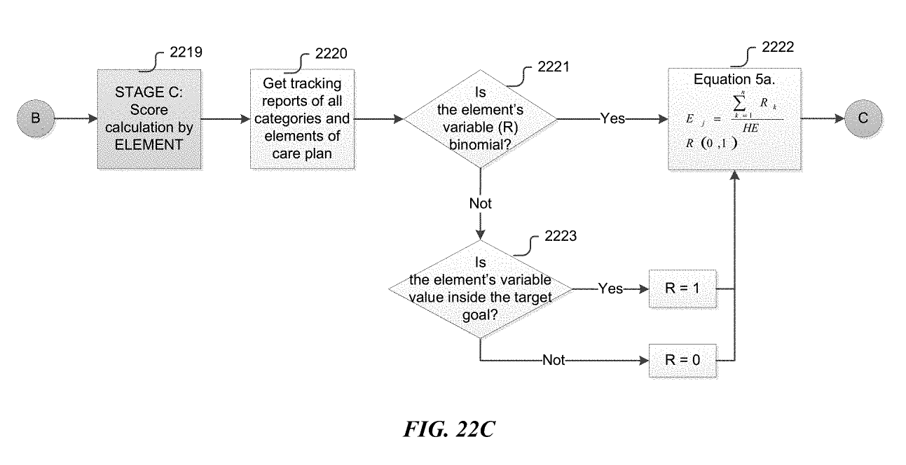

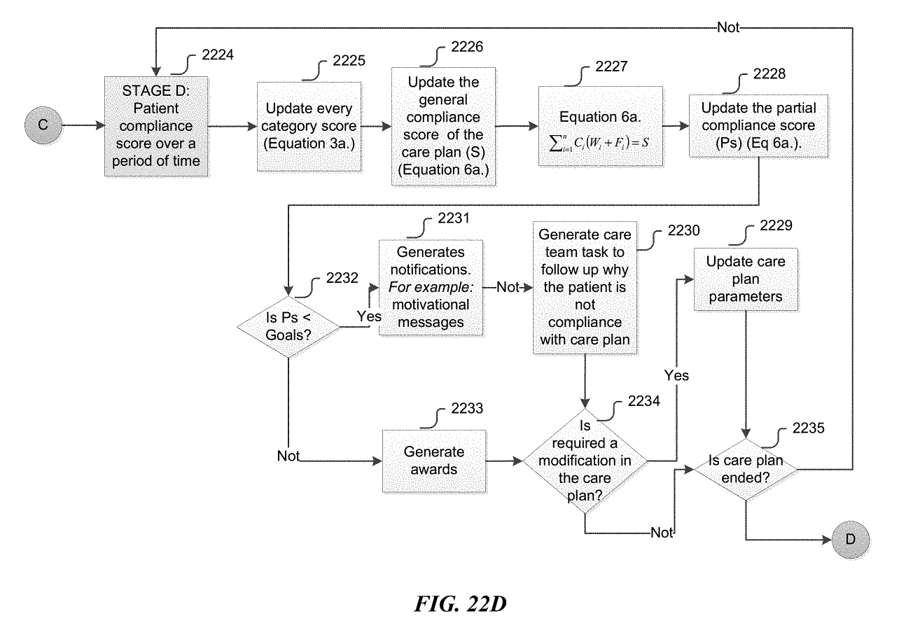

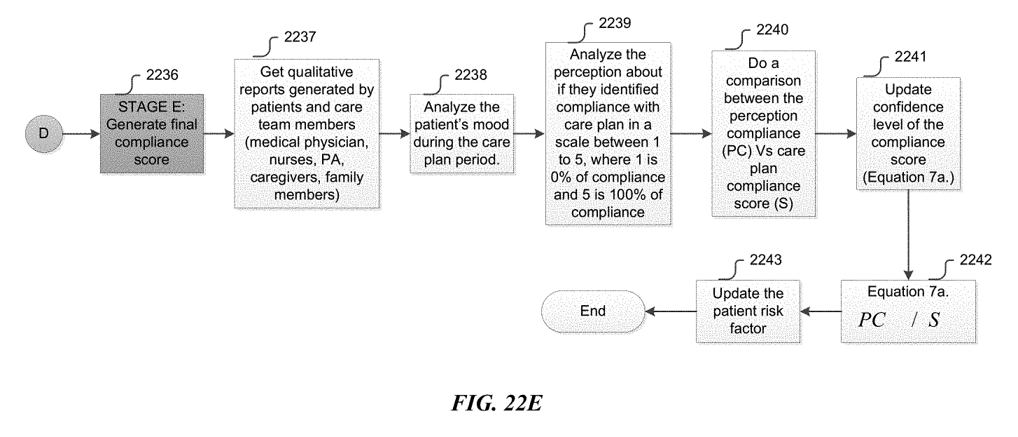

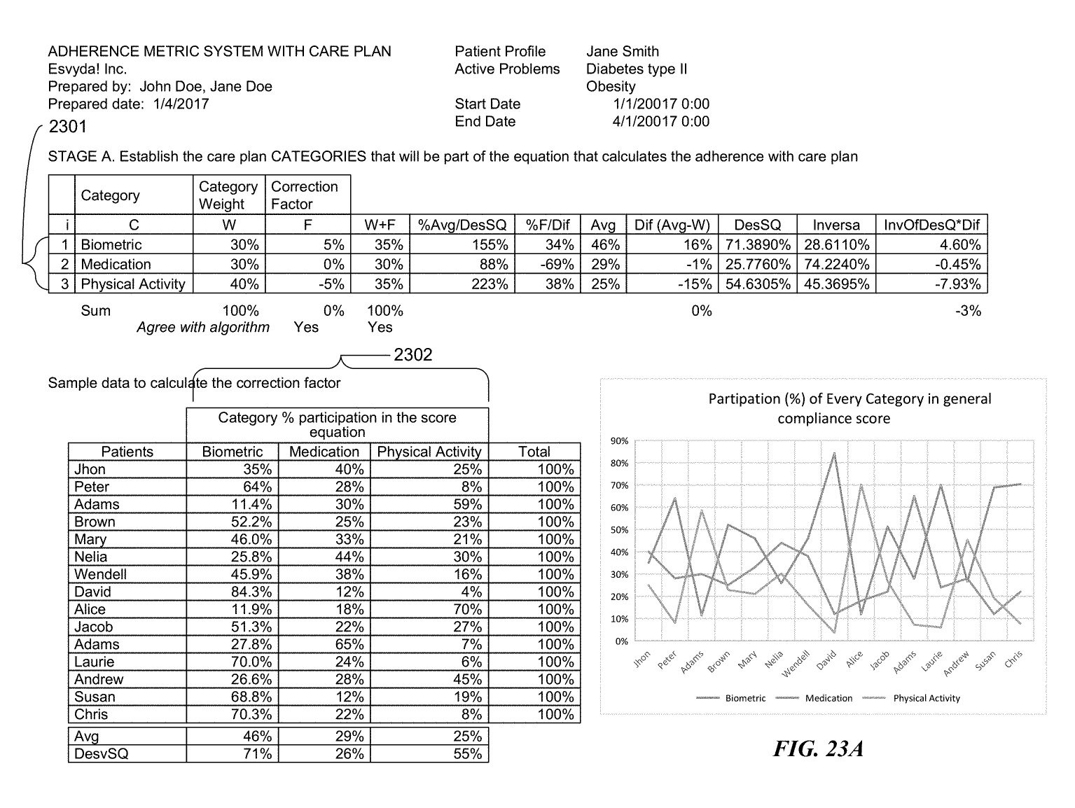

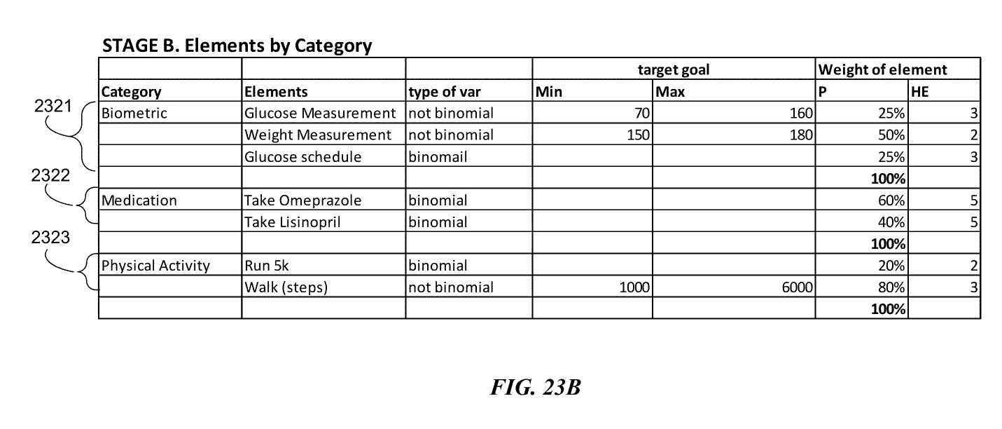

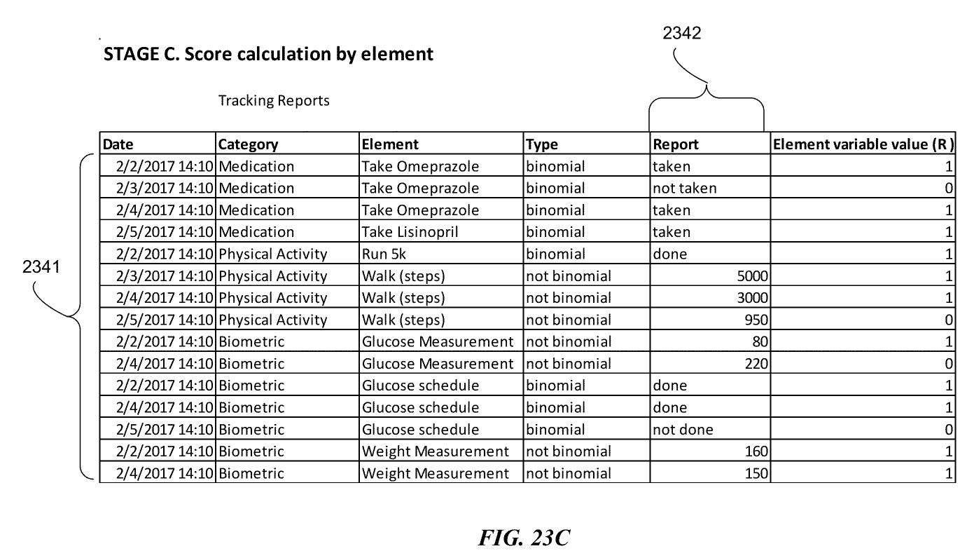

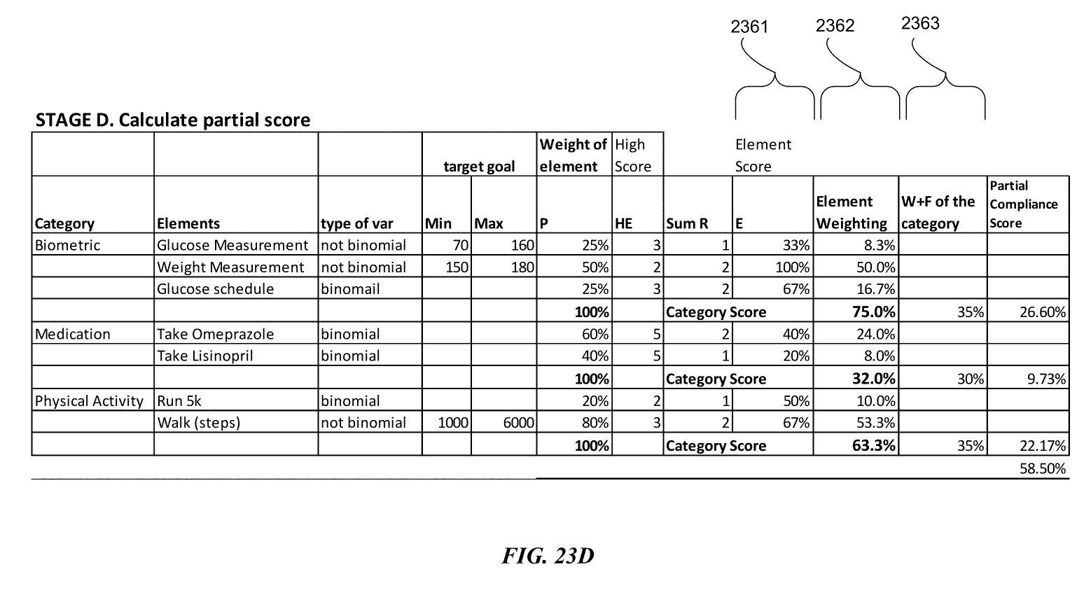

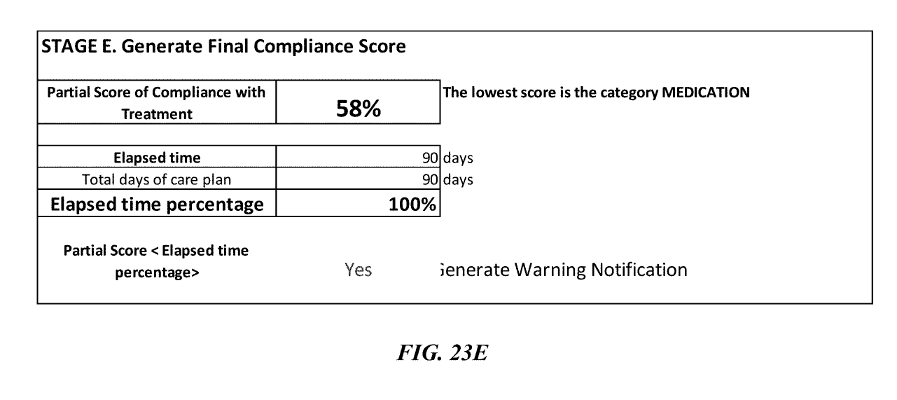

FIGS. 22A-E are a flow diagram illustrating a process for generating a patient compliance score, consistent with various embodiments. In an example, at block 2201, a telemonitoring system accesses patient information. The information includes various information related to a medical care plan, such as patient profile information, patient health issues or diagnoses, patient medical records, a patient nutrition plan, a patient exercise plan, a patient medication plan, a patient education plan, a patient biometric reading plan, etc. At block 2202, the telemonitoring system categorizes various aspects of the patient's medical care plan. In one case, a medical staff member uses a computing device, which communicates with or is part of the telemonitoring system, to identify components of the patient's care plan, and to categorize each component of the care plan. In another case, the telemonitoring system analyzes the patient's care plan and automatically categorizes each component of the care plan. In yet another case, after the telemonitoring system analyzes the patient's care plan and automatically categorizes each component of the care plan, a medical staff member reviews the categorizations, fixes the categorizations, if needed, and authorizes the categorizations. Examples of categories (2203) include nutrition, physical activity (exercise), medication, education, biometric readings schedule, appointments, target biometric ranges, patient tasks, care team tasks, etc., and categories can be created/customized by the medical staff as needed. The user interface of FIG. 24, which illustrates an example patient care plan user interface, provides additional examples of various categories, such as Problems, Care team, Procedures, Nutrition, Last consultations, Readings, Medication, Activities, Appointments, Educational material. FIG. 23A includes categories 2301, which includes Biometric, Medication, and Physical Activity.

At block 2204, the telemonitoring system identifies a weight for each category. In the example of FIG. 23A, categories 2301 include Biometric, which is weighed 30%, Medication, which is weighed 30%, and Physical Activity, which is weighed 40%. Category weights can further be customized for each patient. For example, categories 2302 customizes category weights for each patient (e.g., Jhon, with Biometric weighted at 35%, Medication weighted at 40%, and physical activity weighted at 25%). In one case, a medical staff member uses the computing device to identify the weights. In another case, the telemonitoring system analyzes the patient's care plan and automatically determines the weights for each category, which can later be reviewed by a medical staff member. In yet another case, an expert, such as an appropriately licensed or other qualified medical professional, determines the weights of each category (2205). The telemonitoring system verifies that the sum of the weights for each patient sums to 100%, and causes an error notification message to be displayed when a sum does not equal 100%.

In addition to a weight, a correction factor is identified for each category. A correction factor is a factor used to adjust the weights of the categories, and the sum of weights plus correction factors equals 100% (2206). Stated another way, the sum of the correction factors for a given patient equals zero (2208). In some cases, a goal of the correction factor is to normalize patient compliance scores so that patients that have similar compliance to a similar care plan have similar compliance scores (2209). Blocks 2250 and 2251 include additional detail on one method for calculating a correction factor.

In an example, care plans of patients with a same medical diagnosis (e.g., diabetes) share some common categories amongst different health care providers. The different health care providers have a similar weighting of a first category, e.g., weighting of glucose readings. Because the weights are similar, the contribution to the overall compliance score for patients with similar glucose readings will be similar, so the correction factor in this example for glucose readings will be small. However, the different health care providers have a dissimilar weighting of a second category, e.g., exercise. Because the weights are dissimilar, without a correction factor, the contribution to the overall compliance score for patients with similar exercise performance will be dissimilar. As a result, the correction factors for exercise performance will be larger. The correction factor will be negative for patients with exercise performance weights higher than the average amongst medical providers, and will be positive for patients with exercise performance weights lower than average amongst the medical providers (2207). For categories 2301, the correction factor for Biometric is 5%, and for Physical Activity is −5%.

In a second example, the telemonitoring system supports ten health care providers, and nine of the providers have a similar weighting of a first shared category, and one health care provider has a substantially higher weighting of the first shared category. In this example, the correction factor for the nine providers for this first shared category will be small, and the correction factor for the one health care provider will be substantially larger and will be negative.

At block 2210, the telemonitoring system establishes elements for each category. Examples of categories and associated elements include: Physical Activities (category)—walk 3 km, run 30 minutes (elements); Medication—take omeprazole 30 mg by mouth every 8 hours (2211). FIG. 24 includes further examples of categories and associated elements, such as: Problems—diabetes, hypertension; Care team—Nick Norris, Jacquelyn Brown; Procedures—Labs AC, RX Imaging, Hand RX; Nutrition—low fat, low sodium; etc.

At block 2212, the telemonitoring system defines the weight of each element score in each category. FIG. 23B provides an example of element weights, where elements 2321 includes a first element, glucose measurement, which is weighted at 25%, includes a second element, weight measurement, which is weighted at 50%, and includes glucose schedule, which is weighted at 25%. Elements 2322 and 2323 provide similar examples. Element weights can be defined in any of various ways. For example, in one case, a medical staff member uses a computing device, which is part of the telemonitoring system or communicates with the telemonitoring system, to identify the weights of each element. In another case, the telemonitoring system analyzes the patient's care plan and automatically determines the weights for each element, which can later be reviewed by a medical staff member. In yet another case, an expert, such as an appropriately licensed or qualified medical professional, determines the weights of each category. The telemonitoring system verifies that the sum of the weights for all the elements of each category sums to 100% (2214), and causes an error notification message to be displayed when a sum does not equal 100%. A category score is equal to the sum of each element score times its associated element weight (2213).

At block 2215, the telemonitoring system defines the type of variable assigned to each element. The type of variable can be binomial, or not binomial. Examples of variable types include (2216): run 30 minutes (element)—binomial (type of variable); glucose reading—not binomial. At block 2217, the telemonitoring system gathers target goals established in the care plan for elements which are not binomials, and for each element determines the maximum high score (2218). At block 2219, the telemonitoring system calculates a score for each element. The telemonitoring system obtains various care plan related data, such as tracking reports of various elements. FIG. 23C includes examples of elements and associated tracking reports. Elements 2341 includes a number of elements, and each element has an associated report (2342). The telemonitoring system determines the variable type for each element (2221). When an element is a binomial type variable, the report will be binary (e.g., medicine taken or not taken, glucose measurement taken or not taken). When an element is not a binomial type, the report will be the value of the element (e.g., element: walk, report: 5000 steps taken; element: glucose measurement, report: 80).

For every element within a category that is a binomial variable, the telemonitoring system adds the value of the “n” binomial variables reported to a total for the category element, and divides by the high score assigned previously to that category element (2222). For some binomial variable elements, the telemonitoring system needs to determine the binomial value for the element. For example, when the element is glucose measurement between a lower range and an upper range (e.g., between 60 and 150), the binomial variable is 1, else the binomial variable is 0 (2223).

At block 2224, the telemonitoring system computes a patient compliance score over a period of time. In the example of FIG. 22, a compliance score indicates a patient's compliance to a medical care plan over a period of time, such as from the beginning of the care plan to the current day, over the last 30 days, etc. At block 2225, the telemonitoring system calculates each category score, such as based on equation 3a of block 2213, utilizing health care related data of the patient that was obtained over the period of time. For example, column 2362 of FIG. 23D shows category scores for biometric (75%), medication (32%), and physical activity (63.3%). At block 2226, the telemonitoring system updates the general compliance score, such as based on equation 6a of block 2227, once again based on health care related data of the patient that was obtained over the period of time. For example, column 2363 of FIG. 23B shows the W+F of each of the categories, and, as previously discussed, column 2362 includes the category scores.

At block 2228, the telemonitoring system calculates the partial compliance scores for each category, and an overall partial compliance score. An overall partial compliance score is a compliance score over a portion of a care plan time period, where the portion is less than 100%. When the patient has exceeded his care plan goals (2232), the telemonitoring system generates awards for the patient (2233). For example, the telemonitoring system may provide a discount on a next doctor's visit, may provide a discount on a medication refill, may provide an electronic message that enables the patient to obtain a free coffee at a local coffee house, etc. When the patient falls short of his care plan goals (2231), the telemonitoring system generates a notification (2231), such as a notification that includes a motivational message. For example, the notification can be a text message sent to the patient's smartphone that includes the message “Keep up the good work, you exercised 3 out of 7 days this past week, and have almost achieved your goal of 4 days out of 7 !”, or “great job on keeping your blood sugar under control, you met your goal 6 days this past week, only 1 day short of your goal !”

At block 2230, the telemonitoring system generates a task for a member of the medical staff to follow up with the patient to determine why the patient is not in compliance with the care plan. At block 2234, the telemonitoring system determines whether a modification to the care plan is required. When the patient is achieving his care plan goals, the modification to the care plan may be to raise the target goals. When the patient is not achieving his care plan goals, the modification may be to lower the target goals. When the care plan has ended (2235), the telemonitoring system generates a final compliance score (2236). FIG. 23E provides an example of a final compliance score. The telemonitoring system obtains qualitative reports generated by patients and care team members (2237), and analyzes the reports and other data to determine the patient's mood during the care plan time period (2238). The telemonitoring system obtains input from the patient as to the patient's self-assessment of his compliance over the care plan time period (2239). The telemonitoring system, based on the patient's qualitative report and the care team members' qualitative report, generates a perception compliance, and the perception compliance is compared to the computed compliance score (2240). Based on the comparison of block 2240, the telemonitoring system updates a confidence level of the compliance score (2241), such as based on equation 7a of block 2242. When a patient's self-assessment correlates well with the calculated compliance score, the confidence level is higher, and then it correlates poorly, the confidence level is lower. At block 2243, the telemonitoring system updates the patient risk factors based on the compliance score.

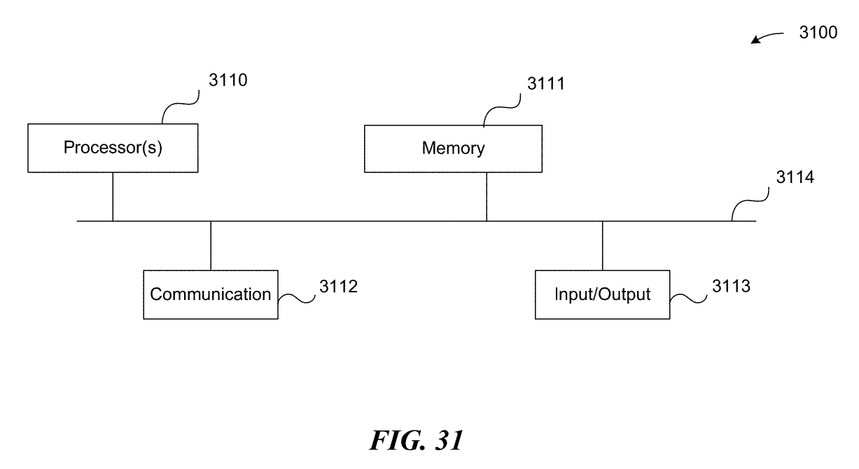

FIG. 31 is a block diagram illustrating an example of a processing system in which at least some operations described herein can be implemented, consistent with various embodiments. Processing device 3100 can represent any of the devices described above, e.g., a telemonitoring system, a mobile device, a computing device, etc. Any of these systems can include two or more processing devices, as is represented in FIG. 31, which can be coupled to each other via a network or multiple networks.

In the illustrated embodiment, the processing system 3100 includes one or more processors 3110, memory 3111, a communication device 3112, and one or more input/output (I/O) devices 3113, all coupled to each other through an interconnect 3114. The interconnect 3114 may be or include one or more conductive traces, buses, point-to-point connections, controllers, adapters and/or other conventional connection devices. The processor(s) 3110 may be or include, for example, one or more general-purpose programmable microprocessors, microcontrollers, application specific integrated circuits (ASICs), programmable gate arrays, or the like, or any combination of such devices. The processor(s) 3110 control the overall operation of the processing device 3100. Memory 3111 may be or include one or more physical storage devices, which may be in the form of random access memory (RAM), read-only memory (ROM) (which may be erasable and programmable), flash memory, miniature hard disk drive, or other suitable type of storage device, or any combination of such devices. Memory 3111 may store data and instructions that configure the processor(s) 3110 to execute operations in accordance with the techniques described above. The communication device 3112 may be or include, for example, an Ethernet adapter, cable modem, Wi-Fi adapter, cellular transceiver, Zigbee transceiver, Bluetooth transceiver, or the like, or any combination thereof. Depending on the specific nature and purpose of the processing device 3100, the I/O devices 3113 can include various devices, e.g., a display (which may be a touch screen display), audio speaker, keyboard, mouse or other pointing device, microphone, camera, etc.

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by any combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

Note that any and all of the embodiments described above can be combined with each other, except to the extent that it may be stated otherwise above or to the extent that any such embodiments might be mutually exclusive in function and/or structure.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

1. A method for telemonitoring compliance of a patient with a care plan, the method comprising:
receiving, by a telemonitoring system, from a first computing device, a care plan of a patient after the care plan was input by a first medical staff member by use of the first computing device;
establishing a schedule of events, by the telemonitoring system, based on the care plan, wherein the schedule of events includes a biometric reading time that indicates a time to take a biometric reading of a patient, a schedule time that indicates a time of a medical staff appointment for the patient, a nutrition time that indicates a time for the patient to consume a nutrient, an education time that indicates a time for the patient to attend a medical education class, and a physical activity time that indicates a time for the patient to do a physical activity to improve physical health;
based on the biometric reading time, sending a biometric message, by the telemonitoring system, that causes a notification to take the biometric reading to be displayed at a mobile device of the patient;
receiving, by the telemonitoring system, from the mobile device, biometric data of the patient after the biometric data was acquired by a biometric device and wirelessly transmitted by the biometric device to the mobile device;
analyzing the biometric data, by the telemonitoring system, to determine if the biometric data indicates that a target range for the biometric data has been exceeded, wherein the telemonitoring system determined the target range based on the care plan;
based on a determination that the biometric data exceeded the target range, sending an alert, by the telemonitoring system, to a second computing device, to notify a second medical staff member that the biometric data exceeded the target range;
based on the nutrition time, sending a nutrition message, by the telemonitoring system, that causes a notification for the patient to consume the nutrient to be displayed at the mobile device of the patient;
receiving a message, by the telemonitoring system, from the mobile device, that indicates whether the nutrient was consumed by the patient;
based on the education time, sending an education message, by the telemonitoring system, that causes a notification to attend the medical education class to be displayed at the mobile device of the patient;
receiving a message, by the telemonitoring system, from a third computing device, that indicates whether a patient attended the medical education class after a third medical staff member indicated via the third computing device whether the patient attended the medical education class;
based on the schedule time, sending a schedule message, by the telemonitoring system, that causes a notification of the medical staff appointment to be displayed at the mobile device of the patient;
receiving a message, by the telemonitoring system, from a fourth computing device, that indicates whether the patient attended the medical staff appointment after a fourth medical staff member indicated via the fourth computing device whether the patient attended the medical staff appointment;
based on the physical activity time, sending a physical activity message, by the telemonitoring system, that causes a notification to do the physical activity to be displayed at a mobile device of the patient;
receiving a message, by the telemonitoring system, from the mobile device, that indicates whether the patient performed the physical activity;
computing, by the telemonitoring system, a compliance score for the patient based on the biometric data, the indication that the nutrient was consumer, the indication whether the patient attended the medical education class, the indication whether the patient attended the medical staff appointment, and the indication whether the patient performed the physical activity; and
sending a message, by the telemonitoring system, that causes the compliance score to be displayed at a fifth computing device to facilitate a licensed medical professional in a health-related determination related to the patient.

2. The method of claim 1,
wherein the indication whether the nutrient was consumed by the patient is an indication that the patient consumed the nutrient, and the indication whether the nutrient was consumed by the patient was received after the patient tapped an icon on the mobile device to indicate that the nutrient was consumed,
wherein the first, second, third, fourth, and fifth computing devices are all a same computing device,
wherein the first, second, third, and fourth medical staff members are all a same medical staff member,
wherein the first medical staff member is a medical doctor, and
wherein the licensed medical professional is the medical doctor.

3. The method of claim 1, wherein the indication whether the nutrient was consumed by the patient is an indication that the patient did not consume the nutrient, the method further comprising:
sending a message that causes a motivational message to be displayed at the mobile device to motivate the patient to follow a nutrition component of the care plan.

4. The method of claim 3, wherein the motivational message includes a description of an award that the patient can earn by following the nutrition component of the health care plan.

5. The method of claim 1, wherein the care plan includes a biometric reading component, a medication component, a nutrition component, and an education component, and wherein the computing of the compliance score further includes computing a correction factor for the biometric reading component, the medication component, the nutrition component, and the education component.

6. A method comprising:
accessing, by a telemonitoring system, a care plan of a patient, wherein the care plan includes a plurality of health-related components;
establishing, by the telemonitoring system, a schedule of health-related events based on the care plan;
based on the schedule of health-related events, sending a first plurality of messages, by the telemonitoring system, to a mobile device of the patient, to prompt the patient to take a plurality of actions indicated by the care plan;
receiving, by the telemonitoring system, from the mobile device, a second plurality of messages, wherein each of the second plurality of messages indicate whether the patient took an action of the plurality of actions; and
computing, by the telemonitoring system, a compliance indicator for the patient based on whether the patient took the plurality of actions.

7. The method of claim 6, further comprising:
sending a message, by the telemonitoring system, that causes the compliance indicator to be displayed at a computing device of a medical staff member.

8. The method of claim 6, wherein the schedule of health-related events includes any of a biometric reading time that indicates a time to take a biometric reading of the patient, a schedule time that indicates a time of a medical staff appointment for the patient, a nutrition time that indicates a time for the patient to consume a nutrient, an education time that indicates a time for the patient to attend a medical education class, a physical activity time that indicates a time for the patient to do a physical activity, or a medication time that indicates a time for the patient to take a medication.

9. The method of claim 6, wherein computing the compliance indicator further comprises:
determining a weight for each of the plurality of health-related components; and
determining a correction factor for each of the plurality of health-related components, wherein the computing of the compliance indicator is based on the weight and the correction factor for each of the plurality of health-related components.

10. The method of claim 6, further comprising:
enrolling the patient at the telemonitoring system, wherein the enrolling includes:
receiving an identification of the patient,
receiving an identification of a chronic health condition of the patient,
sending a message that causes a description of services of the telemonitoring system to be displayed to the patient,
assigning a unique identifier to the patient,
determining whether the patient is covered by an insurance plan,
determining whether the insurance plan covers telemonitoring services, and
establishing a profile for the patient at the telemonitoring system.

11. The method of claim 6, further comprising:
enrolling a health care provider at the telemonitoring system, wherein the enrolling includes:
receiving an identification of the health care provider,
determining whether the health care provider is able to perform Center for Medicaid Services (CMS) services via the telemonitoring system,
determining whether the health care provider includes an appropriately licensed medical professional, and
verifying whether the licensed medical professional has a valid state medical license.

12. The method of claim 11, wherein the enrolling the health care provider further includes:
determining whether the licensed medical doctor participates in one or more innovative CMS programs,
when the licensed medical doctor participates in more than one innovative CMS programs, determining whether any restrictions result from participating in the more than one innovative CMS programs, and
generating an electronic data interchange form to enable the licensed medical doctor to become an authorized CMS participant.

13. The method of claim 6, further comprising:
establishing a secure connection with an Electronic Health Record (EHR) system;
determining whether the telemonitoring system supports a connection protocol of the EHR system;
sending patient demographics to the EHR system to enable the EHR system to identify the patient; and
receiving health-related data of the patient from the EHR system.

14. The method of claim 6, further comprising:
receiving, from a computing device, a care plan of the patient after the care plan was input at the first computing plan by a medical staff member.

15. The method of claim 6, further comprising:
receiving, from a computing device, the plurality of health-related components after the plurality of health-related components were input at the computing device by a medical doctor; and
establishing a medical care plan based on the plurality of health-related components.

16. The method of claim 6, further comprising:
updating the care plan based on patient-related data received by the telemonitoring system.

17. The method of claim 16, wherein the updating of the care plan further comprises:
determining whether progress data related to the care plan of the patient exists in a database;
causing the progress data to be displayed at a computing device associated with a medical doctor to facilitate a medical evaluation of the patient by the medical doctor;
causing the compliance indicator to be displayed at the computing device to facilitate the medical evaluation; and
receiving, from the computing device, an indication to update the care plan.

18. A telemonitoring system comprising:
a processor;
a storage device coupled to the processor;
a networking interface coupled to the processor; and
a memory coupled to the processor and storing instructions which, when executed by the processor, cause the telemonitoring system to perform operations including:
accessing, at the storage device, a care plan of a patient, wherein the care plan includes a plurality of health-related components,
establishing a schedule of health-related events based on the care plan,
based on the schedule of health-related events, sending a first plurality of messages, via the networking interface, to a mobile device of the patient, to prompt the patient to take a plurality of actions indicated by the care plan,
receiving, via the networking interface, from the mobile device, a second plurality of messages, wherein each of the second plurality of messages indicate whether the patient took an action of the plurality of actions, and
computing a compliance indicator for the patient based on whether the patient took the plurality of actions.

19. The telemonitoring system of claim 18, wherein one of the plurality of actions is to take a biometric reading, and wherein the operations further include:
determining a biometric reading time by which the biometric reading should be taken,
when the biometric reading has not been received by the biometric reading time, generating an alert to notify a care taker of the patient that the biometric reading has not been taken, and
sending the alert to a computing device of the care taker to prompt the care taker to cause the biometric reading to be taken.

20. The telemonitoring system of claim 18, wherein the patient did not take a particular action of the plurality of actions, and wherein the operations further include:
based on the patient not taking the particular action, sending a message to notify a medical staff member that the patient did not take the particular action, and
establishing a schedule of a task for the medical staff member to prompt the medical staff member to follow up with the patient in regards to the patient not taking the particular action.

21. A mobile device comprising:
a processor;
a storage device coupled to the processor;
a networking interface coupled to the processor; and
a memory coupled to the processor and storing instructions which, when executed by the processor, cause the mobile device to perform operations including:
receiving, by a care plan application executing at the mobile device, via the networking interface, a message that indicates for a patient to take a biometric reading indicated by a care plan,
receiving, by the care plan application, from a medical device, via the networking interface, biometric data of the patient, after the biometric data was acquired by the medical device,
sending, to a telemonitoring system, the biometric data,
receiving, from the telemonitoring system, a message that indicates that the biometric data is out of a range indicated by the care plan,
receiving, from the telemonitoring system, a message from a medical staff member that indicates for the patient to take an action to address the biometric data being out of range, and
sending, to the telemonitoring system, a plurality of biometric data to enable the telemonitoring system to calculate a compliance indicator that indicates compliance by the patient to the care plan.

22. The mobile device of claim 21, wherein the operations further include:
receiving, by the care plan application, a message that indicates for the patient to take a medication,
displaying a message to prompt the patient to take the medication,
in response to determining that the patient did not take the medication within a predetermined amount of time, sending a message to the telemonitoring system that indicates that the patient did not take the medication in compliance with the care plan, and
receiving a message from a medical staff member that inquires about status of the patient taking the medication.
